SEQUENCE LISTING (4 sequences)

SEQ ID NO: 1 - DNA, 3569 bp, Escherichia sp.
  source 1..3569: mol_type = genomic DNA
gggtgggacccctttcggggtcctgctcaacttcctgtcgagctaatgccatttttaatgtctttagcgagacgctaccatggctatcgctgtaggtagccggaattccattcctaggaggtttgacctgtgcgagcttttagtacccttgatagggagaacgagaccttcgtcccctccgttcgcgtttacgcggacggtgagactgaagataactcattctctttaaaatatcgttcgaactggactcccggtcgttttaactcgactggggccaaaacgaaacagtggcactacccctctccgtattcacggggggcgttaagtgtcacatcgatagatcaaggtgcctacaagcgaagtgggtcatcgtggggtcgcccgtacgaggagaaagccggtttcggcttctccctcgacgcacgctcctgctacagcctcttccctgtaagccaaaacttgacttacatcgaagtgccgcagaacgttgcgaaccgggcgtcgaccgaagtcctgcaaaaggtcacccagggtaattttaaccttggtgttgctttagcagaggccaggtcgacagcctcacaactcgcgacgcaaaccattgcgctcgtgaaggcgtacactgccgctcgtcgcggtaattggcgccaggcgctccgctaccttgccctaaacgaagatcgaaagtttcgatcaaaacacgtggccggcaggtggttggagttgcagttcggttggttaccactaatgagtgatatccagggtgcatatgagatgcttacgaaggttcaccttcaagagtttcttcctatgagagccgtacgtcaggtcggtactaacatcaagttagatggccgtctgtcgtatccagctgcaaacttccagacaacgtgcaacatatcgcgacgtatcgtgatatggttttacataaacgatgcacgtttggcatggttgtcgtctctaggtatcttgaacccactaggtatagtgtgggaaaaggtgcctttctcattcgttgtcgactggctcctacctgtaggtaacatgctcgagggccttacggcccccgtgggatgctcctacatgtcaggaacagttactgacgtaataacgggtgagtccatcataagcgttgacgctccctacgggtggactgtggagagacagggcactgctaaggcccaaatctcagccatgcatcgaggggtacaatccgtatggccaacaactggcgcgtacgtaaagtctcctttctcgatggtccataccttagatgcgttagcattaatcaggcaacggctctctagatagagccctcaaccggagtttgaagcatggcttctaactttactcagttcgttctcgtcgacaatggcggaactggcgacgtgactgtcgccccaagcaacttcgctaacggggtcgctgaatggatcagctctaactcgcgttcacaggcttacaaagtaacctgtagcgttcgtcagagctctgcgcagaatcgcaaatacaccatcaaagtcgaggtgcctaaagtggcaacccagactgttggtggtgtagagcttcctgtagccgcatggcgttcgtacttaaatatggaactaaccattccaattttcgctacgaattccgactgcgagcttattgttaaggcaatgcaaggtctcctaaaagatggaaacccgattccctcagcaatcgcagcaaactccggcatctactaatagacgccggccattcaaacatgaggattacccatgtcgaagacaacaaagaagttcaactctttatgtattgatcttcctcgcgatctttctctcgaaatttaccaatcaattgcttctgtcgctactggaagcggtgatccgcacagtgacgactttacagcaattgcttacttaagggacgaattgctcacaaagcatccgaccttaggttctggtaatgacgaggcgacccgtcgtaccttagctatcgctaagctacgggaggcgaatggtgatcgcggtcagataaatagagaaggtttcttacatgacaaatccttgtcatgggatccggatgttttacaaaccagcatccgtagccttattggcaacctcctctctggctaccgatcgtcgttgtttgggcaatgcacgttctccaacggtgctcctatggggcacaagttgcaggatgcagcgccttacaagaagttcgctgaacaagcaaccgttaccccccgcgctctgagagcggctctattggtccgagaccaatgtgcgccgtggatcagacacgcggtccgctataacgagtcatatgaatttaggctcgttgtagggaacggagtgtttacagttccgaagaataataaaatagatcgggctgcctgtaaggagcctgatatgaatatgtacctccagaaaggggtcggtgctttcatcagacgccggctcaaatccgttggtatagacctgaatgatcaatcgatcaaccagcgtctggctcagcagggcagcgtagatggttcgcttgcgacgatagacttatcgtctgcatccgattccatctccgatcgcctggtgtggagttttctcccaccagagctatattcatatctcgatcgtatccgctcacactacggaatcgtagatggcgagacgatacgatgggaactattttccacaatgggaaatgggttcacatttgagctagagtccatgatattctgggcaatagtcaaagcgacccaaatccattttggtaacgccggaaccataggcatctacggggacgatattatatgtcccagtgagattgcaccccgtgtgctagaggcacttgcctactacggttttaaaccgaatcttcgtaaaacgttcgtgtccgggctctttcgcgagagctgcggcgcgcacttttaccgtggtgtcgatgtcaaaccgttttacatcaagaaacctgttgacaatctcttcgccctgatgctgatattaaatcggctacggggttggggagttgtcggaggtatgtcagatccacgcctctataaggtgtgggtacggctctcctcccaggtgccttcgatgttcttcggtgggacggacctcgctgccgactactacgtagtcagcccgcctacggcagtctcggtatacaccaagactccgtacgggcggctgctcgcggatacccgtacctcgggtttccgtcttgctcgtatcgctcgagaacgcaagttcttcagcgaaaagcacgacagtggtcgctacatagcgtggttccatactggaggtgaaatcaccgacagcatgaagtccgccggcgtgcgcgttatacgcacttcggagtggctaacgccggttcccacattccctcaggagtgtgggccagcgagctctcctcggtagctgaccgagggacccccgtaaacggggtgggtgtgctcgaaagagcacgggtgcgaaagcggtccggctccaccgaaaggtgggcgggcttcggcccagggacctccccctaaagagaggacccgggattctcccgatttggtaactagctgcttggctagttaccaccca

SEQ ID NO: 2 - DNA, 20 bp, synthetic construct
  source 1..20: mol_type = other DNA
gtttccgtcttgctcgtatc

SEQ ID NO: 3 - DNA, 21 bp, synthetic construct
  source 1..21: mol_type = other DNA
tttcacctccagtatggaacc

SEQ ID NO: 4 - DNA, 27 bp, synthetic construct
  source 1..27: mol_type = other DNA
  modified_base 1: mod_base = OTHER; note = 5' Cy5
  modified_base 11: mod_base = OTHER; mod_base = OTHER; note = TAO quencher
  modified_base 27: mod_base = OTHER; mod_base = OTHER; note = Iowa Black RQ
ncgcaagttcnttcagcgaaaagcacn

(19) United States
(12) Patent Application Publication
(10) Pub. No.: US 2025/0033049 A1
(43) Pub. Date: Jan. 30, 2025

(54) SYSTEM, DEVICE, AND METHOD FOR DETECTING NUCLEIC ACIDS

(71) Applicant: SEKISUI DIAGNOSTICS, LLC, Burlington, MA (US)

(72) Inventors: Sean Patrick BRADLEY, San Diego, CA (US); Gregory D. YENT, San Diego, CA (US); Gabriel MARTINEZ-TRIBOLET, Chula Vista, CA (US); Ruth Anne BAUER, San Diego, CA (US); Garrett Dwight GARNER, Encinitas, CA (US); Ryan Keith BIEBER, San Diego, CA (US); Jennifer Alese BOMAN, Poway, CA (US); Trevor MALONE, San Diego, CA (US)

(21) Appl. No.: 18/765,091

(22) Filed: Jul. 5, 2024

Related U.S. Application Data
(60) Provisional application No. 63/525,348, filed on Jul. 6, 2023.

(51) Int. Cl. B01L 3/00; B01L 7/00

(52) U.S. Cl. CPC B01L 3/502738; B01L 7/525; B01L 2200/025; B01L 2200/0647; B01L 2200/0689; B01L 2200/16; B01L 2300/042; B01L 2300/044; B01L 2300/0867; B01L 2300/1805; B01L 2300/1844; B01L 2400/0644

(57) ABSTRACT

Provided herein is a system, a device that includes modules, a cartridge that includes components such as a microfluidic channels, and methods that relate to detecting nucleic acids and other constituents of biological samples. The present disclosure also relates to cartridges, devices, and methods for performing sample analysis, e.g., nucleic acid analysis such as PCR analysis of materials within the cartridges in a rapid manner.

### RELATED APPLICATIONS

This disclosure claims priority to U.S. Provisional Application No. 63/525,348, filed Jul. 6, 2023, the contents of which are herein incorporated by reference in their entirety.

### SEQUENCE LISTING

The instant application contains a Sequence Listing that has been submitted electronically in XML format and is hereby incorporated by reference in its entirety. Said XML copy, created on Jul. 1, 2024, is named U3415-00101_SEQ_ID_LISTING.xml and is 9,867 bytes in size.

### FIELD OF THE INVENTION

This disclosure relates to a system, a device that includes modules, a cartridge that includes components such as a microfluidic channels, and methods that relate to detecting nucleic acids and other constituents of biological samples. The present disclosure also relates to cartridges, devices, and methods for performing sample analysis, e.g., nucleic acid analysis such as PCR analysis of materials within the cartridges in a rapid manner.

### BACKGROUND

Polymerase Chain Reaction (PCR) is a facile method involved in the detection of selected nucleic acids in a sample suspected of or having the selected nucleic acids by amplifying nucleic acids. Biological samples (e.g., saliva, buccal swab, nasal aspirate, blood, or other bodily fluids) comprise nucleic acids and many sources of PCR inhibitors. As such, PCR analysis of biological samples requires removal of such inhibitors to generate a nucleic acid sample of sufficient quality to perform the intended analysis. Manual sample preparation methods may often be time-consuming.

Integrated microfluidic handling systems that provide control over limited sample volumes are useful in miniaturizing PCR tests in a time-efficient manner. Microfluidic devices include components such as channels, valves, pumps, flow sensors, mixing chambers and optical detectors. Examples of these components and systems may be found in U.S. Pat. Nos. 5,932,100; 5,922,210; 6,387,290; 5,747,349; 5,748,827; 5,726,751; 5,716,852; 5,974,867; 6,007,775; 5,972,710; 5,971,158; 5,948,684; 6,171,865; 7,648,835; 7,745,207 6,870,185; 8,672,532; and 8,894,946.

### SUMMARY OF THE INVENTION

In one aspect, this disclosure relates to methods of preparing samples and detecting constituents from biological samples, for example, methods of loading metered amounts of sample into an analyzer, methods of lysing samples, and methods of detecting constituents, e.g., nucleic acids, polypeptides, peptides and/or post-translational modifications of polypeptides or peptides, from lysed samples. The present disclosure also relates, in some aspects, to detecting nucleic acids. In some aspects, this disclosure features methods of detecting one or a plurality of selected nucleic acids.

In some aspects, the method comprises the steps of (a) providing a sample mixed with lysis solution to an introduction element of a microfluidic cartridge and (b) closing the cap of the introduction element, e.g., a cup, vial, tube, cylinder. The sample introduction element comprises a moveable cap providing a pressure tight seal. In some aspects, the sample introduction element is fluidically connected to a waste reservoir via a first opening and a sample introduction microchannel via a second opening, directly, or indirectly (e.g., through a valve) to other components of a system for purifying and/or detecting biological samples. In some aspects, the sample introduction microchannel connects to a valve configured to selectively isolate the sample introduction element and sample introduction microchannel.

In one aspect, an introduction element for introducing a sample to a microfluidic cartridge includes an opening through the introduction element defined by annular ring. In one aspect, a chimney is positioned within the opening. The chimney may include an aperture extending through the chimney. The chimney aperture has an internal cross-sectional area that is less than an internal cross-sectional area of the opening. For example, in some aspects a cross-sectional area of the aperture is, from 5 to 65% of a cross-sectional area of the opening. In some aspects, the cross-sectional area of the aperture is from 5 to 20%, or from 5 to 15%, of a cross-sectional area of the opening. In some aspects, the cross-sectional area of the aperture is about 6.5% of a cross-sectional area of the opening. The chimney is, in some aspects, a hollow cylinder defined by the aperture and the opening. The chimney may extend beyond the annular ring defining the opening at both ends. The top of the chimney is submerged when a sample with a volume greater than a selected volume is presented to the sample introduction cup. In some aspects, the selected volume is about 50, 75, 100, 125, 150, 175, 200, 225, 250, 275, 300, 350, or 400 microliters, or any volume between any of the aforementioned volumes. Upon venting the sample introduction cup, bubbles may form which can be reduced or eliminated by contacting the chimney.

In some aspects the introduction element includes a cap capable of maintaining a closed position under pressure. Closure features such as friction elements may be selected to withstand a predetermined pressures during use. Closure features may include one or more engaging members. In some instances, the closure features may include four engaging members. The opening and the aperture may be positioned such that they correspond to separate channels in a microfluidic cartridge during use.

In some aspects, closing the cap of the introduction element to form a pressure tight seal introduces pressure into the introduction element, resulting in flow of sample into the lysis chamber. The sample introduction cup contains two ports, one pneumatic for pressurizing with air, and one fluidic for moving sample to the lysis chamber. In some aspects, the volume introduced into the sample cup ranges from 150 to 400 microliters. The entirety of the sample can be introduced to the microfluidic cartridge through exogenous pressure. In some aspects, exogenous pressure can be applied with the chimney feature allowing for the pressurization of the sample cup feature via a pneumatic port in close proximity to a fluidic port, while the chimney feature eliminates air bridging from the pneumatic port to the fluidic ports present in the sample cup.

In some aspects, the method further comprises the step of (c) introducing pressure to the introduction element through the vertical channel to introduce pressure above the level of the fluid in the introduction element and (d) actuating the valve to fluidically connect the introduction element to the sample introduction microchannel, which is fluidically connected to other modules or subsystems that relate to detecting nucleic acids or proteins, peptides, or post-translational modifications such as phosphorylation or glycosylation. In some aspects, the sample introduction microchannel is fluidically connected to, e.g., a mechanical lysis chamber with a plurality of magnetizeable beads disposed therein. The method further comprises the steps of (c) conveying the sample mixed with lysis solution to the mechanical lysis chamber and (f) actuating the valve to fluidically disconnect the mechanical lysis chamber from the introduction element. The method further comprises the step of (g) actuating at least two rotatable members comprising magnets to move the magnetizeable beads from end to end in the mechanical lysis chamber, where the sample is converted to lysed cell constituents comprising nucleic acids. In some aspects, the lysed cell constituents may be further processed or purified, either on the microfluidic cartridge or off the microfluidic cartridge.

In some aspects, the method further comprises the steps of (h) actuating the valve to fluidically connect the lysis chamber with a extraction chamber, which comprises a reversibly binding medium and (i) conveying the lysed cell constituents into the extraction chamber, where the nucleic acids reversibly bind to the reversibly binding medium. The method further comprises the steps of (j) actuating the valve to fluidicially connect a wash solution reservoir, which comprises wash solution, to an input port of the extraction chamber, and further fluidically connects an output port of the extraction chamber to a waste reservoir and (k) conveying wash solution to the extraction chamber to convey the lysed cell constituents not reversibly bound to the reversibly binding medium into the waste reservoir, while retaining substantially all of the nucleic acids bound to the reversibly binding medium. The method further comprises the step of (1) actuating the valve to fluidicially connect an elution solution reservoir, which comprises elution solution, to an input port of the extraction chamber, and to further fluidically connect an output port of the extraction chamber to a reagent zone or an outlet. In some aspects, the reagent zone may comprise reagents for, e.g., LAMP (Loop-Mediated Isothermal Amplification), DNA sequencing or sample preparation thereof (NGS or Sanger), hybridizing to a microarray, hybridization to a labeled bead (Luminex assay), gel electrophoresis, PCR, qPCR, nested or hemi-nested PCR, CRISPR-based genetic analysis (e.g., Mammoth Biosciences DETECTR™ assay), and mass spectrometry (Agena Bioscience MASSARRAY™ assay), or an immunoassay. In some aspects, the PCR reagents are selected from: Taqman™, Scorpions™, Amplifluor, LUX, Cyclicons, Angler, or Molecular Beacons™. In some aspects, the RT-PCR reagents comprises a transcriptase. In some aspects, the transcriptase is NxtScrip reverse transcriptase (Roche). In some aspects, the qPCR reagents comprise a polymerase. In some aspects, the polymerase is Ttx polymerase (Toyobo, Japan). In some aspects, the DNA sequencing reagents include, as a non-limiting example, adapters that include or exclude unique molecular identifiers, universal and/or target specific amplification or sequencing primer sites, and/or hybridization sites.

In some aspects, eluted nucleic acids are detected either on the microfluidic cartridge or off the microfluidic cartridge. In some aspects, the prepared sample for DNA sequencing can be removed from the microfluidic cartridge and analyzed on a separate DNA sequencing instrument. The separate DNA sequencing instrument can include or exclude: Illumina MiSeq, iSeq, Miniseq, NextSeq, Novaseq, Hiscq, Solexa Sequencer, Hiseq 2000; Element Biosciences AVITI; Singular Genomics G4; Ion Torrent; ThermoFisher 3730 ×1 DNA Analyzer (including its predecessors); Molecular Dynamics/Amersham MegaBACE 1000, 1500, 4000, and 4500; Ultima Genomics UG100; PacBio Onso, Revio, Sequel; BGI DNBSEQ-G99, DNBSEQ-T7, DNBSEQ-G400C, DNBSEQ-G400; and Oxford Nanopore MiniION.

The method further comprises the steps of (m) conveying elution solution to the extraction chamber to elute and convey nucleic acid eluted from the reversibly binding medium to other modules or subsystems that relate to detecting nucleic acids, e.g., by PCR, LAMP (Loop-Mediated Isothermal Amplification), DNA sequencing (NGS or Sanger), hybridizing to a microarray, hybridization to a labeled bead (Luminex assay), gel electrophoresis, qPCR, nested or hemi-nested PCR, multiplex PCR, RT-PCR, CRISPR-based genetic analysis (e.g., Mammoth Biosciences DETECTR™ assay), and mass spectrometry (Agena Bioscience MASSARRAY™ assay). In some aspects, the method comprises conveying eluted nucleic acid into one or a plurality of reagent mastermix zones forming a nucleic acid admixture and (n) conveying the nucleic acid admixture into a mixing microchannel forming a mixed nucleic acid admixture. In one aspect, the method comprises conveying eluted nucleic acid into one or a plurality of PCR mastermix zones forming nucleic acid PCR admixture, and (n) conveying the nucleic acid PCR admixture into a mixing microchannel forming a mixed nucleic acid PCR admixture.

The method further comprises the step of (o) actuating the valve to fluidically connect the mixing channel to a detecting subsystem for detecting nucleic acids by any of the detecting methods disclosed above and herein. In one aspect, actuating the valve fluidically connects the mixing microchannel to one or a plurality of PCR chambers and a waste reservoir, where each PCR chamber can comprise a reagent which can include or exclude: one or more polymerases, control PCR reagents and primers and probes for a selected nucleic acid target. In some aspects, there may be from 1 to 384 PCR chambers. In some aspects, there are 2 to 96 PCR chambers. In some aspects, there are from 2 to 5 PCR chambers. In some aspects, there are 4 PCR chambers. In some aspects, the labels are fluorescent labels or nanoparticle labels. In some aspects, the method further comprises the step of (p) conveying the mixed nucleic acid PCR admixture into the one or a plurality of PCR chambers, where each of the PCR chambers. In some aspects, the method further comprises the steps of (q) actuating the valve to fluidically isolate the PCR chambers, (r) contacting the microfluidic cartridge with a first heating zone, (s) modulating the temperature of the microfluidic cartridge to a first selected temperature, (t) contacting the microfluidic cartridge with a second heating zone, (u) modulating the temperature of the microfluidic cartridge to a second selected temperature, (v) presenting an excitation light source to the PCR chambers, where a labeled primer or probe emits fluorescence, and (w) measuring one or a plurality of selected photophysical properties from the emitted fluorescence from each PCR chamber, and repeating steps (r) through (v) for a selected number of instances.

In some aspects, the microfluidic cartridge comprises a sample introduction element, one or a plurality of valves, a control sample zone, a mechanical lysis chamber, an extraction chamber, a waste reservoir, a wash solution reservoir, an elution solution reservoir, one or a plurality of PCR mastermix zones, a mixing microchannel, and one or a plurality of PCR chambers. In one aspect, the valve is rotatable.

In one aspect, the microfluidic cartridge comprises one valve. In one aspect, the one valve is rotatable. In one aspect, the sample introduction microchannel comprises a control reagent zone comprising one or more control reagents. In one aspect, the lysis solution, elution solution, or both comprise one or more control reagents. In one aspect, the one or more control reagents comprises a nucleic acid having a known sequence. In one aspect, the control sample further comprises carrier RNA (cRNA) or carrier DNA (cDNA). In one aspect, the cRNA is greater than 200 nt (nucleotides) in length. In one aspect, the cRNA is polyA. In one aspect, the nucleic acid having a known sequence is MS2 DNA (SEQ ID NO: 1). In one aspect, the one or more control reagents are lyophilized.

In one aspect, step (c) introducing pressure to the sample conveyance pressure port to introduce pressure into the sample introduction element, further comprises (i) introducing pressure into a first reservoir of the sample introduction element through a vertically aligned channel surrounded by a wall disposed within the interior of the sample introduction cap, where at least a portion of the vertically aligned channel wall does not extend throughout the entirety of the first reservoir of the sample introduction element and the top surface of the sample mixed with lysis solution is above the top of the vertically aligned channel, where pressure is increased in the volume defined by the top of the sample surface and the interior surface of the cap, (ii) stopping the introduction of pressure into the first reservoir and allowing the pressure presented to the first reservoir to return to atmospheric pressure, where any fluid in the first reservoir positioned above the top of the vertically aligned channel is conveyed through the vertically aligned channel into a lower region of the waste reservoir, and (iii) introducing pressure to the sample conveyance pressure port through the waste reservoir to the sample holder cup.

In one aspect, each of the at least two rotatable members independently comprises magnets on one or both ends. In one aspect, the reversibly binding medium is a porous silica medium. In one aspect, the porous silica medium is a porous silica membrane. In one aspect, the volume of the sample mixed with lysis solution that exceeds the selected volume is conveyed to the waste reservoir. In one aspect, conveying the sample mixed with lysis solution into the mechanical lysis chamber is performed by introduction of pressure to a waste reservoir pump port. In one aspect, conveying the lysed cell constituents into the extraction chamber is performed by introduction of pressure to a post-sample air pump port while the valve is actuated to fluidically disconnect the sample introduction element from the mechanical lysis chamber. In one aspect, conveying wash solution to the extraction chamber is performed by introduction of pressure to a wash solution reservoir pump port. In one aspect, conveying elution solution to the extraction chamber is performed by introduction of pressure via an external disc pump in contact with an elution solution reservoir pump port. In one aspect, conveying the nucleic acid PCR admixture into the mixing chamber is performed by introduction of pressure to an elution solution reservoir pump port.

In one aspect, temperature zones are separated into a movable first temperature zone having a temperature of less than about 70° C. and a second movable temperature zone having a temperature of higher than about 85° C. Temperatures in the first movable temperature zone may be controlled to stay within a range from about 50° C. to about 65° C. In a particular embodiment, the temperature in the first movable temperature zone (also referred to herein as “Heater Zone 1”) is in a range between about 55° C. to about 65° C. In one aspect, the first movable temperature zone is maintained within a range of about 55° C. to about 60° C. In one aspect, the second movable heating zone comprises a temperature of less than the selected temperature. In one aspect, the method further comprises the step of maintaining the first selected temperature for a selected time.

In some aspects, a second movable temperature zone (also referred to herein as “Heater Zone 2”) maintains a temperature in a range from about 90° C. to about 100° C. In some aspects, the second movable temperature zone is be maintained at a temperature in a range from about 91° C. to about 98° C. In one aspect, the method further comprises the step of maintaining the second movable temperature zone at a predetermined temperature for a selected time.

In some embodiments, a microfluidic cartridge is positioned proximate the temperature block where the microfluidic cartridge is positioned proximate a heater held at a temperature of about 95° C. After the predetermined residence time proximate to the high temperature heating block, the cartridge is moved to a position proximate to the low temperature block. At the low temperature block, the latent heat from the cartridge warms up the heater on the low temperature heating block while cooling the cartridge. In this way, the temperature of the heater and the temperature of the cartridge will meet at the predetermined temperature of about 60° C. In some embodiments, the microfluidic cartridge is maintained at a relatively fixed position and the heating blocks are alternatively positioned to the PCR chambers of the microfluidic cartridge.

The contact time between the PCR chambers of the microfluidic cartridge and the temperature zones is designed to be minimal such that the overall PCR cycling time can be minimized. The contact time between the PCR chambers of the microfluidic cartridge and each of the temperature zones can be independently range from about 0.5 seconds to about 10 seconds. In some aspects, the contact time can range from about 1 to about 6 seconds. In some aspects, the contact time is about 0.5, 1, 2, 3, 4, 5, 6, 7. In some aspects, the contact time is about 0.3, 0.5, 1, 2, 3, 4, 5, 6, 7, 8, 9, 10, 20, or 30 seconds or any range between any two of those times or any fractional amount between 0.3 to 30 seconds. In one aspects, the contact time is about 5 seconds.

In one aspect, at least one of the one or a plurality of selected photophysical properties is light intensity at one or a plurality of wavelengths. In one aspect, step (w) measuring one or a plurality of selected photophysical properties from the emitted control fluorescence and selected fluorescence from each PCR chamber is performed at the first heating zone, second heating zone, or both heating zones. In one aspect, the selected number of instances is e.g., from 2 to 100. In one aspect, the selected number of instances is e.g., from 15 to 45. In one aspect, the selected number of instances is e.g., from 30 to 40. In one aspect, the selected number of instances is 30. In one aspect, the light source is continuous. In some aspects, the light source is presented while the temperature is modulating to a selected temperature. In some aspects, the light source is presented after the temperature has modulated to a selected temperature. In some aspects, the light source is discontinuous. In some aspects, the discontinuous light source is presented at each denature (control) and anneal (selected nucleic acid) step or region. In some aspects, multiple wavelengths of discontinuous light sources are presented at a single step or region.

In some aspects, the light source comprises two or more LEDs of separate colors which alternate in their activation. In some aspects the light source provides illumination for an imaging system. In some aspects the imaging system comprises a single camera, and a multi-channel fluorescence filter. In some embodiments, the multi-channel fluorescence filter is a dual-channel fluorescence filter. The fluorescence filter can be selected depending on the activated LED color. The imaging system thus acquires sequential fluorescence measurements of each activated LED color. In some embodiments, the LED color is matched to the about the excitation wavelength of the label on the probe when RT-PCR or qPCR is employed. In aspects with a discontinuous light source, one activated LED color is presented at the denature (control) step or region, and a second activated LED color is presented at the anneal (selected nucleic acid) step or region. In other aspects with a discontinuous light source, all activated LED colors are presented at the anneal (selected nucleic acid) step or region in a sequential fashion. Images are taken from the anneal side, the denature side, or both. In one aspect the images are taken in series. In one aspect the images are taken in series from the anneal side.

In some aspects, also disclosed herein, are microfluidic cartridges. In some aspects, a microfluidic cartridge (cartridge) can include or exclude an element selected from: pierceable pneumatics ports, a sample introduction element, a rotatable valve, a mechanical lysis chamber, a purification/extraction chamber, a waste reservoir, a wash solution reservoir, an elution solution reservoir, one or a plurality of PCR mastermix zones, a mixing microchannel, ports, and one or more PCR chambers. The rotatable valve is configured to selectively put any of the aforementioned elements in fluid communication. In some aspects, the cartridge comprises a control reagent zone.

In some aspects, also disclosed herein are cartridge assemblies. In some aspects, a microfluidic cartridge includes a microfluidic element having one or more PCR chambers having a predetermined geometry. In some embodiments, PCR chambers include rounded and/or chamfered edges.

In some aspects the PCR element for performing PCR of one or a plurality of selected nucleic acids includes one or more PCR chambers. In some aspects each of the PCR chambers has a predetermined geometry. The geometry of the PCR chamber is selected based on the target and/or type of analysis to be conducted. For example, in some aspects a PCR chamber depth (CD) is selected based on a target or a type of analysis. In some aspects a recess section of the PCR element has a depth equal to 1.5 times the PCR chamber depth. The PCR element includes, e.g., a channel having a depth equal to 1.5 times the PCR chamber depth. In some embodiments, a first channel section has a depth equal to half the depth of the PCR chamber. In some aspects, a second channel section proximate the first channel section has a depth equal to a fraction, e.g., one quarter of the PCR chamber depth. In some aspects the PCR element comprises a restriction section. In one embodiment the restriction section has a depth equal to a fraction, e.g., one third of the depth of the PCR chamber.

In some aspects, targets include selected nucleic acids. In some embodiments, at least one of the targets is a control nucleic acid. The control nucleic acid can confirm that the processing steps for nucleic acids in the sample have been properly performed throughout the microfluidic cartridge.

In some aspects, a PCR element includes an outlet from each of the one or more chambers that has a smaller cross-sectional area than a respective inlet of each of the one or more chambers.

In some embodiments, the PCR element includes an irregular channel having predetermined angles such that a flow rate in the channel is controlled and to which each of the one or more chambers is fluidically coupled.

A microfluidic cartridge also includes, in some embodiments, a waste reservoir, two or more separate pathways through the cartridge with openings at a distribution element, and a rotatable valve comprising one or more channels extending laterally across the valve proximate a surface of the rotatable valve capable of connecting two or more pathways of the microfluidic cartridge during use.

A particular embodiment of a microfluidic cartridge includes an introduction element, a rotatable valve, a mechanical lysis chamber, a extraction chamber, a mixing channel, and two or more PCR chambers. The rotatable valve is configured to selectively put any of the elements of the microfluidic cartridge in fluid communication.

In some aspects, also disclosed herein are rotatable valves for use in a microfluidic cartridge. In some aspects, a rotatable valve for use in a microfluidic cartridge comprises a cover section having a geometry to engage at least a portion of a microfluidic cartridge. The cover section comprises a base section, comprising two or a plurality of channels, and a control section coupled to the base section. The base section has a geometry that engages at least a portion of the cover section. In one aspect, the control section comprises openings formed to engage pathways in the microfluidic cartridge.

For example, a rotatable valve for use in a microfluidic cartridge may include a cover section having a geometry to engage at least a portion of a microfluidic cartridge. The rotatable valve may include a control section having one or more walls defining pathways. The control section may include a ring wall proximate the edge of the control section. Pathways of the control section may be configured to engage channels or paths in the microfluidic cartridge. For example, during use a pathway may fluidly connect two openings in the microfluidic cartridge at the distribution element. Thus, two elements of cartridge may be fluidly connected when the valve is rotated to a predetermined position where the pathway aligns with two openings in the microfluidic cartridge.

In some embodiments, the rotatable valve engages with a rotor arm which is controlled by a controllable stepper motor to control the position of the rotatable valve. In some embodiments, the rotatable valve can be keyed such that the absolute position can be controlled by the stepper motor position.

In one aspect, the control section comprises one or more channels formed such that they connect at least two openings in the microfluidic cartridge such that the at two least openings in the microfluidic cartridge are in fluid communication when the one or more pathways in the control section are positioned proximate the at least two microfluidic cartridge openings.

In one aspect, at least one of the cover section, control section, or the base section comprises cyclic olefin copolymers (COC), cyclo-olefin polymer (COP), polystyrene (PS), polycarbonate (PC), polymethyl methacrylate (PMMA), Zeonor™, Topaz™, and/or polypropylene and the control section comprises an overmolded elastomer. In one aspect, the elastomer is a thermoplastic elastomer such as a silicone and/or polyurethane. In one aspect, at least one of the cover section, the base section, or the control section comprises polycarbonate. In particular, a thermoplastic elastomer used in the control section may have a value in a range between about 40 to 50 on the Durometer Shore A hardness scale. In one aspect, at least a portion of the control section comprises overmolded silicone having a valve of about 60 on the Durometer Shore A hardness scale.

Walls defining the pathways and the ring wall may be formed from an overmolded elastomer. In some instances, a cover section and/or the base section may include polycarbonate and/or polypropylene and the control section is formed from an overmolded elastomer. For example, the walls and/or a ring wall in the control section may include overmolded silicone. In an aspect of a valve for use in the microfluidic cartridge, walls and/or a ring wall may include an overmolded silicone having a valve of about 60 on the Durometer Shore A hardness scale.

In some aspects, also disclosed herein are lysis modules for lysing biological materials. In some aspects, a lysis module for lysing biological materials comprises a lysing chamber and at least two rotatable members comprising magnets on one or both ends of each of the at least two rotatable members. The lysing chamber comprises one or more magnetizeable balls. In one aspect, the one or more magnetizeable balls comprise e.g., stainless steel. In one aspect, the one or more magnetizeable balls are magnetic and/or subject to a magnetic field. In one aspect, during use, movement of the at least two rotatable members moves the one or more magnetizeable balls within the lysis chamber, e.g., in a linear movement from a first wall to a second wall of the chamber at a speed in a range from about 100 to about 3200 strokes per minute. In one aspect, during use the at least two rotatable members rotate in the same direction such that they do not contact each other. The rotation of the rotatable members may be offset from each other. For example, the rotation of the rotatable members may be offset by about 90 degrees. This may ensure that the rotatable members do not contact each other during use. Further, the positioning of the rotatable members, speed of rotation, and/or the orientation relative to each other while rotating may be selected in order to ensure that the rotatable members do not contact each other.

In one aspect, during use PCR interfering substances are separated or eliminated from the sample by the movement of the one or more magnetizeable balls. In one aspect, during use the lysis module lyses constituents in a sample in less than about 60 seconds. Magnetizeable balls can include, but are not limited to balls having magnetic properties, metal balls, balls made of alloys such as stainless steel balls, ball bearings, and the like. In some embodiments, magnetizeable balls may be coated or uncoated ball bearings based on the requirements of use.

In one aspect magnetizeable balls have a diameter in a range from about 0.015 inches to 0.250 inches (0.381 mm to 6.35 mm). In one aspect magnetizeable balls have a diameter in a range from about 0.03125 inches to 0.125 inches (0.79 mm to 3.18 mm). In some aspects, magnetizeable balls have a diameter of about 0.9 inches (i.e., 22.9 mm).

In one aspect, the magnetizable balls comprise e.g., 410 chrome plated ball bearings. In one aspect, the magnetizable balls comprise ball bearings having a diameter of about 0.09 inches. In one aspect there are between about 1 to about 10 magnetizeable balls. In one aspect, there are 4 magnetizeable balls.

A first magnet positioned on a first end of the at least one rotating member has a polarity opposite a second magnet positioned on a second end of the at least one rotating member. The at least one rotating member is sized such that during use the at least one rotating member moves the plurality of magnetizeable balls within the lysing chamber. In one aspect, during use the rotation of the rotating members moves the magnetizeable balls linearly from a first end of the lysing chamber to a second end of the lysing chamber. In one aspect, during use the rotating members move such that the magnetizeable beads move within the lysing chamber at a speed ranging from about 500 to about 3000 strokes per minute. In some aspects, the magnetizeable beads move within the lysing chamber at a speed at about 1500 strokes per minute. The width and height of the lysing chamber is configured to be less than the width of two of the magnetizeable balls such that the balls may not move past each other when traversing the length of the lysing chamber.

In one aspect, the plurality of magnetizeable balls comprise e.g., uncoated ball bearings of a uniform size. In one aspect, the magnetizeable balls are plated with e.g., 410 chrome. In one aspect, each of the magnetizeable balls has a diameter of about 0.09 inches (2.286 mm).

In some aspects, also disclosed herein are PCR chambers for performing PCR of one or a plurality of selected nucleic acids. In some aspects, a PCR chamber for performing PCR of one or a plurality of selected nucleic acids comprises two or more chambers having a predetermined geometry and two or more irregular channels extending from the two or more chambers and comprising predetermined angles such that a flow rate in the channel is controlled. The two or more chambers comprise one or more pathways, having a predetermined height at least two different and distinct points along the one or more pathways, and an outlet from each of the two or more chambers having a smaller cross-sectional area than a respective inlet to each of the two or more chambers. In one aspect, the number of selected nucleic acids is two or a plurality, and one of the nucleic acids is a control nucleic acid.

In some aspects, also disclosed herein are modules for heating a sample. In one aspect, a system for heating a sample may include a device having a low temperature heating block and a high temperature block. The heating blocks may include a heater plate, heater, heater mount plate, a thermistor, a thermal interface pad, and a spring. In addition, the low temperature heating block may include a heat sink. The heat sink may help with dissipation of heat away from the heater plate to ensure that the predetermined temperatures are achieved in the correct order and/or for the proper duration.

Heating elements may include but are not limited to polyimides, for example, a polyimide film, metals such as copper, copper plated with silver, a copper alloy plated with silver, and/or other materials known in the art. Materials used in the low and high temperature block may differ.

Springs may be used to ensure a predetermined contact between the microfluidic cartridge and a heating block. For example, springs may provide a predetermined amount of pressure to a heating block to ensure contact. The pressure can range from 1 to 15 psi (6.89 kPa to 103.4 kPa). In a particular embodiment, springs providing pressure in a range of about 9 to about 13 psi (62 kPa to 89.6 kPa).

In some aspects, a system for heating a sample comprises a microfluidic cartridge, a first movable heating zone, and a second movable heating zone. The first movable heating zone comprises a first mounting plate having a first surface on which the microfluidic cartridge sits during a first process during use, a first heating element positioned proximate the first mounting plate, a first fan, a first spring positioned proximate a second surface of the first mounting plate, and a first heat sink positioned proximate the first mounting plate. The second movable heating zone comprises a second mounting plate having a first surface on which the microfluidic cartridge sits during a second process during use, a second heating element positioned proximate the second mounting plate, a second fan, a second spring positioned proximate a second surface of the second mounting plate, and a second heat sink positioned proximate the second mounting plate. In one aspect, the second mounting plate comprises at least one opening or reduced thickness area. In one aspect, at least one of the first and second heating elements comprises e.g., copper plated with silver. In one aspect, at least one of the first and second heating elements comprises e.g., a copper alloy plated with silver. In one aspect, at least one of the first and second heating elements comprises e.g., a 110 copper alloy plated with silver. In one aspect, at least one of the at least one opening of the second mounting plate is sized to house a thermistor. In some aspects, the first movable heating zone and the second movable heating zone can independently move in a Z-axis direction. In some aspects, the microfluidic cartridge moves in a X-axis direction while the first and second movable heating zones independently contact the PCR module component of the microfluidic cartridge from the Z-axis. In this manner, the microfluidic cartridge is contacted with the first or second movable heating zones independently, and the spring component of each said heating zone independently allows for efficient contact of the first and second surface to the PCR module component of the microfluidic cartridge.

In some aspects, also disclosed herein are introduction elements for introducing a sample to a microfluidic cartridge. In some aspects, a sample introduction element for introducing a sample to a microfluidic ship comprises a cap having one or more engaging members positioned equidistant from each other around a circumference of the cap and one or more first coupling elements and an introduction element. The introduction element comprises an opening through the introduction element and an aperture through the introduction element. The opening and/or the aperture may allow fluids to flow. For example, the opening may be used for sample introduction. The opening through the introduction element may be defined by an annular ring. A chimney may be positioned within the opening. The chimney may include an aperture extending through the chimney. The chimney aperture has an internal cross-sectional area that is less than an internal cross-sectional area of the opening. For example, an internal cross-sectional area of the aperture may be from 5 to 50%, from 5 to 20%, from 5 to 15%, or from 5 to 10% of a cross-sectional area of the opening, or a value that is any of the aforementioned values or a value between any of the aforementioned values. In some embodiments, an internal cross-sectional area of the aperture may be about 5, 6, 7, 8, 9, 10, 1,1 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% of a cross-sectional area of the opening. In some embodiments, an internal cross-sectional area of the aperture may be about 6.5% of a cross-sectional area of the opening. The chimney may be a hollow cylinder defined by the aperture and the opening. The chimney may extend beyond the annular ring defining the opening at both ends. The introduction element may include a cap capable of maintaining a closed position under pressure. Closure features such as friction elements may be selected to withstand a predetermined pressures during use. Closure features may include one or more engaging members. In some instances, the closure features may include four engaging members. The opening and the aperture may be positioned such that they correspond to separate channels in a microfluidic cartridge during use.

The introduction element may include a cap, hinge, and cup. The cap and cup may include coupling elements to couple the cap to the cup of the introduction element. The first and second openings are independently connected to separate channels in the microfluidic cartridge. In some aspects, the first opening is fluidically connected to an air vent port and the second channel is fluidically connected to the sample microfluidic channel. In some aspects, the aperture is disposed on a vertical channel configured to be within the interior of the introduction element at a height greater than a plane comprising the first opening and less than the ceiling of the interior of the introduction element. In one aspect, the cap and the cup on the introduction element are coupled together using a pressure fit during use. In one aspect, the one or more engaging members comprises four engaging members. In one aspect, at least one of the cap and the introduction element comprises e.g., polypropylenc.

In some embodiments, the introduction element comprises a vent port which comprises a self-sealing plug. The vent port vents excess positive pressure from the sample introduction cup and lysis chamber fluidic channels. If fluid enters the vent port, it seals to prevent any fluid from exiting the vent port. The vent port can comprise a hydrogel (e.g., cellulose, polyacrylate, polyacrylic acid, and copolymers thereof) which, when wet, will expand to seal the vent port. In some embodiments, the exit element comprises a vent port which comprises a self-scaling plug. The vent port vents excess positive pressure from the waste chamber. If fluid enters the vent port, it seals to prevent any fluid from exiting the vent port and waste chamber.

In some aspects, also disclosed herein are systems for detecting one or a plurality of selected nucleic acid sequences. In some aspects a system for detecting one or a plurality of selected nucleic acid sequences comprises a microfluidic cartridge, a rotatable valve, and an analytic device. The microfluidic cartridge comprises a sample collection cup, one or a plurality of PCR chambers, one or a plurality of waste reservoirs, at least one path through the microfluidic cartridge, and a valve engaging member formed of unitary construction with the microfluidic cartridge. The rotatable valve comprises one or more openings extending laterally through the valve proximate a surface of the valve. The analytic device comprises one or more pumps positioned to engage a portion of the microfluidic cartridge during use, two or more heating elements positionable proximate to a predetermined surface of the microfluidic cartridge, one or more light sources, and one or more image capturing devices.

Accordingly, it is an object of the invention to not encompass within the invention any previously known product, process of making the product, or method of using the product such that Applicants reserve the right and hereby disclose a disclaimer of any previously known product, process, or method.

It is noted that in this disclosure and particularly in the claims, terms such as “comprises”, “comprised”, and “comprising” and the like (e.g., “includes”, “included”, “including”, “contains”, “contained”, “containing”, “has”, “had”, “having”, etc.) can have the meaning ascribed to them in US Patent law, i.e., they are open ended terms. For example, any method that “comprises,” “has” or “includes” one or more steps is not limited to possessing only those one or more steps and also covers other unlisted steps. Similarly, any plant that “comprises,” “has” or “includes” one or more traits is not limited to possessing only those one or more traits and covers other unlisted traits. Similarly, the terms “consists essentially of” and “consisting essentially of” have the meaning ascribed to them in US Patent law, e.g., they allow for elements not explicitly recited, but exclude elements that are found in the prior art or that affect a basic or novel characteristic of the invention. See also MPEP § 2111.03. In addition, the term “about” is used to indicate that a value includes the standard deviation of error for the device or method being employed to determine the value.

These and other embodiments are disclosed or are obvious from and encompassed by the following Detailed Description.

### DETAILED DESCRIPTION

### Brief Description of the Drawings

The following detailed description, given by way of example, but not intended to limit the invention solely to the specific embodiments described, may best be understood in conjunction with the accompanying drawing, in which:

FIG. 1 is a side perspective view of a representative embodiment of a system that includes an analyzing device and a microfluidic cartridge;

FIG. 2 is an exploded view of a representative embodiment of the microfluidic cartridge shown in FIG. 1.

FIG. 3A is a top view of a representative embodiment of the microfluidic cartridge shown in FIG. 2; FIG. 3B is a top view of an alternative representative embodiment of the microfluidic cartridge shown in FIG. 2 which includes a thermal break 2610 feature and a PCR module 2600 which is continuously aligned with the about four corners of the microfluidic cartridge;

FIG. 4 is a view of the underside of a representative embodiment of a top portion of the microfluidic cartridge shown in FIG. 3A.

FIG. 5A is a side view of an embodiment of a valve;

FIG. 5B is a top view of an embodiment of a valve;

FIG. 5C is a top perspective view of an embodiment of a valve;

FIG. 6A is a top perspective view of a portion of a microfluidic cartridge that includes a mixing chamber and a mixing channel wherein the mixing chamber 2504 is configured to be position upstream of the mixing channel 2500;

FIG. 6B is a top perspective view of a portion of a microfluidic cartridge that includes a mixing chamber and a mixing channel wherein the mixing chamber 2504 is configured to be position downstream of the mixing channel 2500;

FIG. 7 is a top perspective transparent view of a portion of a microfluidic cartridge that includes a mixing chamber;

FIG. 8A is a side transparent view of an embodiment of a mixing chamber;

FIG. 8B is a side cutaway view of an embodiment of a mixing chamber;

FIG. 9A is a top view of one representative embodiment of a PCR element;

FIG. 9B is a top view of an alternative representative embodiment of a PCR element, wherein the PCR overflow outlet port 2699 is configured to be positioned at a farther distance from the restriction element 2620 than the embodiment depicted in FIG. 9A;

FIG. 9C is a table that defines relationships between depths of the various sections of the PCR element shown in FIG. 9A;

FIG. 10A is a top view of an embodiment of a PCR element;

FIG. 10B is a table that defines relationships between widths of the various sections of the PCR element shown in FIG. 10A;

FIG. 11A is a top view of a representative embodiment of a PCR element;

FIG. 11B is a top view of an alternative embodiment of a PCR element;

FIG. 11C is a table that defines relationships between lengths of the various sections of the PCR element shown in FIG. 11A;

FIG. 12 is a top exploded view of a portion of a PCR element;

FIG. 13A is a side cross-sectional view of the interface between a valve and a microfluidic cartridge in transparent view;

FIG. 13B is a side cross-sectional view of a representative valve;

FIG. 14 is bottom view of an embodiment of a portion of a microfluidic cartridge;

FIG. 15 is a bottom view of an embodiment of a valve;

FIG. 16 is a bottom perspective view of the interface between an introduction element and a transparent cartridge;

FIG. 17 is a bottom view of a representative microfluidic cartridge portion of a microfluidic cartridge embodiment showing the fluid paths through the microfluidic channels;

FIG. 18A is a bottom view of a portion of a microfluidic cartridge of a microfluidic cartridge embodiment showing selected fluid paths through the microfluidic channels;

FIG. 18B is a bottom view of a portion of a microfluidic cartridge of a microfluidic cartridge embodiment showing selected fluid paths through the microfluidic channels;

FIG. 19 is a top perspective view of a representative embodiment of a microfluidic cartridge;

FIG. 20A is a bottom perspective view of a representative embodiment of a microfluidic cartridge;

FIG. 20B is a bottom perspective view of an alternative embodiment of a microfluidic cartridge which includes the thermal break 2610 thermally separating the microfluidic chip from the PCR module 2600;

FIG. 21 is a top view of a representative embodiment of a microfluidic cartridge;

FIG. 22A is a top perspective view of a representative embodiment of a microfluidic cartridge;

FIG. 22B is a top perspective view of an alternative embodiment of a microfluidic cartridge which includes a mixing chamber 2504;

FIG. 23 is a top perspective view of a portion of a representative embodiment of a microfluidic cartridge which includes a mixing chamber 2504 which comprises balls 2506a, 2506b, and 2506c which enhance mixing within the mixing chamber;

FIG. 24 is a top perspective view of a portion of a microfluidic cartridge which includes a primary waste reservoir 2700 which comprises an absorbent material 2704;

FIG. 25 is a top perspective view of an embodiment of a microfluidic cartridge;

FIG. 26A is a side view of an embodiment of a valve;

FIG. 26B is a bottom view of an embodiment of a valve;

FIG. 26C is a bottom perspective view of an embodiment of a valve;

FIG. 27A is a top view of an embodiment of a valve cover;

FIG. 27B is a top perspective view of an embodiment of a valve cover;

FIG. 28A is a side view of an embodiment of a valve cover;

FIG. 28B is a bottom view of an embodiment of a valve cover;

FIG. 28C is a bottom perspective view of an embodiment of a valve cover;

FIG. 29A is a top view of an embodiment of an introduction element;

FIG. 29B is a bottom view of an embodiment of an introduction element;

FIG. 29C is a side view of an embodiment of an introduction element;

FIG. 30 is a top perspective view of an embodiment of an introduction element;

FIG. 31 is a bottom perspective view of an embodiment of an introduction element;

FIG. 32 is an exploded view of a valve, a valve cap, and a portion of a representative microfluidic cartridge;

FIG. 33 is a side cross-sectional view of an assembled valve, valve cap, and portion of a representative microfluidic cartridge;

FIG. 34 is a top perspective view of an embodiment of a microfluidic cartridge;

FIG. 35A is a side view of a representative device for analyzing a microfluidic cartridge with a microfluidic cartridge;

FIG. 35B is a side view of an alternative representative device for analyzing a microfluidic cartridge with a microfluidic cartridge;

FIG. 36 is a top view of an alternative embodiment of a representative device for analyzing cartridges;

FIG. 37 is a partial top view of a device for analyzing cartridges;

FIG. 38 is view of elements of a lysing module for use in a device described herein;

FIG. 39 is perspective view of a rotating member for use in a lysing module;

FIG. 40 is top view of a lysis module path;

FIG. 41 is top view of a lysis module path with respect to a lysis chamber;

FIG. 42 is a top perspective view of a portion of a device embodiment showing a PCR module;

FIG. 43A is a side perspective view of a portion of one embodiment of a device embodiment showing a PCR module comprising a camera 3602 and a plurality of light sources 3603a and 3603b;

FIG. 43B is a side perspective view of a portion of an alternative embodiment of a device embodiment showing a PCR module comprising a camera 3602 and a plurality of light sources 3603a and 3603b;

FIG. 43C is a front perspective view of a portion of an alternative embodiment of a device embodiment showing a PCR module comprising a camera 3602 and a plurality of light sources 3603a and 3603b;

FIG. 44 is a side perspective view of an embodiment of a spring;

FIG. 45 is a side perspective view of an embodiment of a heating block acting as anneal element;

FIG. 46A is a top perspective view of an embodiment of a heating blocks for a PCR module;

FIG. 46B is a side view of an embodiment of the relative height positions of a heating blocks for a PCR module;

FIG. 46C is a side view of an embodiment of a first heating zone (selected from the denature element or anneal element) in contact proximate to the PCR module 2600 of the microfluidic cartridge 2000, where the heating zones move relative to a fixed Z-axis microfluidic cartridge position, while the microfluidic cartridge moves solely on an X-axis direction.

FIG. 46D is a side view of an embodiment of a second heating zone (selected from the denature element or anneal element) in contact proximate to the PCR module 2600 of the microfluidic cartridge 2000, where the heating zones move relative to a fixed Z-axis microfluidic cartridge position, while the microfluidic cartridge moves solely on an X-axis direction.

FIG. 47 is a top perspective view of an embodiment of a heating block for a PCR module;

FIG. 48A is a top perspective view of an embodiment of a heating block for a PCR module;

FIG. 48B is an exploded view of an embodiment of a heating block for a PCR module;

FIG. 49 is a top perspective view of an embodiment of a heating block for a PCR module;

FIG. 50 is an exploded view of an embodiment of a heating block for a PCR module;

FIG. 51 is a graph of a representative heater profile for use in this system and device, where the Y-axis is Temperature (C), and the X-axis is time (seconds);

FIG. 52A is a top view of the separately activated flow paths for one embodiment of the microfluidic cartridge;

FIG. 52B is a top view of the separately activated flow paths for one embodiment of the microfluidic cartridge;

FIG. 53A is a top view of one embodiment of the microfluidic cartridge configuration where the valve is selected to connect the sample loading chamber to lysis chamber and then to the extraction chamber and then to waste;

FIG. 53B is a top view of one embodiment of the microfluidic cartridge configuration where the valve is selected to connect the sample loading chamber to lysis chamber and then to the extraction chamber and then to waste;

FIG. 54A is a top view of one embodiment where the valve is selected to connect the wash buffer reservoir to the extraction chamber and then to waste;

FIG. 54B is a top view of one embodiment where the valve is selected to connect the wash buffer reservoir to the extraction chamber and then to waste;

FIG. 55A is a top view of one embodiment where the valve is selected to connect the elution buffer chamber to the extraction chamber to elute the purified sample from the silica membrane in the extraction chamber into the PCR chambers and then to waste; During the flow path from the extraction chamber to the PCR chambers is a mixing channel and one or a plurality of PCR reagent zones 2204 which comprise lyophilized PCR master mix reagents as described herein;

FIG. 55B is a top view of one embodiment where the valve is selected to connect the elution buffer chamber to the extraction chamber to elute the purified sample from the silica membrane in the extraction chamber into the PCR chambers and then to waste; During the flow path from the extraction chamber to the PCR chambers is a mixing channel which may comprise PCR reagents as described herein;

FIG. 56A is a top view of one embodiment where the valve is selected to connect exogenous pressure to the PCR chambers through the mixing chamber to ensure the eluted sample has passed through the mixing channel into the PCR chambers;

FIG. 56B is a top view of an alternative embodiment where the valve is selected to connect exogenous pressure to the PCR chambers through the mixing chamber to ensure the eluted sample has passed through the mixing channel into the PCR chambers and filled the fluidics regions of the PCR module;

FIG. 57A is a top view of one embodiment where the valve is selected to break fluidic communication from the PCR chambers with the other channels in the microfluidic cartridge so that the sample is confined to the PCR chambers during the PCR steps;

FIG. 57B is a top view of an alternative embodiment where the valve is selected to break fluidic communication from the PCR chambers with the other channels in the microfluidic cartridge so that the sample is confined to the PCR chambers during the PCR steps;

FIGS. 58A and 58B show normalized PCR amplification curves for the first replicate in each well of the microfluidic cartridge;

FIG. 59A shows the normalized PCR amplification curve for each well of the microfluidic cartridge using Cy5 fluorescence;

FIG. 59B shows the normalized PCR amplification curve for each well of the microfluidic cartridge using 6-FAM fluorescence;

FIG. 60A shows the raw images of scanned PCR chambers in the Cy5 channel after 1 PCR cycle;

FIG. 60B shows the raw images of scanned PCR chambers in the Cy5 channel after after 25 PCR cycles; and

FIG. 60C shows the raw images of scanned PCR chambers in the Cy5 channel after after 36 PCR cycles.

FIG. 61 shows the concentration versus total cycling time for a series of PCR reactions performed using the systems and methods of this disclosure, wherein the total PCR time is under 5 minutes at a selected DNA input concentration.

FIG. 62A, FIG. 62B, and FIG. 62C show an embodiment of a sample input cartridge that is configured to separately receive a sample swab (not shown) comprising a patient sample. The sample input cartridge is separate from the microfluidic cartridge, and can be mated with the microfluidic cartridge after receiving a sample into the sample input chamber 6204 and enclosed with a resealable cap 6202.

FIG. 62A shows a top perspective view of an embodiment of a sample input cartridge.

FIG. 62B shows a bottom perspective view of an embodiment of a sample input cartridge.

FIG. 62C shows a top view of an embodiment of a sample input cartridge.

FIG. 63 shows an alternative embodiment of a microfluidic cartridge.

FIG. 64A and FIG. 64B show embodiments of a pricking post system.

FIG. 64A shows a top perspective view of a pricking post system.

FIG. 64B shows a top view of a pricking post system.

FIG. 65 shows a top perspective view of a sample input cartridge mated to an embodiment of a microfluidic cartridge.

FIG. 66 shows an alternative embodiment of the microfluidic cartridge with additional features as described herein, including an exploded view of a closed sample input cartridge preparing with alignment and engagement with the microfluidic cartridge including the pricking post system of the microfluidic cartridge.

FIG. 67 shows an alternative embodiment of the microfluidic cartridge with additional features as described herein, including an exploded side view of a closed sample input cartridge preparing for alignment and engagement with the microfluidic cartridge.

FIG. 68 shows an alternative embodiment of the microfluidic cartridge with additional features as described herein, including an exploded top view of a closed sample input cartridge mated with the microfluidic cartridge.

FIG. 69 shows an alternative embodiment of the microfluidic cartridge with additional features as described herein, including an exploded side view of engagement features on the microfluidic cartridge for the sample input cartridge.

FIG. 70 shows an alternative embodiment of the microfluidic cartridge with additional features as described herein, including an exploded top view of the piercer post system for engagement with the sample input cartridge.

FIG. 71 shows an alternative embodiment of the microfluidic cartridge with additional features as described herein, including an expanded view of a lysis chamber.

FIG. 72 shows an alternative embodiment of the microfluidic cartridge with additional features as described herein, including a projected side view of the microfluidic cartridge and a sample input cartridge engaged with the microfluidic cartridge.

FIG. 73 shows an alternative embodiment of the microfluidic cartridge with additional features as described herein, including an exploded view of a sample input cartridge preparing for alignment and engagement with the microfluidic cartridge, including the piercer post system and alignment posts of the microfluidic cartridge.

FIG. 74 shows an alternative embodiment of the microfluidic cartridge with additional features as described herein, including an exploded side view of a sample input cartridge preparing for alignment and engagement with the microfluidic cartridge, including the alignment posts of the microfluidic cartridge.

FIG. 75 shows an alternative embodiment of the microfluidic cartridge with additional features as described herein, including an exploded top view of a sample input cartridge engaged with the microfluidic cartridge.

FIG. 76 shows an alternative embodiment of the microfluidic cartridge with additional features as described herein, including an expanded view of a sample mixing channel.

FIG. 77 shows an alternative embodiment of the microfluidic cartridge with additional features as described herein, including a side view of the sample input cartridge engaged with the microfluidic cartridge.

FIG. 78 shows an alternative embodiment of the microfluidic cartridge with additional features as described herein, including a top view of the microfluidic cartridge engaged with the sample input cartridge.

FIG. 79 shows an alternative embodiment of the microfluidic cartridge with additional features as described herein, including an exploded Iso view of a valve and cage of the microfluidic cartridge engaged with the sample input cartridge.

FIG. 80 shows an alternative embodiment of the microfluidic cartridge with additional features as described herein, including an exploded side view of a valve and cage of the microfluidic cartridge engaged with the sample input cartridge.

FIG. 81 shows an alternative embodiment of the microfluidic cartridge with additional features as described herein, including an exploded side view of a sample input cartridge preparing for alignment and engagement with guide wall engagement features of the microfluidic cartridge.

FIG. 82 shows an alternative embodiment of the microfluidic cartridge with additional features as described herein, including an Iso exploded view of a sample input cartridge preparing for alignment and engagement with guide wall engagement features and a pricking post system of the microfluidic cartridge.

FIG. 83 shows an alternative embodiment of the microfluidic with additional features as described herein, including a side view of guide wall engagement features of the microfluidic cartridge, for engagement with a sample input cartridge.

FIG. 84 shows an alternative embodiment of the microfluidic cartridge with additional features as described herein, including a top view of input sample cartridge engagement features of the microfluidic cartridge, including alignment walls and alternative pricking post system engagement features.

FIG. 85 shows an alternative embodiment of the microfluidic cartridge with additional features as described herein, including an expanded view of the Cartridge Lysis Chamber.

FIG. 86 shows an alternative embodiment of the microfluidic cartridge with additional features as described herein, including a top view of a sample input cartridge engaged with a microfluidic cartridge.

FIG. 87 shows an alternative embodiment of the microfluidic cartridge with additional features as described herein, including an expanded view of a sample mixing channel.

FIG. 88 shows an alternative embodiment of the microfluidic cartridge with additional features as described herein, including an exploded iso view of a cartridge valve and cage of alignment walls.

FIG. 89 shows an alternative embodiment of the microfluidic cartridge with additional features as described herein, including an exploded side view of a cartridge valve and a cage of alignment walls engaged with an embodiment of a sample input cartridge.

FIG. 90 shows an alternative embodiment of the microfluidic cartridge with additional features as described herein, including a top view of a cartridge valve and a cage of alignment walls engaged with an embodiment of a sample input cartridge.

FIG. 91 shows an alternative embodiment of the microfluidic cartridge with additional features as described herein, including a cartridge valve holder in locked position, and an engaged sample input car.

FIG. 92 shows an alternative embodiment of the microfluidic cartridge with additional features as described herein, including a cartridge valve holder in open position.

### CERTAIN DEFINITIONS

Every embodiment of the disclosure may optionally be combined with any one or more of the other embodiments described herein which are consistent with that embodiment.

Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values. In certain embodiments, the term “about” or “approximately” means within 10 percent or 5 percent of the specified value.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

The term “sample” as used herein, refers to a sample containing biological material. A sample may be, e.g., a fluid sample (e.g., a blood sample) or a tissue sample (e.g., a check swab). A sample may be a portion of a larger sample. A sample can be a biological sample having a nucleic acid, such as deoxyribonucleic acid (DNA) or ribonucleic acid (RNA), or a protein. A sample can be a forensic sample or an environmental sample.

A sample can be pre-processed before it is introduced to the system. In some embodiments, the preprocessing can include extraction from a material that would not fit into the system, quantification of the amount of cells, DNA or other biopolymers or molecules, concentration of a sample, separation of cell types such as sperm from epithelial cells, concentration of DNA or bead processing or other concentration methods or other manipulations of the sample. A sample can be carried in a carrier, such as a swab, a wipe, a sponge, a scraper, a piece punched out a material, a material on which a target analyte is splattered, a food sample, a liquid in which an analyte is dissolved, such as water. A sample can be a direct biological sample such as a liquid such as blood, semen, saliva, or a biological fluid as described herein; or a digested solid such a solid tissue sample (e.g., FFPE) or flesh.

The invention can also be applied to process and analyze a sample that has been previously preprocessed, for example, by extraction of DNA and other processing which may include quantification of DNA concentration, cell concentration, or other manipulations before input of the pre-processed sample into the sample cartridge.

The term “module” as used herein, refers to a device or component as part of a larger device, instrument or system.

### Systems

The present disclosure provides a system used to analyze biological samples. The system may be used to analyze samples using methods including but not limited to sample extraction, metered loading of a sample volume into an analytical system, sample lysis, extraction of nucleic acids from the lysed sample, and detecting target analytes, e.g., nucleic acids, polypeptides or peptides, and/or post-translational modifications of polypeptides or peptides, such as phosphorylation or glycosylation.

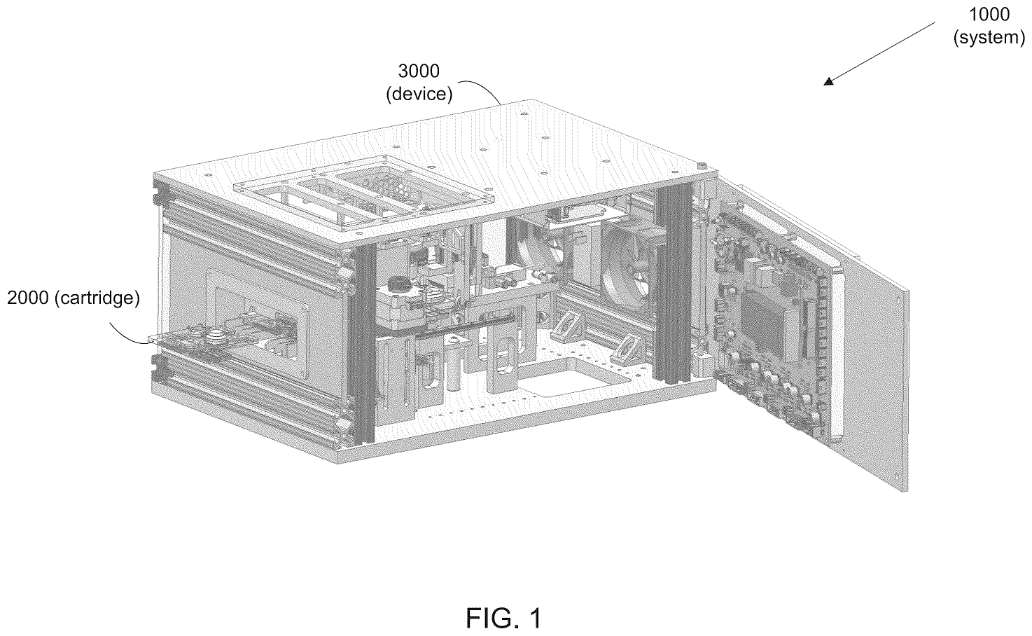

The system as described herein may include an analyzing device and a microfluidic cartridge having a microfluidic elements. As shown in FIG. 1, a system 1000 includes cartridge 2000 and device 3000. In some embodiments, a microfluidic cartridge 2000 may be used to analyze samples using device 3000.

The device 3000 may include multiple modules for performing, e.g., sample extraction, metered loading of a pre-determined sample volume into an analytical system, sample lysis, extraction of nucleic acids from the lysed sample, and detecting target nucleic acids in a microfluidic cartridge. Cartridges 2000 that include a microfluidic cartridge may be used to facilitate analysis of the sample in the device. For example, a microfluidic cartridge may be used to subject a sample to analysis such as nucleic acid analysis, e.g., polymerase chain reactions.

Samples may include, but are not limited to saliva, mucus, bile, breast milk, tears, nasal aspirate, blood, plasma, urine, vaginal excretion, feces, CSF (cerebrospinal fluid), sweat, serum, pus, phlegm, semen, buccal swab, digested tissues (which can include or exclude FFPE samples), and/or other bodily fluids. In some embodiments, a sample introduced into the system may be processed prior to introduction to remove some constituents. Samples introduced into a microfluidic cartridge may include multiple constituents including, for example nucleic acids and/or PCR inhibitors.

To prepare the sample for analysis it may be necessary to treat the sample. In some embodiments, a sample may be introduced to a microfluidic cartridge and then transported to various elements on the microfluidic cartridge for mixing, lysing, capturing, binding, washing, and/or extracting constituents of the sample prior to amplification using a nucleic acid test (NAT), for example, a nucleic acid amplification test (NAAT) such as polymerase chain reaction (PCR). For example, a biological sample in a microfluidic cartridge may be subjected to a predetermined process in a device of the system that includes lysing, mixing, capturing, binding, washing, and/or extracting constituents of the sample prior to amplification of a target by PCR.

Microfluidic cartridges of this disclosure may be used to process samples. In some embodiments samples delivered to the introduction element may be released to the microfluidic cartridge in a metered manner such that only predetermined volumes of sample are moved to a particular module at a predetermined time. For example, pressures may be applied at ports to cause predetermined amount of fluid flow from the introduction element. Further, a chimney element in the introduction element may help pressurization portions of the microfluidic cartridge to cause the desired flow. In some aspects samples of a predetermined volume or volume range are introduced to the microfluidic cartridge. In some embodiments the sample is between 250-300 μL (microliters).

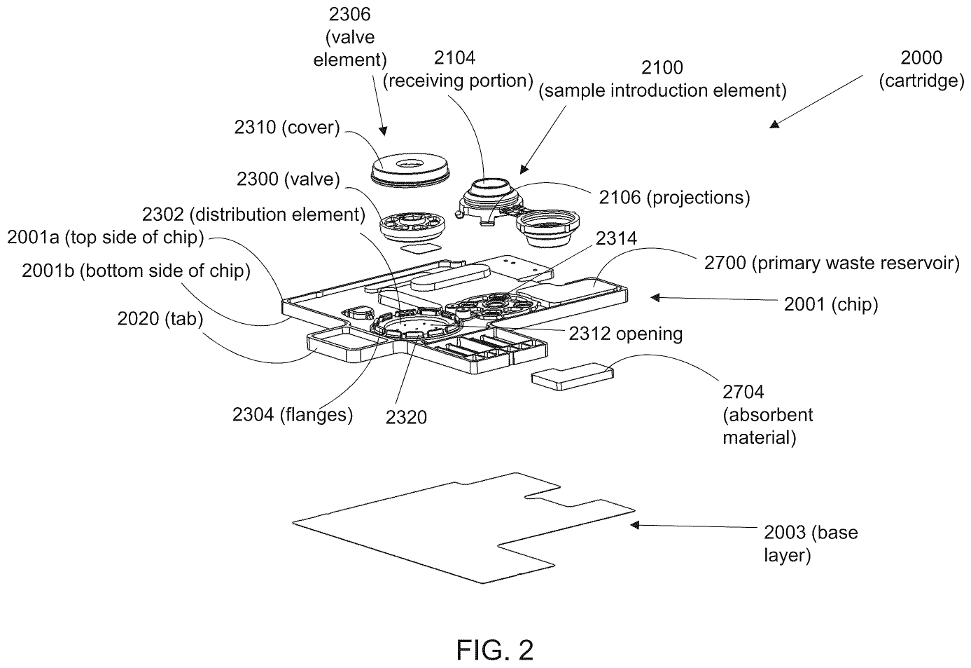

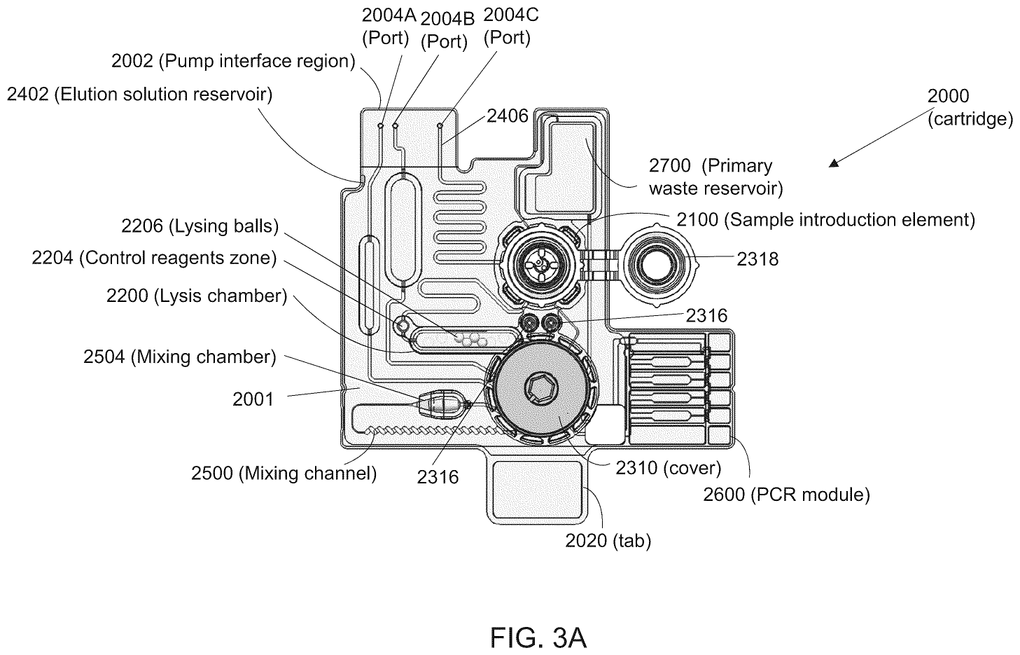

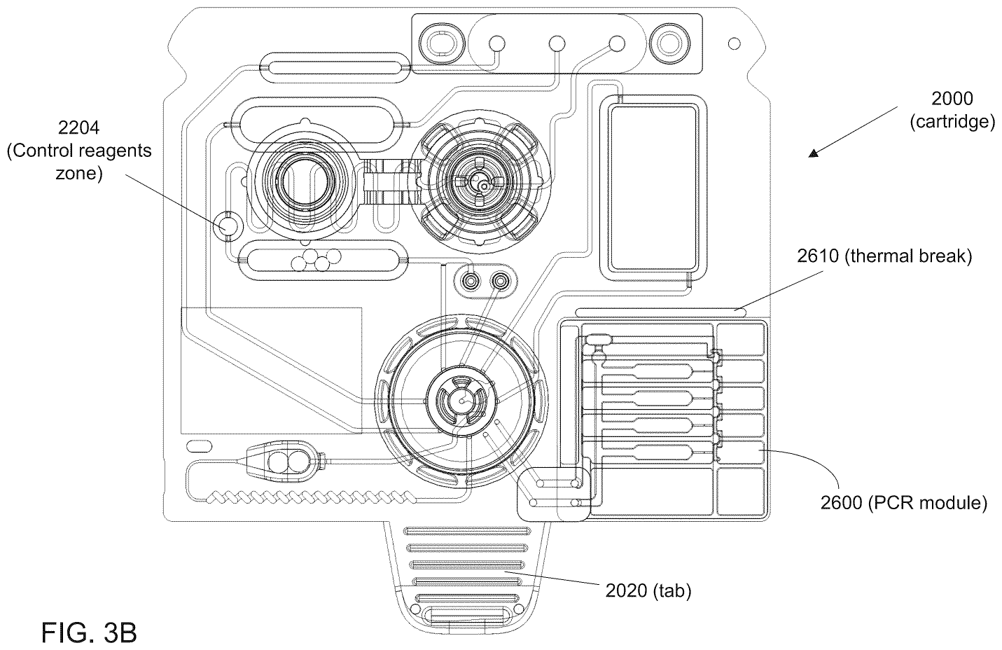

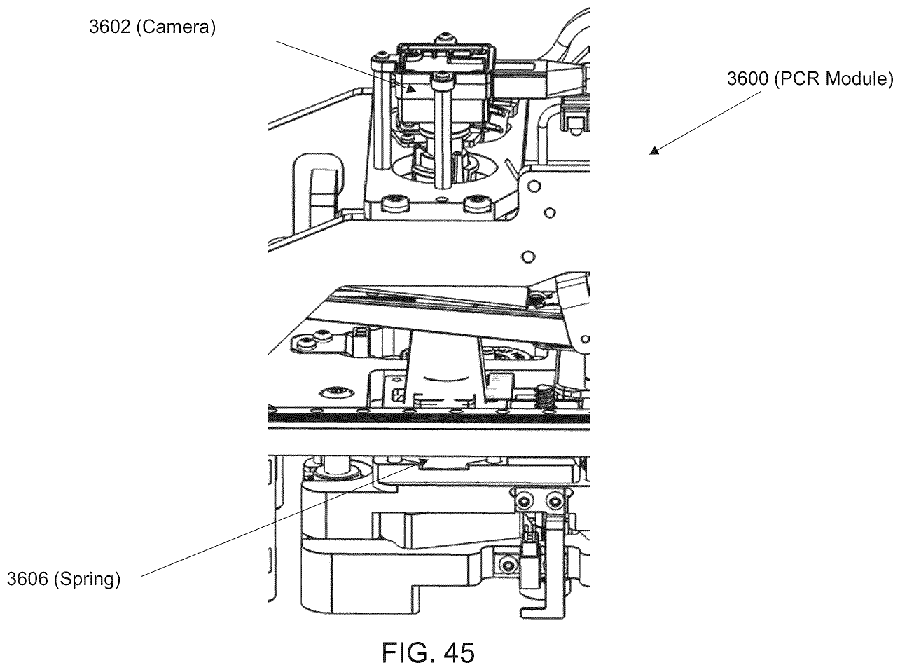

As shown in FIGS. 3, 20, 22, 24, 25, 28, 45, 54, for example, geometries of cartridges 2000 may vary. Microfluidic cartridges 2000 may be configured to be positioned within device in a particular orientation. To achieve this, microfluidic cartridges may include positioning elements to ensure proper positioning of the microfluidic cartridge within the device and/or facilitate proper movement including, but not limited to projections such as tabs, openings, cut-outs, or the like. FIGS. 2-3 depict embodiments of cartridge 2000 having tab 2020 for handling and/or placing cartridge 2000 in device 3000.

Further, positioning elements on cartridges 2000 may ensure that the sample is processed properly and/or in a pre-determined manner. For example, a microfluidic cartridge 2000 may have a geometry that enables the microfluidic cartridge 2000 to take a pre-determined pathway through the device 3000. To achieve this, cartridges 2000 may include elements to ensure proper positioning of the microfluidic cartridge within the device and/or facilitate proper movement within the device including, but not limited to projections such as tabs (e.g., tab 2020), openings, cut-outs, or the like.

In some embodiments, a method of analysis may require that samples are subjected to various conditions in a particular order. Thus, it may be desirable to position a microfluidic cartridge 2000 such that portions of the microfluidic cartridge come in contact with specific modules within the analyzing device 3000 in a particular order. During use, cartridges 2000 may be subjected to modules sequentially, simultaneously, or a combination thereof.

In this manner, the microfluidic cartridge geometry may allow specific portions of the microfluidic cartridge 2000 to contact modules in a pre-determined manner. Device(s) 3000 may include geometries and/or elements that engage a portion of a microfluidic cartridge 2000. In some embodiments, a microfluidic cartridge 2000 may be designed such that it couples to a bracket in the device 3000.

In some embodiments, external geometries of the microfluidic cartridge 2000, as well as placement of components within the microfluidic cartridge 2000 may be coordinated with a configuration of the modules within the device 3000. For example, one or more modules may be used in combination to analyze the contents of a sample. In particular, cartridges 2000 may be subjected to analysis for biological samples and their constituents, e.g., nucleic acids, polypeptides, peptides and/or post-translational modifications such as glycosylation or phosphorylation.

Cartridges may include but are not limited to components such as caps, covers, channels, valves, pumps, flow sensors, chambers for example, reservoirs, extraction chambers, mixing chambers, lysing chambers, reactors, etc., inlets, for example, cups such as sample introduction elements, friction elements, outlets, ports, vents, or any other element known in the art. For example, an embodiment of a microfluidic cartridge may include an introduction element, a rotatable valve, a mechanical lysis chamber, a extraction chamber, a waste reservoir, a wash solution reservoir, an elution solution reservoir, one or more mix zones, a mixing channel, and two or more PCR chambers.

FIG. 2 depicts an exploded view of cartridge 2000 that shows separate components used in some cartridge embodiments. Components of a microfluidic cartridge may be formed by one or more process including but not limited to molding such as an injection molding process, overmolding, thermoforming, cutting, for example, by etching or routing out material in areas of interest and/or additive manufacturing such as 3D printing, laser sintering.

Cartridge 2000 includes sample introduction element 2100, cover 2310, valve 2300, absorbent material 2704, microfluidic cartridge 2001, and base layer 2003. The microfluidic cartridge 2001 may be formed such that there are structures on both a top side and a bottom side of the cartridge. For example, microfluidic cartridge 2001 of cartridge 2000 includes projections 2304 and openings 2312, 2314. In some embodiments, the microfluidic cartridge may be formed in a single process. In particular, the microfluidic cartridge and/or the base layer may be formed during a molding process. For example, the microfluidic cartridge may be formed using an injection molding process in a unitary manner.

In some embodiments, the microfluidic cartridge and/or one or more structures on the microfluidic cartridge may be formed by cutting, for example, by etching or routing out material in the area of interest and/or additive manufacturing such as 3D printing, laser sintering, in particular selective laser sintering.

In some embodiments, materials used in the microfluidic cartridge may include but are not limited to glass, silicon, ceramics such as aluminum oxides, polymers such as elastomers for example, polydimethylsiloxane (PDMS) and/or thermoset polyester (TPE), thermoplastics for example, cyclic olefin copolymers (COC), cyclo-olefin polymer (COP), polystyrene (PS), polycarbonate (PC), polymethyl methacrylate (PMMA), poly(ethylene glycol) diacrylate (PEGDA), perfluorinated compounds (PFEP, PFA, PFPE), polyurethane (PU), Topaz™, Zeonor™, foil, e.g., aluminum foil, and/or combinations thereof.

During use a sample introduction element, valve element, and valve cover may be coupled to a microfluidic cartridge using projections, openings, or combinations thereof. As shown in FIG. 2, introduction element 2100 includes receiving portion 2104 having projections 2106. Projections 2106 are used in the embodiment shown in FIG. 2 to couple the introduction element 2100 to the microfluidic cartridge 2001.

As depicted microfluidic cartridge 2001 includes distribution element 2302 includes lip 2320, flanges 2304, and openings 2312 on top side 2001a. The openings 2312 extend through the microfluidic cartridge 2001 to the bottom side 2001b.

In some embodiments, reservoirs, chambers, zones, and/or channels are in fluidic communication depending on a position of a valve at a distribution element. For example, the microfluidic cartridge can be configured such that engagement with the distribution element of the microfluidic cartridge and movement of the valve may create a flow path between two chambers through a channel (e.g., a segment of a channel) and/or may create a flow path between two channels (e.g., channel segments). Valves may be used to route the passage of fluids in the channels, e.g., between a first pathway and a second pathway. Valves for use in a microfluidic cartridge as described in this system may be rotatable. For example, a rotatable valve may be used to allow the valve to enable different channels to be put into fluid communication depending on the orientation of the valve.

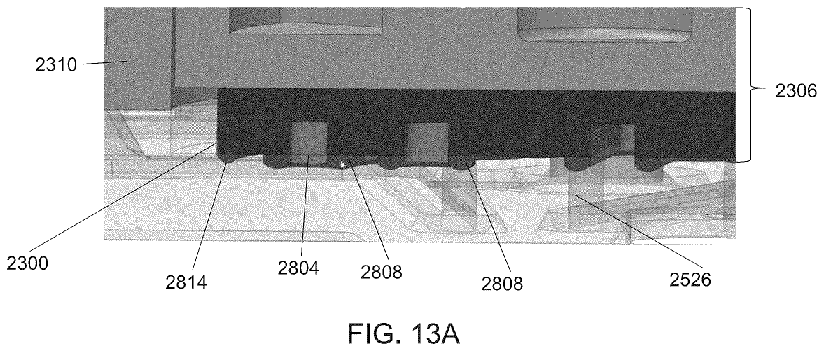

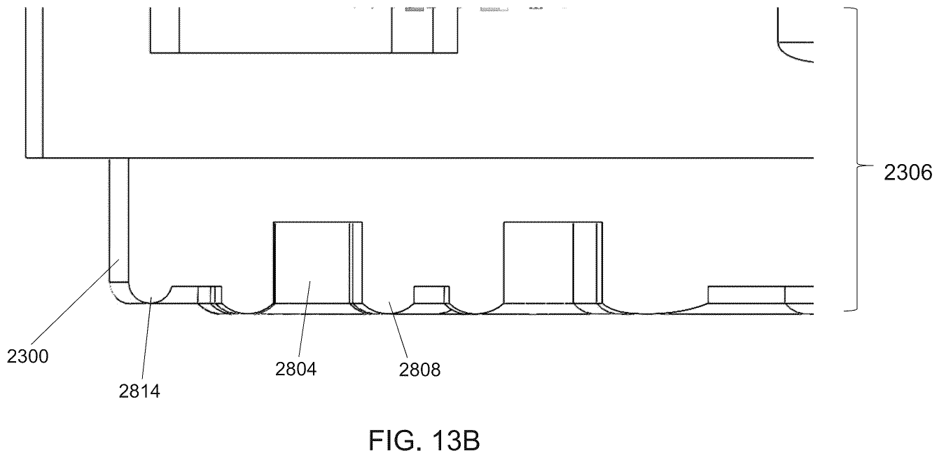

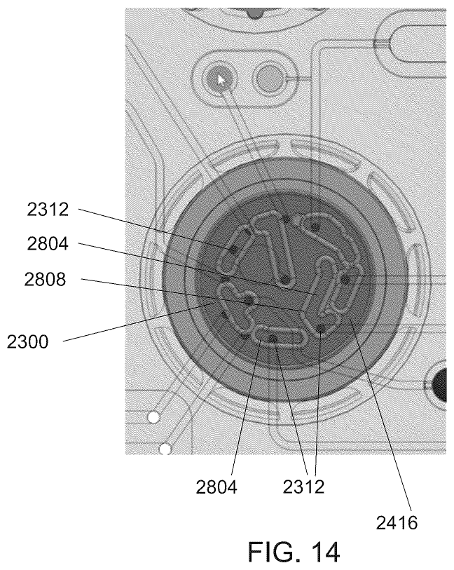

Valve 2300 (shown in FIG. 2) is used to control the flow of liquids through the microfluidic cartridge 2001 when assembled during use. The cover 2310 may ensure that the valve 2300 is coupled to the microfluidic cartridge 2001 by forming a friction fit with elements of the microfluidic cartridge 2001. The cover 2310 may have a geometry that engages at least a portion of a microfluidic cartridge 2000. For example, in the embodiment depicted in FIG. 2, valve 2300 and cover 2310 couple to microfluidic cartridge 2001 at distribution element 2302 using flanges 2304. In some embodiments, the valve comprises a key slot or key configuration, as shown in the embodiments represented in FIG. 13A, FIG. 13B, and FIG. 14. The key configuration allows for absolute control of the valve position with respect to the rotating shaft which is connected to a controllable stepper motor.

In some instances, chambers, channels, zones, and/or reservoirs may include materials loaded into areas of the microfluidic cartridge prior to assembly. For example, materials that may be preloaded into structures on the microfluidic cartridge include, but are not limited to balls, bearings, absorbent materials, reagents such as mastermix reagents, polymerase, buffer, salt, nucleotides, primers, probes, enhancers, stabilizers, and nuclease-free water, desiccated and/or lyophilized materials including buffers such as lysis buffers, elution buffers, wash buffers, collection buffers, etc., control reagents such as standards, negative controls, positive controls such as a nucleic acid having a known sequence, carrier RNA (cRNA), and/or a polyA cRNA and/or combinations thereof. In some embodiments, the master reagents are reagents for LAMP (Loop-Mediated Isothermal Amplification), DNA sequencing (NGS or Sanger), hybridizing to a microarray, hybridization to a labeled bead (Luminex assay), gel electrophoresis, qPCR (quantitative PCR), RT-PCR (reverse transcriptase-PCR, or alternatively real-time PCR), CRISPR-based genetic analysis (e.g., Mammoth Biosciences DETECTR™ assay), and mass spectrometry (Agena Bioscience MASSARRAY™ assay), or an immunoassay. In some aspects, the qPCR reagents are selected from: Taqman™, Scorpions™, Amplifluor, LUX, Cyclicons, Angler, or Molecular Beacons™. In some aspects, the RT-PCR reagents comprises NxtScrip reverse transcriptase (Roche). In some aspects, the qPCR reagents comprise Ttx polymerase (Toyobo, Japan). In some aspects, the DNA sequencing reagents include adapters that include or exclude unique molecular identifiers, non-unique molecular identifiers, sample barcodes, universal or target specific amplification or sequencing primer sites, or hybridization sites. In some instances, the control reagent is a nucleic having a specific percentage homology. For example, a control reagent may include a sequence MS2 DNA (SEQ ID NO: 1).

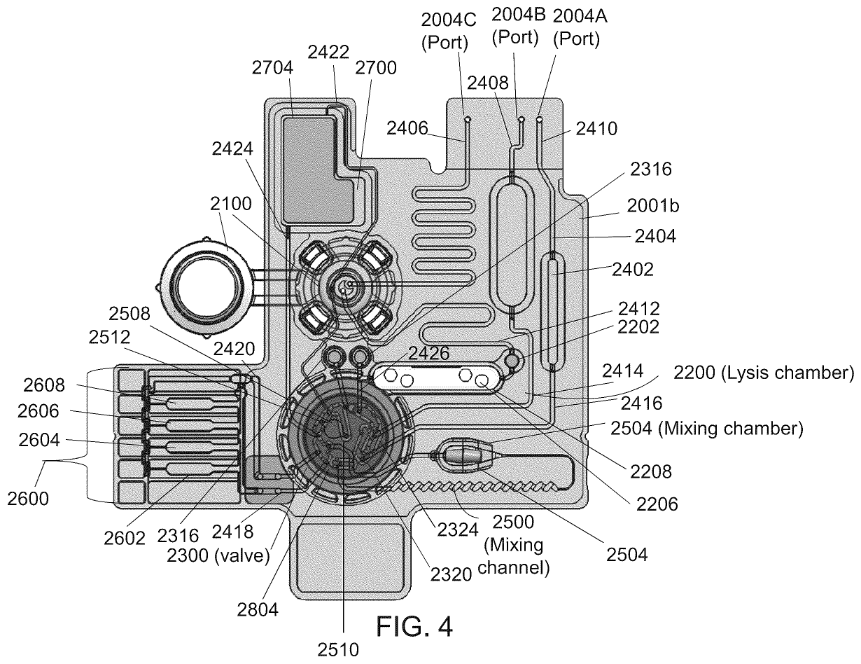

In some embodiments, cartridges are pre-loaded with reagents in chambers for performing one or a series of chemical or biochemical reactions. Accordingly, cartridges may be structured to inhibit and in some cases to prevent leakage of the materials from the microfluidic cartridge and/or to inhibit or prevent mixing of materials (e.g., reagents) until desired. Such a configuration is useful for shipping or otherwise transporting reagents in isolation. As shown in FIG. 3, cartridge 2000 vent ports 2316, 2316 that are, initially, fluidically separated from each other. In some embodiments, reagent zones 2204 as depicted in FIGS. 3-4 may include an internal control. Internal controls may include nucleic material. For example, nucleic material may be deposited on beads. In particular, bacteriophage MS2 (MS2) and/or carrier RNA (cRNA) may be deposited on lyophilized beads. The lyophilized beads can be pre-impregnated into one or a plurality of reagent zones within the microfluidic channels of the microfluidic cartridge.

Some embodiments of a microfluidic cartridge may include all materials necessary to complete analysis for one or more targets except the sample. Alternatively, all materials necessary to complete analysis may be included except for the sample and/or fluids (e.g., air) provided to move sample materials through the microfluidic cartridge. For example, pressure may be introduced into the microfluidic cartridge at various ports to move and/or meter fluids in the system. In some instances, excess fluids may be directed toward a waste reservoir.

In some embodiments, the microfluidic cartridge can be assembled by bonding a substrate comprising microfluidic channels and other microfluidic features described herein and a top plate which comprises holes which are aligned to selected regions of the microfluidic features. In some embodiments, the bonding method can be selected from high pressure, thermal or solvent-assisted, or ultrasonic welding. In preferred embodiments, the microfluidic cartridge can be assembled by ultrasonic welding.

In particular, reservoirs, such as a wash buffer reservoir or an elution reservoir may be preloaded with a predetermined amount of wash buffer and elution solution, respectively. Volumes of the reservoirs may depend on the type and/or number of targets to be analyzed for, as well as the method of analysis. A wash buffer reservoir may have a volume in a range from about 315 to about 585 microliters. In a particular case, a wash buffer reservoir have a volume in a range from about 405 to about 495 microliters. For example, a wash buffer reservoir have a volume of about 450 microliters. An elution solution reservoir may have a volume in a range from about 56 to about 104 microliters. In a particular case, an elution solution reservoir have a volume in a range from about 72 to about 88 microliters. For example, an elution solution reservoir have a volume of about 80 microliters.

To ensure rehydration of lyophilized solids and fluids within a microfluidic cartridge 2000 are properly mixed (homogenous) some elements may be provided in the microfluidic cartridge 2001 that enhance mixing. In some embodiments, constituent concentrations may be influenced and/or controlled using turbulent flow. In particular, fluid concentrations may be homogenized by turbulent flow mixing. For example, fluid flow may be controlled such that a predetermined constituent concentration at an outflow of a mixing element is within a predetermined range relative to the total fluid volume.

As shown in FIG. 2, absorbent material 2704 is sized to fit in reservoir 2700 which is open on bottom side 2001b (shown in FIG. 4).

As shown in FIG. 3A, valve cover 2310, valve 2300 (not shown), vent port 2316, and cap 2318 are positioned on microfluidic cartridge 2001 of cartridge 2000. Microfluidic cartridge 2001 includes PCR element 2600 with multiple PCR chambers 2602 as well as lysis chamber 2200 including balls 2206.

As shown in FIG. 3B, in some embodiments, PCR element 2600 can be thermally isolated from the other features of the microfluidic cartridge 2001 by a thermal break 2610. The thermal break is a region of the microfluidic cartridge that has a low thermal conductivity. The thermal break can be an air gap or a solid material with a low thermal conductivity impregnated into the microfluidic cartridge. In some embodiments, the thermal break can be an evacuated region, a region filled with an inert gas (e.g., Argon), an aerogel, or a void in a section of the microfluidic cartridge filled with air. In some embodiments, the PCR module 2600 comprises at least three sides, at least one of which is configured to comprise a thermal break positioned between the PCR module and the other features of the microfluidic cartridge on the X-Y plane of the microfluidic cartridge.

Further openings on the microfluidic cartridge 2001 open to the bottom include channels 2406, lysis chamber 2200, reservoirs 2402, 2404, reagent zones 2202, 2204, extraction chamber 2508, and PCR chambers 2602, 2604, 2606, 2608. In particular, magnetizeable balls 2206 are positioned within lysis chamber 2200 after assembly.

During use base layer 2003 is coupled to the microfluidic cartridge such that any structures are enclosed. Base layer 2003 may be formed to couple to the structures of the microfluidic cartridge 2001 such that materials in the various chambers, channels zones, and/or reservoirs are isolated from each other. This allows fluids to occupy space within the microfluidic cartridge 2000 and/or the chambers, reservoirs, channels, and zones without leaking.

In some instances, cartridges include a rotatable valve that having one or more elements on a control section that direct movement of materials at the valve. In particular, turning the valve allows the control section to direct fluids into predetermined channels such that the fluids flow in a predetermined path through the microfluidic cartridge. Different positions of the rotatable valve may selectively allow any of the aforementioned elements to be in fluid communication. FIGS. 3-4 depicts top and bottom views of a transparent version of the microfluidic cartridge shown in FIG. 2.

As shown in FIG. 4, reservoirs 2402, 2404 and introduction element 2100 are in fluid communication with ports 2004A-C. As described herein, ports may be used to drive fluids toward and/or away from the valve element 2306. For example, port 2004c is connected to introduction element 2100 by channel 2406. Pressure, both positive and negative, applied at port 2004c may be used to control fluid flow through channels 2406, 2412, introduction element 2100, lysis chamber 2200, and lysis reagent zone 2202. Pressure applied at the port to drive fluids through the microfluidic cartridge may be less than about 15 psi (103.4 kPa). In some embodiments, pressure applied at the port to drive fluids may be less than about 12 psi (82.7 kPa). In a particular use, fluid pressure applied at a port will be equal to less than about 2 psi (13.8 kPa).

As shown in FIG. 4, cartridge 2000 includes pathways 2804 on the control section 2806 of the valve element 2306. Pathways 2804 are bounded by walls 2808. Pathways may allow for fluid communication between two unconnected channels when the valve element is positioned in a predetermined orientation. Pathways may define an area on the bottom surface of a valve element that is encompassed a wall of material surrounding an open area.

As shown in FIG. 4, valve element 2306 is coupled to the waste reservoir 2700 using channels 2422, 2424. As shown waste reservoir 2700 includes absorbent material 2704. The absorbent material may reduce and/or inhibit flow of fluids from the waste reservoir back. For example, fluids may be inhibited from flowing out of the waste reservoir into channels and/or the valve elements. In some embodiments, the absorbent material is one or a plurality of layers of foam pads. In some embodiments, the foam pads are hydrophilic. In some embodiments the foam pads are hydrophobic. In some embodiments, the waste reservoir may include or exclude a vent port 2316 to the atmosphere to allow for the release of pressure. In some embodiments, the volume of the waste reservoir is configured to be sufficiently large that minimal backpressure forms throughout the microfluidic channels when fluid is transferred into the waste reservoir.

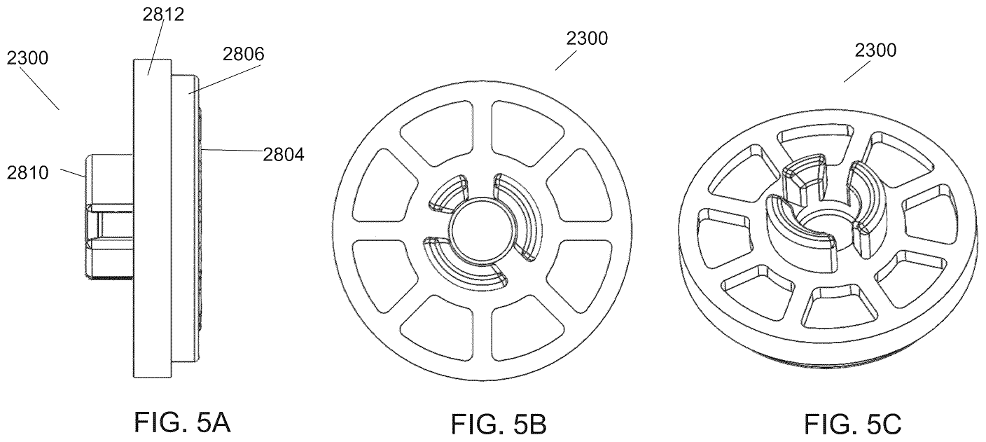

Valve elements may allow for fluid communication between the various elements in the microfluidic cartridge. FIGS. 5A-B depict valve 2300 having a control section 2806 in which pathways 2804 are positioned on the valve 2300. Pathways 2804 are defined by walls 2808. Further, as shown in FIG. 5A, pathways may be recessed into control section 2806. A depth of the pathways may be determined based on the target of interest and/or the analysis method. For example, a depth of a pathway may be less than about 2.5 mm. In a particular embodiment, pathways may be recessed into the control section at a depth in a range of from about 1 mm to about 2 mm. In alternate embodiments, the depths of the pathways may vary. In a particular embodiment, the control element may be a solid material with the walls forming the pathways deposited and/or molded to the control element.

Pathway walls on the valve may be formed from materials that include, but are not limited to thermoplastic elastomers (TPE). In some embodiments, the control section includes a wall structure defining pathways and that is formed from thermoplastic elastomers including but not limited to thermoplastic polyurethanes (TPU), silicone, styrenic block copolymers, TPS (TPE-s), thermoplastic polyolefin elastomers, TPO (TPE-o), thermoplastic vulcanizates, TPV (TPE-v or TPV), thermoplastic copolyester, TPC (TPE-E), thermoplastic polyamides, TPA (TPE-A), and/or combinations thereof.

The elements of the control section such as the walls and the pathways may be positioned on base section using molding such as injection molding, overmolding, additive manufacturing, for example, 3D printing, vat polymerization, material jetting, binder jetting, material extrusion, powder bed fusion, sheet lamination, directed energy deposition, sintering, or any other process known in the art.

In some embodiments, the control section is integrally formed with walls and pathways. For example, the control element, walls, and pathways may be molded and/or overmolded.

For example, the wall structure that defines pathways on the control section may be formed from a silicone. In an embodiment, the control section of the valve includes wall elements made from overmolded silicone. The silicone used in the control section of the valve may be selected based on the hardness of the material. In particular, silicones used in the wall element may be selected based on a reported hardness value of the material using the Durometer Shore A Hardness scale. For example, a silicone may be selected for use in a control section of a valve if the reported value on the Durometer Shore A Hardness scale is in a range from about 30 to 80. In some embodiments, a silicone material having a hardness in a range between 40 and 70 on the Durometer Shore A hardness scale. In a particular embodiment, the walls on the control section are formed from a silicone selected for having a valve of about 60 on the Durometer Shore A hardness scale.

FIG. 5C depicts a side view of valve 2300 having an engaging section 2810, base section 2812, and control section 2806. The engaging section may be formed from a material having a hardness capable of supporting attachment to an instrument for positioning the valve in the desired orientation. Materials used in the engaging section may include, but are not limited to plastics such has polycarbonate, polypropylene, etc.

FIG. 5C-E depict valve 2300 having engaging section 2810 coupled to valve 2300 having pathways 2804. The engaging section may be formed from a material having a hardness capable of supporting attachment to an instrument capable of positioning the valve in the desired orientation. Materials used in the engaging section 2810 may include, but are not limited to plastics such as polycarbonate or polypropylene.

As shown in FIGS. 5A-B, walls 2808 extend above the outer surface of the valve 2300. The height of walls of the pathways above the valve may be in a range of about 0.10 mm to about 0.35 mm. For example, as shown in FIG. 5A an embodiment of pathways 2804 have a height of about 0.330 mm. Thus, the pathways serve as a way to allow fluids to flow without escaping the confines of the valve. Further, ring wall 2814 encircles control section 2806. The ring wall may inhibit and/or limit flow of fluids at the valve. As shown in FIG. 5A-B ring wall 2814 encircles pathways 2804. Thus, the ring wall acts to inhibit movement of fluid beyond the valve.

The microfluidic cartridge embodiment depicted in FIG. 4 includes introduction element 2100 in fluid communication with port 2004c and lysis element 2208. Lysis element 2208 includes lysis reagent zone 2202, lysis chamber 2200, and balls 2206. Lysis element 2208 is fluid communication with rotatable valve element 2306 positioned on the microfluidic cartridge 2001.

In FIG. 4 both introduction element 2100 and valve element 2306 are depicted in a transparent manner to allow visualization of the pathways, channels, etc. Rotatable valve element 2306 is in fluid communication with multiple elements including introduction element 2100, ports 2004A, 2004B, 2004C, extraction chamber 2508, mixing channel 2500, PCR element 2600 at both inlet 2610 and outlet 2612, extraction chamber 2508, wash solution reservoir 2404, elution solution reservoir 2402, and waste reservoir 2704.

During use a sample may be introduced to the microfluidic cartridge at the introduction element. Samples may include, but are not limited to saliva, mucus, bile, breast milk, tears, nasal aspirate, blood, plasma, urine, vaginal excretion, feces, CSF (cerebrospinal fluid), sweat, serum, pus, phlegm, semen, buccal swab, digested tissue (which can include FFPE samples), and/or other bodily fluids. Samples may include nucleic acids and many sources of PCR inhibitors. Samples provided to the microfluidic cartridge may have a volume in a range from about 150 microliters to about 400 microliters. In a particular embodiment, a sample volume may be in a range of about 250 microliters to about 300 microliters.

To prepare the sample for analysis it may be necessary to treat the sample. In some embodiments, samples may be treated prior to being provided to the microfluidic cartridge. Treatment of the sample may also occur after the sample has been introduced into the microfluidic cartridge. Samples may be treated based on type of sample, type of analysis desired, and/or targets of interest. For example, lysing biological materials may be necessary to conduct certain analyses on samples. In particular, samples that will be subjected to PCR analysis may be lysed and/or extraction prior to PCR.

Treatment of the samples may occur in various locations on the microfluidic cartridge. Samples may be moved through the microfluidic cartridge as fluids to different elements. Fluid flow through the microfluidic cartridge may be controlled using predetermined pressures applied to a portion of the microfluidic cartridge and/or predetermined movements of the microfluidic cartridge. Pressure may be applied to specific elements of the microfluidic cartridge. For example, fluid compression may be achieved by selectively applying pressure at ports when in fluid communication with a particular element such as a channel and/or chamber. Pressure differentials throughout the microfluidic cartridge may influence fluid flow including, but not limited to turbulence and/or residence time of fluids in the microfluidic cartridge.

For example, as shown in FIG. 4 port 2004C is may be placed in fluid communication with introduction element 2100 via channel 2406. Introduction element 2100 is capable of being in fluid communication with vent ports 2316, 2316′ and lysing chamber 2208 via channels.

In some embodiments, pressure is applied to the port to cause fluid movement within the microfluidic cartridge from the introduction element to the lysing chamber. A sample volume treated in the chamber may be in a range from about 9 microliters to about 500 microliters. For example, a sample volume to be treated in a lysis chamber may be in a range from about 200 microliters to about 300 microliters. In particular, a sample volume provided to lysis chamber may be about 250 microliters.

Lysis elements for biological materials may include a lysing chamber and magnetizeable balls in a microfluidic cartridge. A number of magnetizeable balls in a lysing chamber may vary between about 1 to about 10. For example, as shown in FIG. 4, four balls 2206 are present in the lysis chamber 2200.

Dimensions of a lysis chamber may be determined by use. Lysis chambers may have predetermined volumes selected based on targets of interest and/or methods of analysis. In particular, volumes of lysis chambers may range from about 15 mm³ to about 830 mm.³ For example, a lysis chamber may have a volume in a range from about 200 a lysis chamber may have a volume in a range from about to about 500 mm³. In a particular embodiment, a lysis chamber may have a volume of in range from about 400 to 440 mm³.

Embodiments of lysis chambers 2200 may have a width in a range between about 0.05 inches and 0.2 inches (1.3 mm to 5 mm) and a length in a range between about 0.35 inches and 1.3 inches (8.9 mm to 33 mm). For example, as shown in FIG. 4 an embodiment includes a lysis chamber 2200 having a width of about 0.145 inches (3.7 mm) and a length of about 1 inch (25.4 mm).

In some instances, magnetizeable balls used in the lysis chamber 2200 are predetermined. For example, the lysing chamber and magnetizeable balls may be sized such that the balls may move freely along a determined path for a predetermined distance in the lysing chamber. The magnetizeable balls may have a predetermined diameter. In some instances, a ratio of a diameter of the ball bearings to a transverse width of the lysing chamber is in a range from about 0.08 to 0.63. Magnetizeable balls may have a diameter in a range from about 0.015 inches to 0.250 inches (0.381 mm to 6.35 mm). Magnetizeable balls may have a diameter in a range from about 0.03125 inches to 0.125 inches (0.79 mm to 3.18 mm). In particular, as shown in FIG. 4 magnetizeable balls 2206 have a diameter of about 0.09 inches (i.e., 2.29 mm). As shown, magnetizeable balls 2206 used in the lysing element are metal ball bearings of a uniform size. In alternate embodiments, a lysing chamber may include magnetizeable balls of varying size. In some embodiments, the metal ball bearings comprise stainless steel. In some embodiments, the metal ball bearings comprise chrome.

Magnetizeable balls can include, but are not limited to balls having magnetic properties, metal balls, balls made of alloys such as stainless steel balls, ball bearings, and the like. In some embodiments, magnetizeable balls may be coated or uncoated ball bearings based on the requirements of use. For example, magnetizeable balls may be ball bearings plated with chrome, in particular 410 chrome.

Various methods may be used to move the magnetizeable balls within the lysing chamber. In some embodiments, as shown in FIG. 4 the magnetizeable balls 2206 are magnetic. Subjecting magnetic magnetizeable balls 2206 to a variable magnetic field may move the magnetizeable balls in the lysis chamber.

As shown in FIG. 4, from lysing chamber 2208 the sample fluid flows into valve element 2306. Depending upon the position of the valve element the sample fluid may be directed into one or more channels and/or chambers.

After lysing, the lysed fluid may be directed through the valve element to an extraction chamber of the microfluidic cartridge. For example, lysed fluid flows from lysing chamber 2208 to the valve element 2306 and then is directed to extraction chamber 2508.

In some embodiments, the lysed sample comprises cells and/or cellular debris and nucleic acids. Using the mechanical lysis component of the microfluidic cartridge may result in significantly shorter nucleic acids than when the sample has been prepared by another lysis method. For example, chemical lysis methods (absent sonification) may result in significantly longer nucleic acids. If any proteins or polysaccharides from the sample are present, they are also sheared to a sufficiently small size.

In some embodiments, the microfluidic cartridge includes an extraction chamber having a single solid support (the reversibly binding medium) to purify nucleic acids from the lysed sample. As used herein, the term “selectively binding medium” may refer to a solid or semi-solid support which selectively retains substantially or all of the nucleic acids in a solution more effectively than a substance which is not a nucleic acid, under predetermined conditions. For example, in some embodiments, the lysed sample includes a mixture of constituents. Constituents of the lysed sample may include lysed cell constituents. The reversibly binding medium acts to first bind nucleic acids when presented with a solution that includes nucleic acids, selectively retain the nucleic acids when subject to a wash step, and then release the nucleic acids when subject to an elution step.

In some embodiments, the reversibly binding medium can include or exclude beads, a filter membrane, posts, or combinations thereof. For example, the reversibly binding medium can comprise alumina, silica, celite, ceramics, metal oxides, porous glass, controlled pore glass, carbohydrate polymers, polysaccharides, agarose, Sepharose™, Sephadex™, dextran, cellulose, starch, chitin, chitosan, or synthetic polymers (e.g., polymethylmethacrylate, polyvinyl ether, polyethylene, polypropylene, polystyrene, nylons, polyacrylates, polyacrylamides, and polymaleic anhydride). In some embodiments, the reversibly binding medium can be of the form of membranes, hollow fibers, fibers, beads, or any combinations thereof. In some embodiments, the reversibly binding medium is a silica filter membrane.

In some embodiments, the reversibly binding medium can be functionalized to further enhance its ability to selectively adsorb nucleic acids from a solution. The functionalization can include or exclude amines, carboxy groups, alkyl groups, counterions, and polymers. In some embodiments, the polymer functionalization is chitosan-coated silica beads (as described in Cao et al., Anal. Chem. (2006), 78 (20), p. 7222-7228).

In a system in which a sample is subjected to the lysis component described herein, constituents of the sample may be significantly sheared such that they will not bind or significantly impede flow through a reversibly binding medium. Thus, these non-binding constituents will traverse through the reversibly binding medium. In some embodiments, the non-binding constituents are conveyed to a waste reservoir, leaving the nucleic acids reversibly bound to the reversibly binding medium.

Waste reservoirs in the microfluidic cartridge may connect to multiple channels in the microfluidic cartridge. In some embodiments, a waste reservoir may be in fluid communication with one or more elements in the microfluidic cartridge. For example, a waste reservoir may be in fluid communication with a valve and distribution element. Waste reservoirs may include absorbent materials to inhibit, and in some cases prevent fluid from the reservoir flowing back into the microfluidic cartridge. In some embodiments, the absorbent material is glass wool, sintered PTFE, or a high release media. In some embodiments, there are one to five absorbent pads in the waste reservoir. In some embodiments, there are two absorbent pads in the waste reservoir. Waste reservoirs may have a volume in a range between about 500 microliters to about 1500 microliters. In a particular embodiment, a waste reservoirs may have a volume in a range between about 765 microliters to about 1165 microliters. For example, a waste reservoir may have a volume of about 965 microliters. In some embodiments, the waste reservoir can include or exclude a vent port 2316 to atmosphere to relieve backpressure from fluid volume buildup in the waste reservoir. In some embodiments, the vent port 2316 comprises a dry hydrogel (e.g., cellulose, polyacrylate, polyacrylic acid, or copolymers thereof) which when wet will expand to close the vent port to prevent further liquid from eluting from the vent port onto the top surface of the microfluidic cartridge. In some embodiments, the volume of the waste reservoir is configured to be sufficiently larger than the fluid volume transported to the waste reservoir such that minimal backpressure builds up in the waste reservoir, even without a vent port to atmosphere.

As shown in FIG. 4, extraction chamber 2508 includes a reversible binding medium (not shown). Thus, lysed sample fluid may flow from the valve element 2306 into extraction chamber 2508 as shown in FIG. 4. Extraction chamber 2508 has inlet 2510 and outlet 2512 all of which are positioned on the distribution element 2302 (shown on FIG. 2) that is on a top surface of the microfluidic cartridge 2001 (shown from underneath in FIG. 4). In some embodiments, the extraction chamber may include a reversible binder medium such as a membrane. In particular, the extraction membrane may include a porous silica membrane.

The extraction chamber may be a locus of a bind-wash-elute principle employing solid phase extraction wherein the solution comprising nucleic acids is presented to a reversibly binding medium. In many embodiments, the remainder of the solution constituents which do not bind to the reversibly binding medium remain in the solution as it traverses the extraction chamber. In some embodiments, the solution comprising constituents which do not bind to the reversibly binding medium may be conveyed to a waste reservoir using valve actuation. For example, a valve element may be moved into a predetermined position which guides the solution constituents into the waste reservoir. In some embodiments, the solution comprising constituents which do not initially bind to the reversibly binding medium can be selectively recirculated to the same reversibly binding medium or another reversibly binding medium to increase the yield of purified nucleic acids from the solution.

In some embodiments, the solution presented to the reversibly binding medium can include or exclude nucleic acids, proteins, carbohydrates, steroids, peptides, lipids, hormones, ions, small molecule chemicals, and polysaccharides. The surface of the reversible binding medium can be chemically functionalized for the specific analyte (e.g., C18-silica for hydrophobic analytes, or unmodified silica for nucleic acids). In some embodiments, the nucleic acids can include or exclude DNA or RNA. In some embodiments, the nucleic acids have an average size from 10 to 5000 nucleotides. In some embodiments, the nucleic acids are sheared during a prior lysing step before presentation of the solution to the reversibly binding medium. In some embodiments, the nucleic acids are sheared by a chemical reaction in the lysing buffer. The inventors have recognized that the size of the sheared nucleic acids are still of sufficient length as to be amendable to PCR, hybridization, or sequencing reactions.

During use the valve may be moved into a predetermined position to allow flow of excess lysis fluid and/or more constituents which do not bind to the binding medium to a waste reservoir. Then the rotatable valve is moved to a predetermined position that puts the wash a wash solution

In some embodiments, the sample in the sample introduction cup can include or exclude lysis solution and/or control DNA. For example, control DNA can be used to confirm each of the steps in the extraction chamber. Further, in some embodiments, control DNA may be use to confirm that subsequent steps proceed as expected. In particular, control DNA results can be compared with the results of a test sample suspected of and/or comprising a selected nucleic acid sequence. In some embodiments, the control DNA is MS2 DNA (SEQ ID NO: 1). In some embodiments, the solution can further comprise carrier RNA (cRNA) or carrier DNA (cDNA). Carrier RNA can improve the efficiency of nucleic acid separation when using silica solid support (Shaw et al., Anal. Chim. Acta, 652 (2009), p. 231-233). In some embodiments, the biological solution is of a subject. In some embodiments, the subject is a human. However, in alternate embodiments subjects may be selected from a wide variety of organisms.

The biological solution used in a sample can be from saliva, mucus, bile, breast milk, tears, nasal aspirate, blood, plasma, urine, vaginal excretion, feces, CSF (cerebrospinal fluid), sweat, serum, pus, phlegm, or semen. In some embodiments, the lysis solution can include or exclude: a chaotropic agent (e.g., phenol, ethanol, n-butanol, isopropanol, guanidine hydrochloride, guanidine thiosulfate, urea, thiourea, lithium acetate, and lithium perchlorate), glycine, calcium chloride, magnesium chloride, tris-HCl, PBS, NaCl, L-aspartate, a surfactant, a sacrificial protein, and a preservative. The preservative can be sodium azide. The sacrificial protein can be BSA (bovine serum albumin). The surfactant can be EMULGEN120.

A predetermined position of valve element 2306 allows the extraction chamber 2508 to be in fluid communication with channel 2426 emanating from lysis chamber 2208 as shown in FIG. 4.

In an embodiment, the rotatable valve 2300 is be moved such that the wash solution reservoir 2404 is placed in fluid communication with the extraction chamber 2508 such that the wash solution may be driven through the extraction chamber.

As such, the inventors have recognized that an advantageous feature of the present disclosure is that only a single solid support (the reversibly binding medium) is needed to purify nucleic acids from the lysed sample because the constituents of the sample which do not bind to the reversibly binding medium are significantly sheared such that they will not bind or significantly impede flow through the reversibly binding medium and will traverse through the reversibly binding medium. In some embodiments, the sample constituents which do not bind to the reversibly binding medium during the binding step are conveyed to a waste reservoir, leaving the nucleic acids reversibly bound to the reversibly binding medium.

If non-nucleic acid sample constituents are present, they can be further removed in a wash step wherein a low pH solution is presented to the reversibly binding medium to remove non-nucleic acid sample constituents from the reversibly binding medium while retaining nucleic acids on the reversibly binding medium. The wash step can be pulsed or continuous. When the wash is pulsed, the wash solution is started, then stopped for a selected duration, then restarted, and repeat a selected number of instances. The stop period during pulsing can allow for non-nucleic acid sample constituents to equilibrate their surface binding kinetics to yield a higher rate of unbinding (and thus removal) of the non-nucleic acid sample constituents. When the wash is continuous, the wash solution is continuously presented to the reversibly binding medium. In some embodiments, the washings can be recirculated to the same or another reversibly binding medium through a pathway which selectively directs the washings to the reversibly binding medium. Recirculating the wash solution can increase the yield of purified nucleic acids from the solution. The wash solution can comprise a low pH with a low salt concentration. In some embodiments, the pH of the wash solution can range from about 0.5 to about 5.5. In some embodiments, the wash solution pH can be 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, any pH range between any of the aforementioned pH values, or any pH between any of the aforementioned pH values. In some embodiments, the pH of the wash solution is 2.0. In some embodiments, the low salt concentration can be from 5 mM to 100 mM. The low salt concentration can be from 5 mM to 50 mM, 5 mM to 40 mM, 5 mM to 30 mM, 5 mM to 20 mM, 5 mM to 10 mM, any of the foregoing endpoints of the aforementioned ranges of concentrations, or any concentration between any of the aforementioned concentrations. In some embodiments, the salt concentration of the wash solution is 10 mM. The salt can be any mono- or divalent cationic salt. The salt can be selected from: NaCl, KCl, LiCl, Na₂SO₄, NH₄SO₄, K₂SO₄, NaBr, KBr, LiBr, acetate salts (e.g., Na, K, Li, Cs). In some embodiments, the wash solution is 10 mM KCl at a pH of 2.0. In some embodiments, more than one type of wash solution can be presented to the reversibly binding medium in a serial manner. The water used to prepare the wash solution can be nuclease-free.

Then the rotatable valve is moved such that the elution solution reservoir 2402 is placed in fluid communication with the extraction element 2508 allowing the elution solution to flow into the extraction chamber. The elution solution may be selected for its ability to release targets (e.g., nucleic acids, RNA, and/or DNA) from the binding medium.

After washing, the nucleic acids can be eluted from the reversibly binding medium by introduction of a high pH solution. The elution step can be pulsed or continuous. When the elution is pulsed, the presentation of the elution solution to the reversibly binding medium is started, then stopped for a selected duration, then restarted, and repeat a selected number of instances. The stop period during pulsing can allow for nucleic acids to equilibrate their surface binding kinetics to yield a higher rate of unbinding (and thus release) of the nucleic acids. When the elution is continuous, the elution solution is continuously presented to the reversibly binding medium. In some embodiments, the eluted solutions can be recirculated to the same or another reversibly binding medium through a pathway which selectively directs the eluted solutions to the reversibly binding medium. Recirculating the elution solution can increase the yield of purified nucleic acids obtained from the sample. The elution solution can comprise a high pH with a low salt concentration. In some embodiments, the pH of the elution solution can range from about 7.0 to about 11.0. In some embodiments, the elution solution pH can selected from at a predetermined value based on the target. For example, the elution solution may have a pH in a range from about 8.0 to about 10.0. In particular, an elution solution having a pH valve of 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0, or any pH within a range of any two of the aforementioned pH values may be selected for use in this system. In some embodiments, the pH of the elution solution is 9.0.

In some embodiments, an elution solution may have a low salt concentration in a range from about 5 mM to about 100 mM. The low salt concentration can be from 5 mM to 50 mM, 5 mM to 40 mM, 5 mM to 30 mM, 5 mM to 20 mM, 5 mM to 10 mM, any of the foregoing endpoints of the aforementioned ranges of concentrations, or any concentration between any of the aforementioned concentrations. In some embodiments, the salt concentration of the elution solution is 10 mM. The salt can be any mono- or divalent cationic salt. The salt can be selected from: Tris-HCl, NaCl, KCl, LiCl, (NH₄)₂SO₄, K₂SO₄, NaBr, KBr, LiBr, acetate salts (e.g., Na, K, Li, Cs). In some embodiments, the elution solution is 10 mM Tris-HCl at pH 9.0. In some embodiments, more than one type of elution solution can be presented to the reversibly binding medium in a serial manner. The water used to prepare the elution solution can be nuclease-free.

After elution, the eluted nucleic acids can be mixed with reagents/mastermix reagents appropriate for a selected nucleic acid analysis assay. The nucleic acid analysis assay is selected from: LAMP (Loop-Mediated Isothermal Amplification), DNA sequencing (NGS or Sanger), hybridizing to a microarray, hybridization to a labeled bead (Luminex assay), ligation-based assays (e.g., MLPA (Multiplex Ligation Dependent Probe Amplification)), HRM (High-resolution melting analysis), gel electrophoresis, PCR, CRISPR-based genetic analysis (e.g., Mammoth Biosciences DETECTR™ assay), and mass spectrometry (Agena Bioscience MASSARRAY™ assay. In some aspects, the PCR reagents can be selected from: Taqman™, Scorpions™, Amplifluor, LUX, Cyclicons, Angler, or Molecular Beacons™. In some aspects, the reagents can be selected from those described in Gašparič, et al., Comparison of different real-time PCR chemistries and their suitability for detection and quantification of genetically modified organisms. BMC Biotechnol 8, 26 (2008). doi.org/10.1186/1472-6750-8-26; Navarro E, et al., Real-time PCR detection chemistry. Clin Chim Acta. 2015 Jan. 15; 439:231-50. doi: 10.1016/j.cca.2014.10.017. Epub 2014 Oct. 22. PMID: 25451956; Rajagopal, A., et al. Significant Expansion of Real-Time PCR Multiplexing with Traditional Chemistries using Amplitude Modulation. Sci Rep 9, 1053 (2019). doi.org/10.1038/s41598-018-37732-y; Gašparič, et al., Comparison of nine different real-time PCR chemistries for qualitative and quantitative applications in GMO detection. Anal Bioanal Chem 396, 2023-2029 (2010). doi.org/10.1007/s00216-009-3418-0; or Matsuda et al. Adv Clin Chem. (2017); 80:45-72. doi: 10.1016/bs.acc.2016.11.002. Epub 2017 Jan. 4, each of which is incorporated herein by reference. The PCR chemistry can be selected from chemistry appropriate for any type of PCR chemical reaction (including quantitative PCR, reverse transcriptase PCR, real-time PCR, digital droplet PCR, and quantitative reverse transcriptase PCR). In some embodiments, the reagents can be appropriate for CRISPR-based diagnostic assays (see Kaminski, et al. CRISPR-based diagnostics. Nat Biomed Eng 5, 643-656 (2021). doi.org/10.1038/s41551-021-00760-7, herein incorporated by reference). Either prior to, at the chamber, and/or following the chamber in the mixing channel the eluted fluids may come in contact with reagents necessary for completing the predetermined assays of interest. In particular, PCR reagent zones may exist along the path from the extraction chamber to the PCR element. The PCR mastermix reagents can be mixed with the eluted nucleic acids by conveying the eluted nucleic acids into a PCR reagent zone. In some embodiments, lyophilized PCR mastermix reagents are disposed within the PCR reagent zone. The PCR reagent zone can be continuous, and optionally in fluidic connection with a PCR mixing microchannel. In some embodiments, the PCR mastermix reagents are lyophilized beads (e.g., TaqMan™ Fast Environmental Master Mix Beads+IPC, ThermoFisher (Carlsbad, CA)). In some embodiments, there are two or more PCR reagent zones to provide sufficient amount of PCR mastermix reagents to react with the eluted nucleic acid. The PCR reagent zones can be regions in a channel wherein the region comprises continuously round curves and is expanded in width relative to the channel width. In some embodiments, the eluted nucleic acids contact the PCR reagent zones to form a PCR admixture.

In particular, after exiting outlet 2512 of extraction chamber 2508 eluted fluids flow through channel 2418 to mixing chamber 2504 as depicted in FIG. 4.

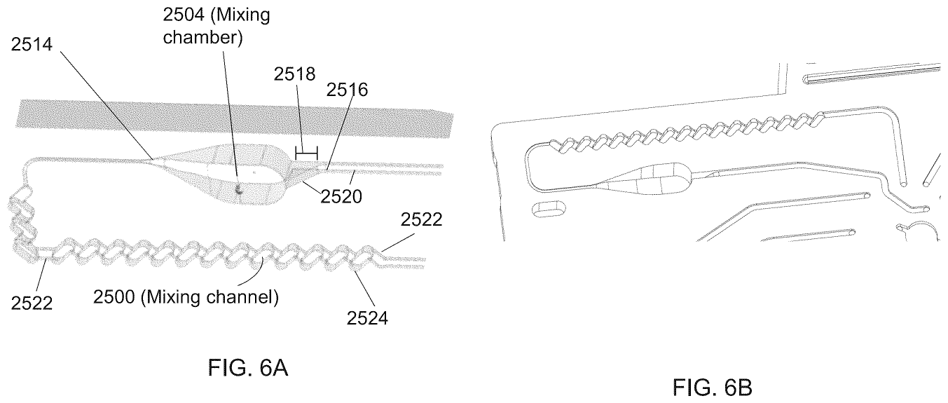

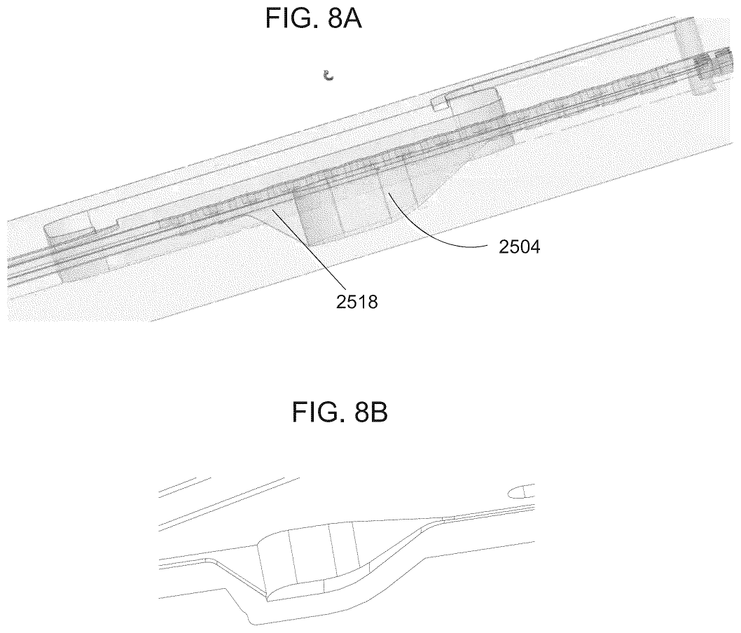

One embodiment of the mixing chamber 2504 is shown in FIGS. 6-9. The channels, mixing chamber, and/or mixing channel may include reagents/mastermix reagents appropriate for a selected nucleic acid analysis assay. For example, reagents are PCR mastermix reagents. The PCR mastermix reagents can include or exclude one or a plurality of polymerases, buffers, salts, nucleotides, primers, probes, enhancers, stabilizers, and nuclease-free water. In some embodiments, the salt can include MgCl₂. In some embodiments, the pH of the buffer can range from 7.0 to 9.0. In some embodiments, the pH of the buffer is about 8.5. In some embodiments, the PCR mastermix reagents can be the reagents necessary to perform a selected PCR reaction chemistry selected from: qPCR (quantitative PCR), reverse-transcriptase PCR, real-time PCR, or digital droplet PCR (ddPCR). In some embodiments, the polymerase is Taq polymerase or AmpliTaq™ polymerase. In some embodiments, the polymerase is any polymerase described in. (NEB catalog.) In some embodiments, the polymerase is selected from: Phusion, (KOD FX, Mighty Amp, Hemo KlenTaq, Phusion Blood II, KAPA, BIOTAQ, GoTaq Flexi, Amplitaq Gold, Q5® High-Fidelity DNA Polymerase, Q5U® Hot Start High-Fidelity DNA Polymerase, Phusion® High-Fidelity DNA Polymerase*, OneTaq® DNA Polymerase, Taq DNA Polymerase, LongAmp® Taq DNA Polymerase, Hemo KlenTaq, Epimark® Hot Start Taq DNA Polymerase, Bst DNA Polymerase, Full Length, Bst DNA Polymerase, Large Fragment, Bst 2.0 DNA Polymerase, Bst 3.0 DNA Polymerase, Bsu DNA Polymerase, Large Fragment, phi29 DNA Polymerase, T7 DNA Polymerase (unmodified), Sulfolobus DNA Polymerase IV, Therminator™ DNA Polymerase, DNA Polymerase I (E. coli), DNA Polymerase I, Large (Klenow) Fragment′, Klenow Fragment (3′-+5′ exo_), T4 DNA Polymerase, Vent® DNA Polymerase, Vent® (exo-) DNA Polymerase, Deep Vent® DNA Polymerase, Deep Vent® (exo-) DNA Polymerase, or combinations thereof. In some embodiments, the primers and/or probes are covalently connected to a fluorophore.

Outlet 2514 has a smaller flow volume than inlet 2516. In particular, FIG. 6 depicts inlet area 2518 where the depth of channel 2520 increases leading into chamber 2504. Along the flow direction in the chamber the depth of the chamber decreases toward the outlet 2514. Outlet 2514 has a smaller cross-sectional area than inlet 2516. The geometry of the mixing chamber may be adjusted based on the materials to be mixed such as the target of interest and/or the PCR mastermix and/or a predetermined residence time in the mixing chamber. In some embodiments, the extracted fluids may be provided to the mixing chamber before, or after, the PCR mastermix. In some embodiments, a filter proximate to and/or in the mixing chamber may be included to increase turbulent flow, and therefore mixing efficiency, of the PCR mastermix with the sample.

As shown in FIG. 6, fluids flow out of the mixing chamber 2504 and into mixing channel 2500. In some embodiments, mixing balls may be included in mixing chamber to ensure mixing.

Mixing channels may be used to enhance mixing of the fluid and its constituents. In some embodiments, flowing fluids through a helical or semi-helical channel may enhance mixing of fluids by creating turbulent flow. Some embodiments of a mixing channel may include walls having variable smoothness. For example, a mixing channel may have discontinuously smooth walls. In some embodiments, regions of the channel may be straight and/or other regions of the channel are bent. In alternate embodiments, channels may include projections and/or depressions in walls of channels.

In some embodiments, the mixing chamber 2504 is in the shape of a tear drop. In some embodiments, one surface of the microfluidic passageway entering the mixing chamber is continuously ramped up at an angle into the mixing chamber. In some embodiments the passageway before the mixing chamber comprises lyophilized beads which comprise PCR mastermix reagents and/or internal control nucleic acids. In some embodiments, the passageway comprising the lyophilized beads comprises a round chamber in which the lyophilized beads are pre-impregnated before or during construction of the microfluidic cartridge. In some embodiments, the mixing chamber

In some embodiments, turbulent flow mixing can be performed by a series of “push-pull” fluid compression steps, wherein the fluid path is moved forward, then reverse (or vice-versa), and repeated a selected number of instances. Fluid compression may be achieved by selectively applying pressure at ports when in fluid communication with a particular mixing element such as a channel and/or chamber. Pressure differentials throughout the microfluidic cartridge may influence fluid flow including, but not limited to turbulence and/or residence time of fluids in the specific locations in the microfluidic cartridge.

In some embodiments, concentration homogenization can be performed by conveying a fluid through a helical or semi-helical channel. For example, a reagent admixture may be mixed to homogenize a nucleic acid and mastermix reagents concentration throughout the volume of the admixture. In some embodiments, a channel may be used to mix a PCR admixture to homogenize the nucleic acid and PCR mastermix reagents concentration throughout the volume of the PCR admixture.

For example, as shown in FIGS. 3-4 mixing channel 2500 is in fluid communication with valve element 2306. Geometries, surfaces, sizes of the mixing channel, and/or ratios of dimension of elements of the mixing channel, for example, a ratio of mixing channel length to the inlet and/or outlet may be selected to provide predetermined flow characteristics in the mixing channel. Surface finishes, projections, and/or depressions on elements of the microfluidic cartridge may be used to influence fluid flow in the system.

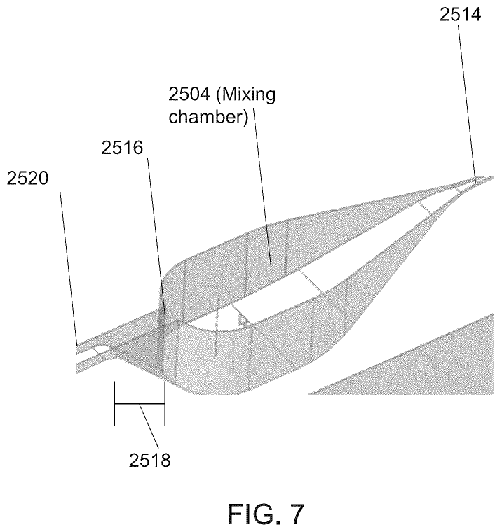

As shown in embodiments depicted in FIGS. 6-7 mixing channel 2500 is a semi-helical channel. FIG. 6 depicts a semi-helical channel 2500 having discontinuously smooth walls and having straight regions 2522 and curved regions 2524. Thus, during use fluid that includes target materials (e.g., extracted nucleic acids, DNA, and/or RNA) may be directed by valve 2300 to PCR element 2600.

A microfluidic cartridge embodiment may include multiple PCR chambers. As shown in FIG. 4, cartridge 2000 includes four PCR chambers 2602, 2604, 2606, 2608 positioned substantially parallel to each other. Volumes of PCR chambers as described herein may be in range from about 5 microliters to about 250 microliters. In some embodiments, PCR chamber volumes may be in a range from about 8 microliters to about 20 microliters. In particular, reactions for targets of particular interest may require about 8 microliters per reaction. For example, a volume for a PCR chamber may be around 8 microliters.

In alternate embodiments, a number of PCR chambers may vary. For example, cartridges may include a one to 96 PCR chambers depending on the application for the microfluidic cartridge. In some embodiments, there are from 2 to 10 PCR chambers. In some embodiments, there are from 4 to 6 PCR chambers. In some embodiments, there are 4 PCR chambers.

In some embodiments, PCR chambers are designated for analysis of a particular target such as predetermined genetic material such as nucleic acid strands, molecules, biomarkers, and/or genetic loci. For example, PCR chambers may be designated for the analysis of Covid, Influenza, Strain1 of Covid (e.g., Delta variant), and/or a different Covid strain (e.g., Omnicron variant), or any other infectious disease. In some embodiments, the infectious disease can include or exclude: HIV, Herpes Simple Virus (Genital Herpes (HSV-1, HSV-2)), Trichomonas vaginalis, Trichomoniasis, Parainfluenza, Respiratory syncytial virus (RSV), Human metapneumovirus (hMPV), Syphilis, norovirus, rotavirus, astrovirus, coronavirus, enterovirus (including enterovirus serotype coxsackievirus A16, also referred to as hand-foot disease), Borrelia burgdorferi (Lyme disease), Borrelia mayonii (rare cause of Lyme disease), Mycoplamsa genitalium, Human Papillomavirus (HPV), Neisseria meningitides, Bordetella pertussis, Gonorrhea, Chlamydia trachomatis bacterium, Chlamydia trachomatis, Neisseria gonorrhoea, Leptospira, Rabies virus (RABV), Zika virus, west nile virus, poliovirus, Cytomegalovirus (CMV), Middle East Respiratory Syndrome Coronavirus, Orthopox (monkeypox), arbovirus of the flavivirus genus (yellow fever), Highly pathogenic avian influenza (HPAI) A (H5N1) virus, Salmonella, and Exanthematous virae (which can include or exclude: varicella-zoster virus (chickenpox), rubeola (measles), human herpesvirus (HHV) type 6 (roseola), and mpox virus). Thus, in each PCR chambers PCR primers specific for a particular target (e.g., molecule, biomarker, and/or genetic locus). In some embodiments the PCR primers and/or a labeled probe for detecting the amplicons from the PCR reaction are allele specific.

PCR chambers are in fluid communication with valve element 2306.

To ensure that elements of the microfluidic cartridge are in fluid communication, in some instances, cartridges include a rotatable valve having one or more pathways on a control section that direct movement of materials at the valve. In particular, turning the valve allows the control section to direct fluids into predetermined channels such that the fluids flow in a predetermined path through the microfluidic cartridge. Different positions of the rotatable valve may selectively allow any of the aforementioned elements to be in fluid communication. FIG. 4 depicts a partial cross-sectional top view of a microfluidic cartridge 2000 where the pathways 2804 on the control section 2806 of the valve element 2306 are visible. Pathways 2804 are bounded by walls 2808.

Relationships between the various elements of the PCR element may be predetermined to optimize PCR reactions in the chambers. PCR chambers may have a large inlet and a smaller outlet. In alternate embodiments, the depths and/or heights of the inlet and/or outlet may change. For example, in some embodiments a change in the depth or relative height of an inlet to an outlet may increase turbulence of the fluid and/or mixing.

For example, specific features may be included in the PCR element to influence fluid flow through the PCR element including, but not limited to protrusions, indentations, wall surface treatments, shapes of the features (e.g., well or chamber shapes), number of features (e.g., a number of PCR chambers and/or channels), predetermined dimensions (e.g., depths, widths, lengths, lengths of well rounds, cross-sectional areas, volumes, and/or lengths and/or angles of chamfers), using predetermined relationships between dimensions, changing volumetric flow size along the flow path such as increasing/decreasing an outlet volume relative to an inlet volume (e.g., points early on the flow path may allow for a larger volumetric flow than further along the flow path), ports positioned proximate a far end of the PCR chamber, the depths and/or heights of the inlet and/or outlet such as the relative height of an inlet to an outlet, and/or combinations of these features. In some embodiments, a port is provided proximate a far end of the PCR chamber. These ports may allow for gas to exit the PCR element. These ports may reduce pressure build up, that is reduce and/or prevent backpressure.

As used herein, the term “depth” refers to a distance from an invariant position or plane. For example, a depth of a PCR chamber 2602 may refer to the distance from a PCR feeder channel 2601 along an x-axis relative to the surface of the microfluidic cartridge. In another example, a depth of a restriction element may refer to the distance of from the X-Y plane of the microfluidic cartridge into the microfluidic cartridge along the Z-axis.

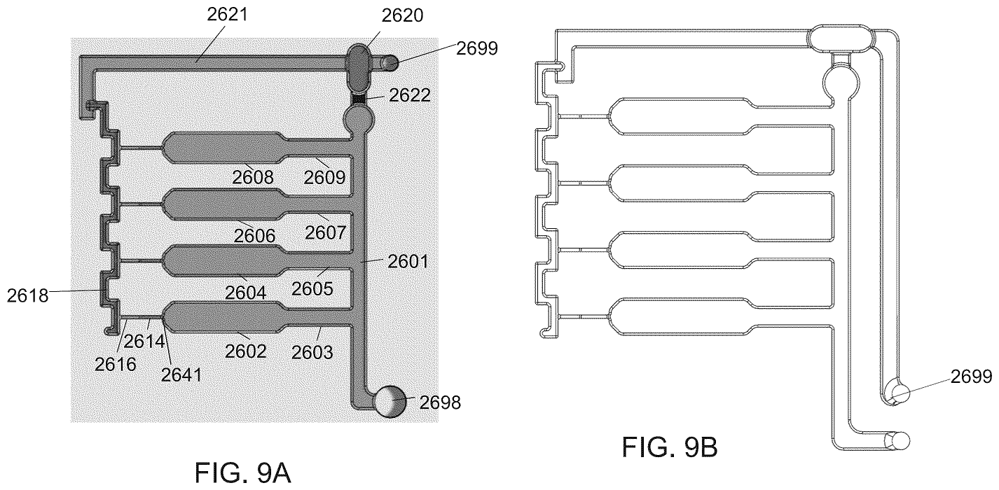

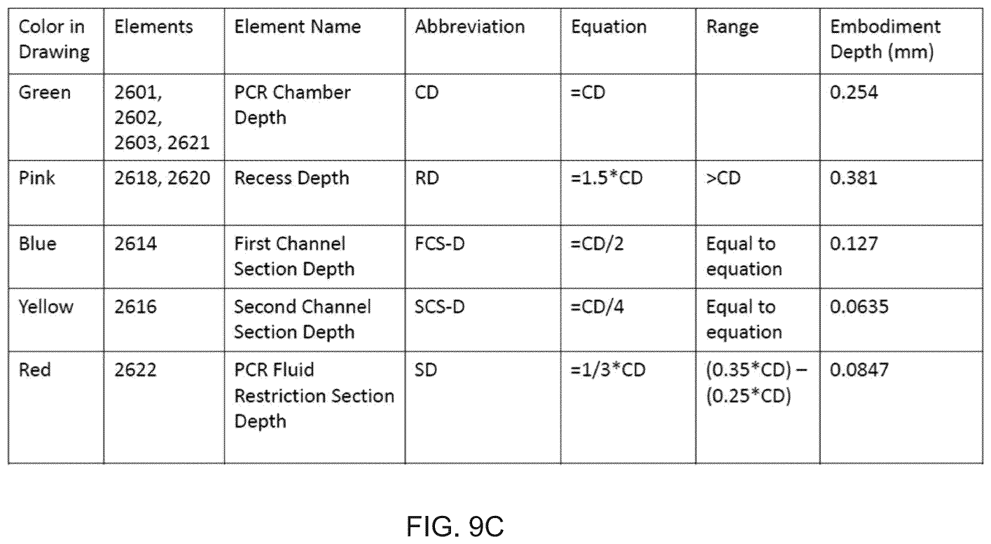

PCR elements found in FIGS. 3-4 are shown in enlarged form in FIGS. 9A, 10A, 11A. In particular, FIG. 9A includes four PCR chambers 2602, 2604, 2606, 2608, each of which is fluidically connected to a PCR antechamber 2603, 2605, 2607, and 2609 respectively. Cartridge 2000 includes PCR element 2600 having PCR chambers 2602, 2604, 2606, 2608 with differing dimensions (e.g., depths, widths, lengths, lengths of well rounds, cross-sectional areas, volumes, and/or lengths and/or angles of chamfers). PCR element 2600 further comprises a PCR feeder channel 2601, from which sample is presented through 2698 PCR input port. Geometries of the components in the PCR elements may affect the formation of bubbles in the system, how the individual chambers fill, and/or the type of flow generated during use.

In particular, PCR chambers and channels 2614, 2616, 2618 have predetermined depths (“D”), predetermined widths (“W”), predetermined lengths (“L”), predetermined well rounds, and/or predetermined chamfers. In some embodiments, these predetermined dimensions of each section of the PCR element have predetermined mathematical relations (i.e., equations).

In an embodiment, various sections of the PCR element may have differing depths that are related as depicted in FIG. 9B. A depth of PCR chamber may be predetermined based on characteristics of samples to be analyzed, requirements of analysis, materials, design, etc., and/or other requirements of the user. A depth of the PCR chamber (CD) may be used to define the depths of sections of the PCR element. Recess section 2620 has depth (RD) equal to 1.5 times the depth of the PCR chamber 2602 (i.e., RD=1.5*CD). Channel 2618 has depth (RD) equal to 1.5 times the depth of the PCR chamber 2602 (i.e., RD=1.5*CD). First channel section 2614 leaving the PCR chamber 2602 has a depth (FCS-D) that is equal to half the depth of the PCR chamber (FCS-D=CD/2). Second channel section proximate the first channel section has a depth (SCS-D) is equal to one quarter of the depth of the PCR chamber (SCS-D =CD/4). PCR Fluid Restriction section 2622 depth (RSD) is equal to one third of the depth of the PCR chamber (i.e., RSD=CD/3).

For example, in a particular embodiment as shown in FIG. 9B values for the various depths are as follows: the CD is equal to 0.254 mm, the SD is equal to 0.381 mm, the FCS-D is equal to 0.127 mm, the SCS-D is equal to 0.0635 mm, and the RSD is equal to 0.0847 mm.

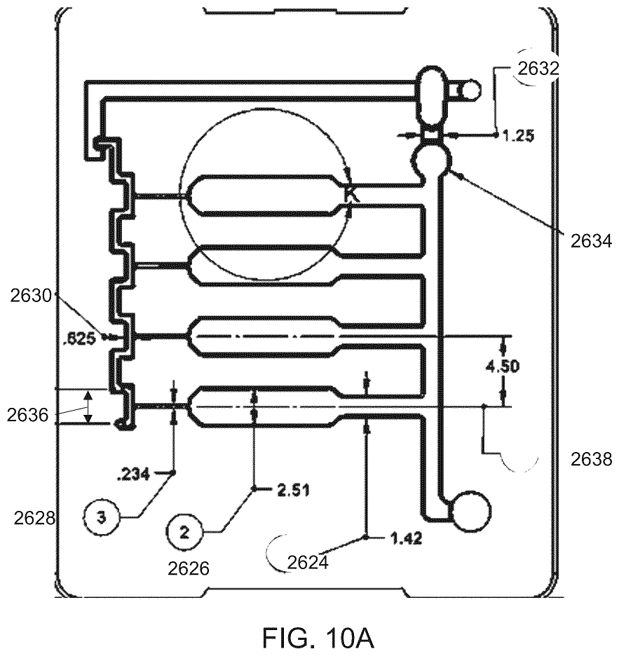

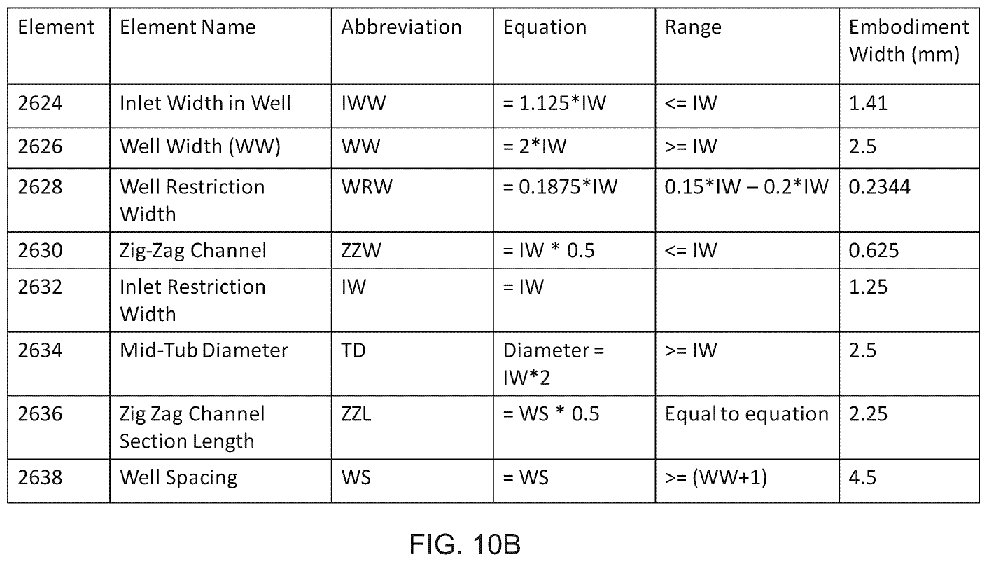

In an embodiment, various sections of the PCR element may have differing widths that are related as depicted in FIG. 10A. Various widths that may be predetermined including the inlet width in well 2624 (IWW), the well width 2626 (WW), the well restriction width 2628 (WRW), the Zig-Zag channel width 2630 (ZZW), inlet restriction width 2632 (IW), tub diameter 2634 (TD), the Zig-Zag channel section length 2636 (ZZL) and the 2638 well spacing (WS) are shown in FIG. 10A.

A width (IW) of inlet restriction section 2632 and/or the well spacing (WS) may be used to define the widths of sections of the PCR element. An inlet restriction width 2632 (IW) may be predetermined based on characteristics of samples to be analyzed, requirements of analysis, materials, design, etc., and/or other requirements of the user. The width of the well inlet 2624 (IWW) may have a value greater than or equal to width of the inlet restriction section. Well has a width (WW) value greater than or equal to width of the inlet restriction section. Well restriction width 2628 (WRW) has a value is in a range between 0.15 times the width of inlet restriction section and 0.2 times the width of inlet restriction section (i.e., 0.15*IW >=WRW <=0.2*IW). The Zig-Zag channel width 2630 (ZZW) has a value that is less than or equal to the width of inlet restriction section. The tub diameter 2634 (TD) has a value that is greater than or equal to the width of inlet restriction section. In addition, the well spacing (WS) has a value greater than or equal to the well width plus 1 (i.e., WS >=WW+1). The Zig-Zag channel section length (ZZL) 2636 has a value that is equal to 0.5 times the well spacing (i.e., ZZL=0.5*WS).

In some embodiments, the width of the well inlet 2624 (IWW) has a value equal to 1.125 times the in inlet width (i.e., IWW=1.125*IW). Well has a width (WW) value equal to 2 times the width of the inlet restriction section (i.e., WW=2*IW). Well restriction width 2628 (WRW) has a value that is equal to 0.1875 times the width of inlet restriction section (i.e., WRW=0.1875*IW). The Zig-Zag channel width 2630 (ZZW) has a value that is equal to 0.5 times the width of inlet restriction section (i.e., ZZW=0.5*IW). The tub diameter 2634 (TD) has a value that is equal to 2 times the width of inlet restriction section (i.e., TD=2*IW). In addition, the well spacing (WS) may be used to determine a length of a section of the Zig-Zag channel (ZZL). In particular, a Zig-Zag channel section length (ZZL) has a value that is equal to 0.5 times the well spacing (i.e., ZZL=0.5*WS).

For example, a particular embodiment of a PCR element as shown in FIG. 10B includes values for the various widths in the PCR element as follows: inlet width in well 2624 (IWW) is equal to 1.41 mm, the well width 2626 (WW) is equal to 2.5 mm, the well restriction width 2628 (WRW) is equal to 0.2344 mm, the Zig-Zag channel width 2630 (ZZW) is equal to 0.625 mm, inlet restriction width 2632 (IW) is equal to 1.25 mm, tub diameter 2634 (TD) is equal to 2.5 mm, the Zig-Zag channel section length (ZZL) 2636 is equal to 2.25 mm and the well spacing (WS) 2638 is equal to 4.5 mm.

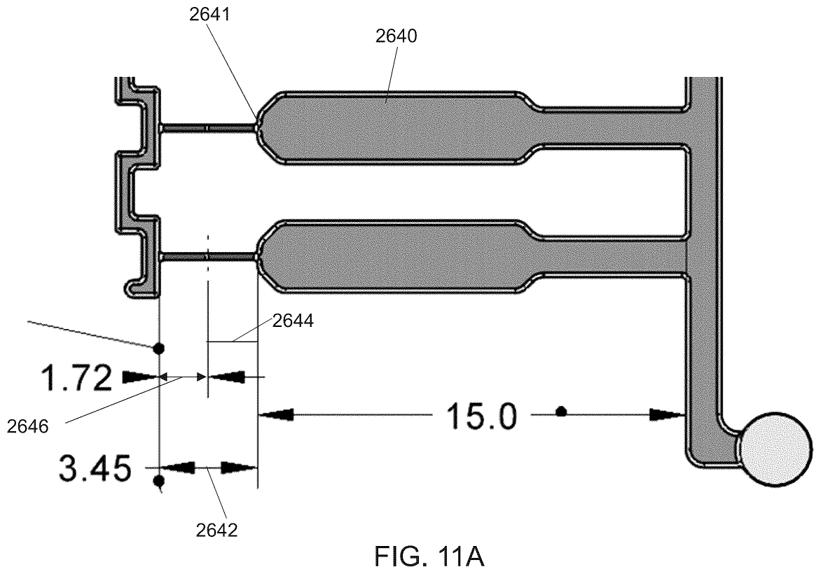

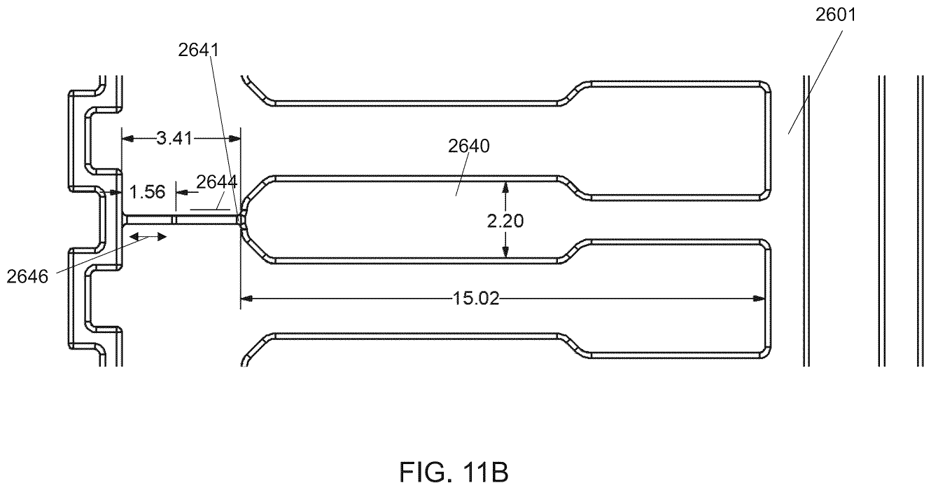

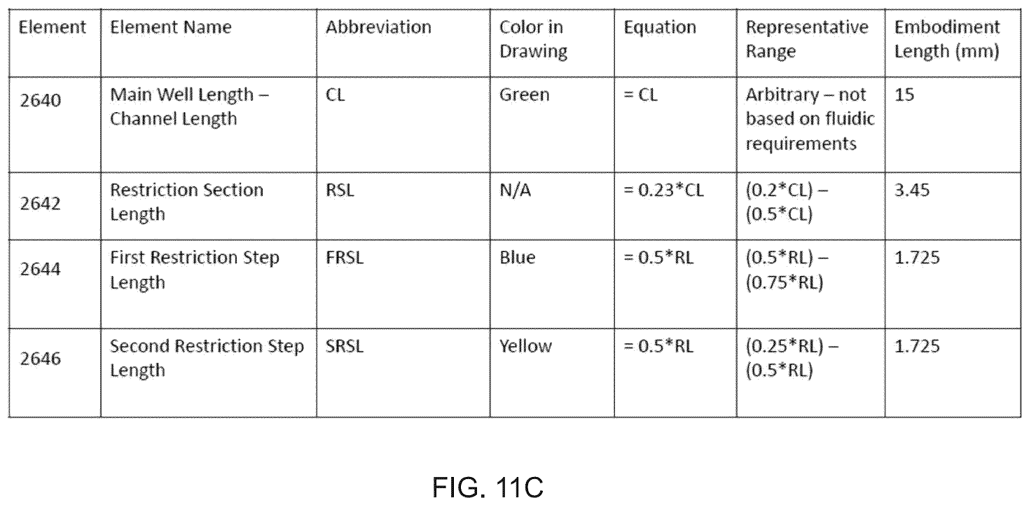

Lengths of sections of the PCR element may be determined using the relationships defined below. FIG. 11B shows the specific lengths of interest. The channel length (CL) may be selected based on characteristics of samples to be analyzed, requirements of analysis, materials, design, etc., and/or other requirements of the user. The CL may be used to determine other lengths within the PCR element. For example, the length of restriction section 2642 may be in a range between about 0.2 to 0.5 times the main well 2640 length (i.e., 0.2*CL<=RSL <=0.5*CL). The first restriction step length 2644 (FRSL) has a value is in a range between about 0.5 and 0.75 times the restriction section length 2642 (i.e., 0.5*RSL <=FRSL <=0.75*RSL). The second restriction step length 2646 (SRSL) has a value is in a range between about 0.25 and 0.50 times the restriction step length 2642 (i.e., 0.25*RSL <=SRSL <=0.5*RSL), such that the relative length of the first restriction and the relative length of the second restriction sum to unit total.

In an embodiment, various sections of the PCR element may have differing lengths that are related as depicted in FIG. 11B. The channel length (CL) of the PCR chamber 2640 may have a predetermined value that dictates the optimal lengths of other sections of the PCR element. In an embodiment, restriction section 2642 has length (RSL) equal to 0.23 times the channel length of the main well length (i.e., RSL=0.23*CL). A length (FRSL) of first restriction step 2644 of the restriction section has a value is equal to half the length of the restriction section length (FRSL=RSL/2). A length (SRSL) of second restriction step 2646 has a value is equal to half the length of the restriction section length (SRSL=RSL/2).

For example, as shown in the embodiment depicted in FIG. 11A, values for the various lengths are as follows: the channel length (CL) is 15 mm, the restriction section length (RSL) is 3.45 mm, a length of first restriction step (FRSL) is about 1.725 mm, and a length of second restriction step (SRSL) is 1.725 mm.

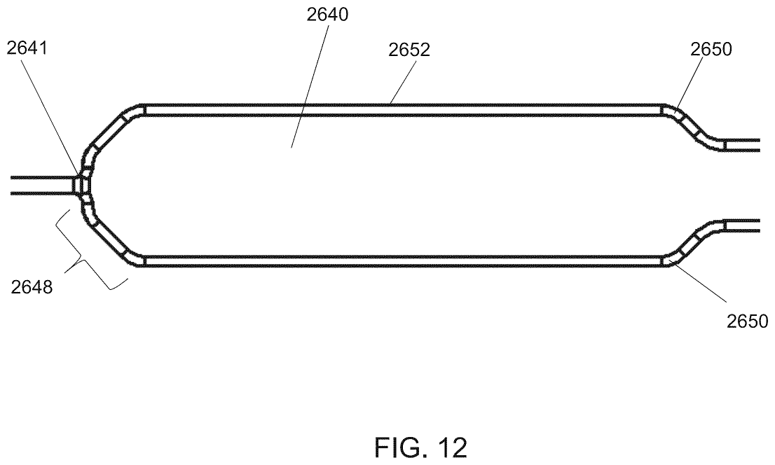

Main well 2640 of PCR element 2600 includes a predetermined geometry. Geometries of the wells may be selected to enhance fluid flow properties, mixing, residence time, and reduce the incidence of bubble formation. As shown in FIG. 12, main well 2640 includes chamfered edges 2648. Chamfered edges may be used at the ends of the well. Chamfers may be offset from sides of the well by about 45 degrees. FIG. 12 depicts horizontal well wall 2652 proximate rounded section 2650. Rounded sections and/or chamfered sections may have predetermined widths based on process requirements. In some embodiments, as shown in FIG. 12, rounded section 2650 has a length of about 0.533 mm (0.021 inches) and chamfer 2648 has a length of about 0.75 mm (0.03 inches). The rounded sections and/or chamfered sections minimize bubble formation within the PCR element 2600.

In some embodiments, each PCR chamber comprises a displaced gas exit opening 2641 through which gas in the PCR chamber and PCR antechamber which is displaced as the PCR chamber and PCR antechamber are filled with liquid exits. Displaced gas traverses the restriction regions 2614 and 2616, and then traverses though 2618 and then to displaced gas final exit channel 2621. Displaced gas then traverses through recess section 2620 to exit through PCR overflow outlet port 2699. The geometries of the microfluidic channels allow for displaced gas to exit the PCR element 2600 such that bubble formation during PCR, which can interfere with accurate optical readings, is minimized.

In some embodiments, sample is introduced to the PCR element 2600 through the PCR input port 2698. Sample then traverses through PCR feeder channel 2601 and then fills the first PCR antechamber 2603 before filling PCR chamber 2602. Fluid flow stops at the displaced gas exit opening 2641 due to surface tension. Thus, gas is displaced from the PCR chamber while the PCR chamber is filled with fluid. Next, fluid is continuously presented through the PCR feeder channel 2601 from the PCR input port 2698 and then enters by a similar mechanism PCR antechambers and PCR chambers, respectively, 2604, 2606, 2608, and 2605, 2607, and 2609, displacing gas through a similar mechanism. Fluid stops traversing the PCR feeder channel 2601 when the fluid contacts the PCR Fluid restriction section 2622. The back pressure differential between the displaced gas exit opening 2641 within each PCR chamber and that of the PCR Fluid restriction section 2622 is modulated by the depth of said PCR Fluid restriction section 2622, whereby the fluid will traverse through the PCR Fluid restriction section 2622 after all of the fluid has contacted the displaced gas exit openings 2641 within each PCR chamber, to ensure the complete filling of each PCR chamber with fluid. Fluid then traverses the PCR Fluid restriction section 2622 then traverses recess section 2620 and then traverses through an exit channel (not identified) through PCR overflow outlet port 2699. The selection of relative restriction depths, element dimensions, and order of elements into which fluid or gas flows yields all PCR chambers and PCR antechambers to be completely filled with fluid before beginning the PCR process.

In some embodiments, the PCR chambers can be fluidically isolated during the thermal PCR amplification steps. In some embodiments, the fluid pressure in the PCR chambers can be increased prior to fluidic isolation. The fluid pressure can be increased up to 9 psi (62.0 kPa) prior to fluidic isolation and performing the PCR amplification process. Increased fluid pressure can reduce bubbling during the PCR amplification process.

In some embodiments, the portion of the microfluidic cartridge where the PCR element 2600 is located comprises a thermally conductive film configured on the external bottom surface of the microfluidic cartridge (which interfaces with the heating blocks, the anneal element and denature element) to increase the heat transfer between the anneal element and denature element and the microfluidic cartridge. The conductive film can be selected from a metallic or mylar film. The metallic film can be a copper, gold, silver, or aluminum film. The metallic film can be applied as a paint or as a tape. When applied as a tape, the adhesive can be a thermal adhesive (e.g., 3M™ Thermally Conductive Adhesive Transfer Tape 8805). In some embodiments, the thermally conductive film is aluminum tape.

FIG. 13 depicts a cross-sectional image of the valve 2300 and cover 2340 positioned on a transparent portion of the microfluidic cartridge. As shown channels 2526 do not appear to align with the pathways 2804. Thus, for these particular channels and pathways the current valve orientation is closed. When the valve rotated out of phase (i.e., in a closed position) the various elements that are connected to the valve are fluidically isolated from each other.

In addition, ring wall 2814 surrounds the pathways 2804 defined by walls 2808. In this manner, the ring wall may inhibit fluid flow from the valve.

In some embodiments, valves may have pathways that correspond to the openings of channels in the microfluidic cartridge which are to be connected when the valve is in a predetermined orientation. Pathways ensure that openings of channels are placed in fluid communication when the valve and the pathways are in a predetermined orientation.

FIG. 14 depicts an alternate embodiment of a portion of a microfluidic cartridge 2000 where a valve 2300 in a closed position with respect to the microfluidic cartridge. As shown, the pathways 2804 are positioned such that only one opening 2312 is positioned within each pathway. Fluids in the various channels may enter the valve but would be inhibited from moving beyond the control section by the walls of the pathway and the lack of an opening in the control section. Thus, fluids in the various channels are inhibited from flowing beyond the valve. In particular, as shown in FIG. 14 opening 2312 connected to channel 2416 is in fluid communication with pathway 2804 surrounded by wall 2808. Fluid entering pathway 2804 from opening 2312 would not move beyond wall 2808.

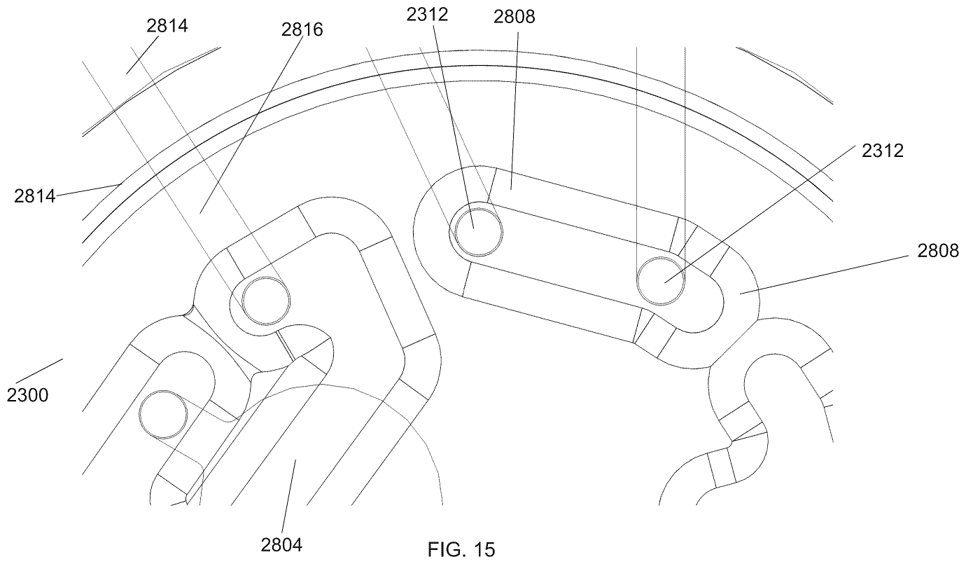

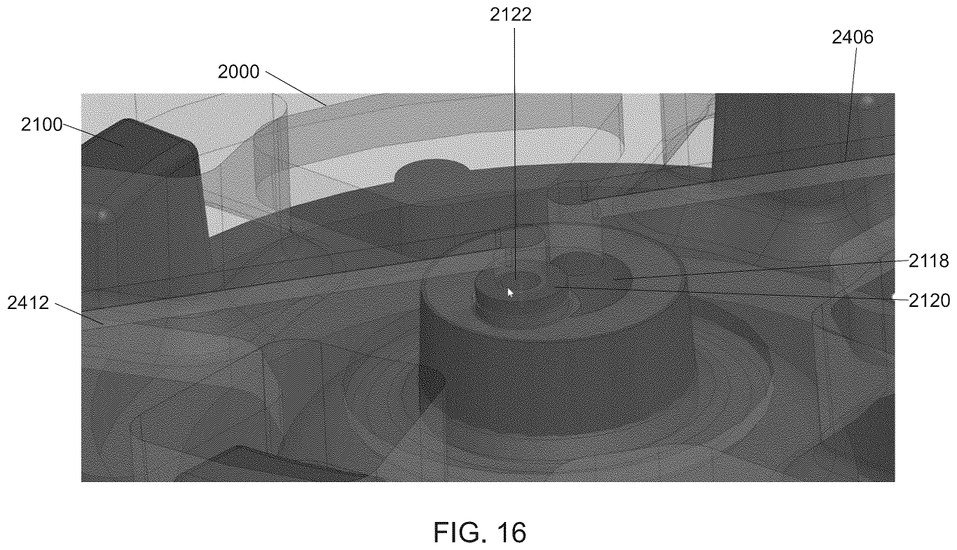

FIG. 15 depicts a blown up section of valve 2300 (shown in FIG. 14). Wall 2808 surrounding pathway 2804 on control section 2806 of valve 2300 is aligned with opening 2312 and thereby channel 2816 of the microfluidic cartridge. As shown pathway 2804 is aligned with opening 2312 in an open position allowing for fluid communication between the pathway 2804 and channel 2816.

FIG. 3A shows a bottom view of the microfluidic cartridge of FIG. 3A. Cap 2318 of the introduction element (not shown) is shown in the open position. Cartridge 2000 has a geometry that engages various elements of device used to process the microfluidic cartridge. Tab 2020 is an integral part of the microfluidic cartridge. The tab may be used to handle the microfluidic cartridge. In particular, the tab may allow for handling of the microfluidic cartridge without interfering with the contents of the microfluidic cartridge.

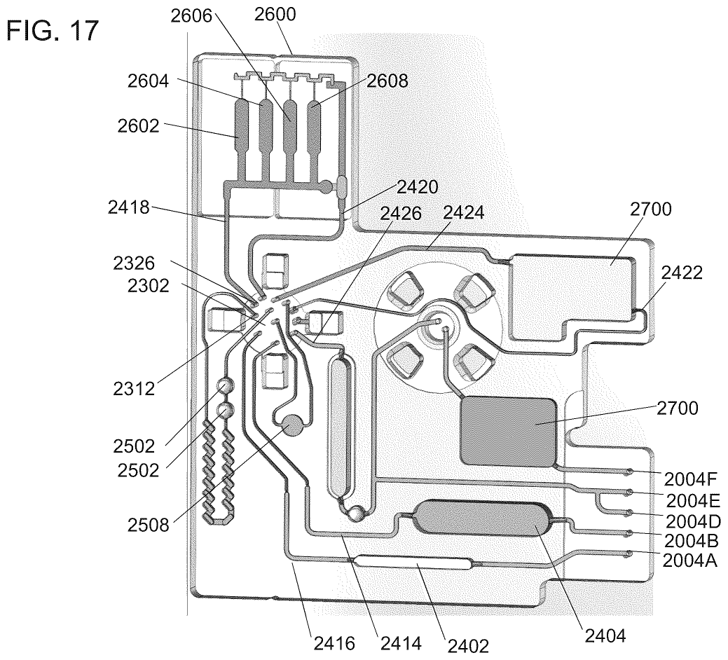

FIGS. 17A-E depict views of valve cover 2310 that is used on cartridge 2000 of FIG. 3A. FIG. 17A is a top view of a valve cover 2310 having aperture 2322 and rim 2324. Rim 2324 as shown in FIG. 17C may be used to couple the valve cover to a microfluidic cartridge.

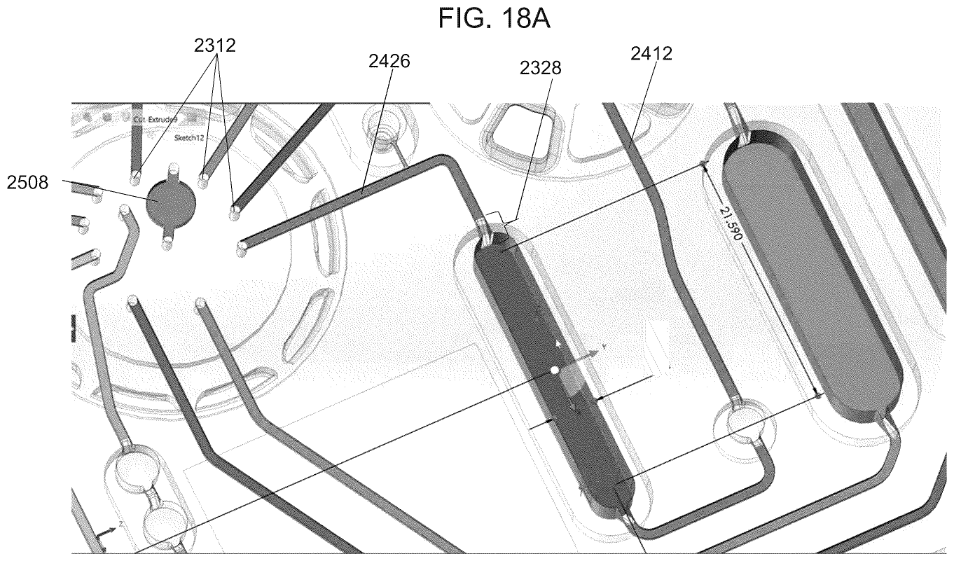

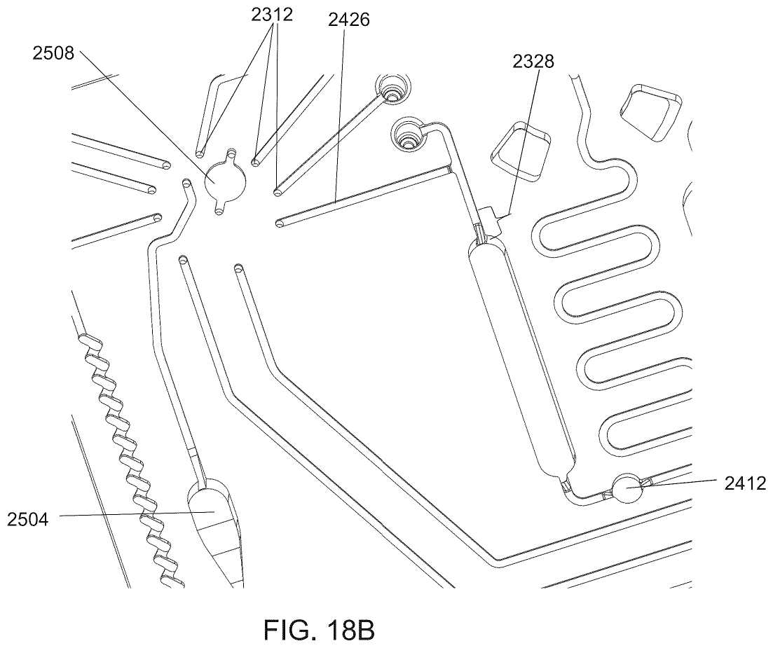

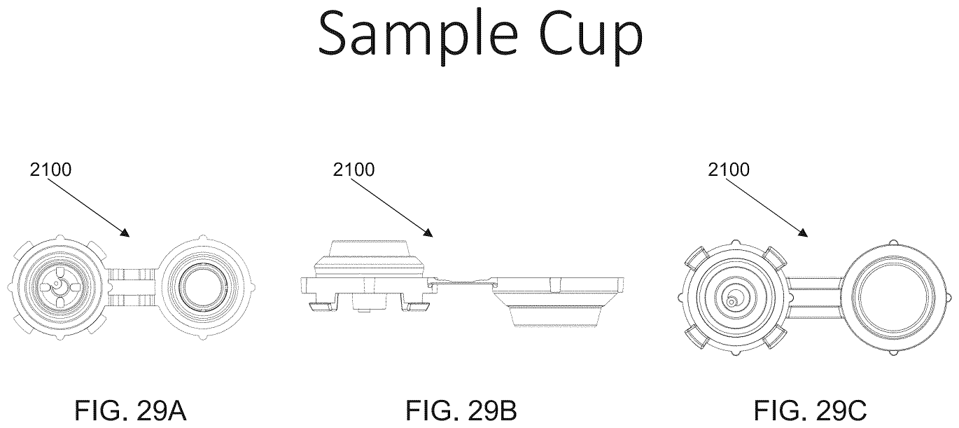

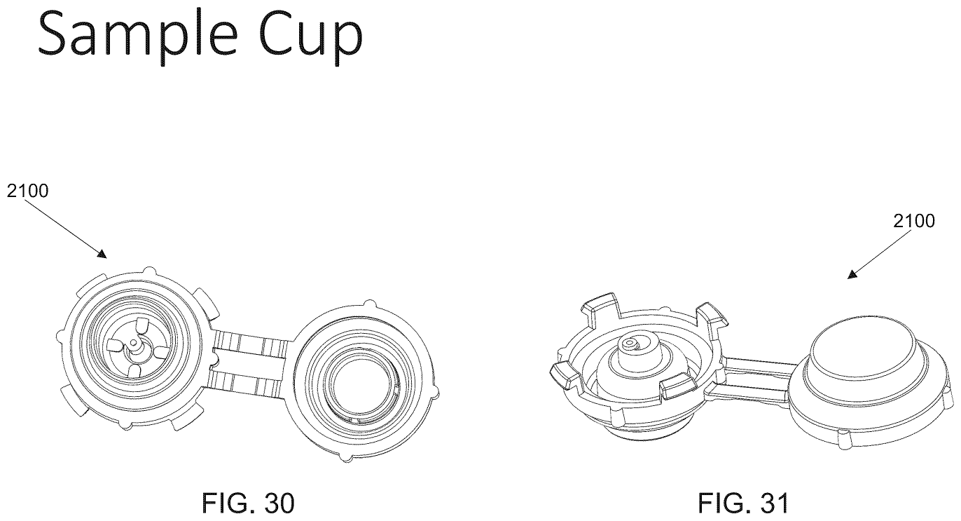

FIGS. 29-31 depict views of an introduction element 2100 having a cup 2108 and a cap 2318. The cap may be used to cover the cup of the introduction element to inhibit flow into and/or out of the introduction element during use. The cap may be coupled to the cup using a friction fit. For example, cup 2108 and cap 2318 include rims 2110, 2112 that engage each other during use. In particular, the embodiment shown in FIG. 18A shows friction elements 2114 on cap 2318. Snap elements may be used to couple the cap to the cup in a closed position during use. Further, cap 2318 is coupled to cup 2108 using hinge 2116.

As shown in FIG. 18A, cup 2108 of introduction element 2100 includes opening 2118 and chimney 2120 positioned within opening 2118 that allow access to the microfluidic cartridge during use. This chimney may have an aperture extending therethrough. The chimney may be in fluid connection with fluid (e.g., air or liquid) in the introduction element and the waste reservoir. Aperture 2122 in the hollow cylindrical chimney 2120 has a cross-sectional area that is predetermined. In particular, the aperture in the hollow cylindrical chimney has a cross-sectional area that is in range from about 3% to about 25% of a cross-sectional area of cup opening. In an example, the aperture in the hollow cylindrical chimney has a cross-sectional area that is about 6.5% of a cross-sectional area of opening 2118. In an embodiment, a radius of the chimney aperture may be about 0.382 mm while a radius of the cup opening may be about 1.5 mm. The aperture in the chimney runs the length of the chimney allowing for fluid communication between a top surface of the microfluidic cartridge and the head space of the introduction element.

In some embodiments, the vertical channel of the chimney is configured within the interior of the introduction element at a height greater than a plane comprising the first opening and lower than the underside of the opening in the cup. In other words, the chimney and the chimney aperture may extend beyond the plane in which the cup opening starts and ends. Thus, a length of the chimney and chimney aperture exceeds a vertical length of the opening during use.

FIG. 18C depicts a bottom view of the cap 2318 and cup 2108. Chimney 2120 positioned partially within opening 2118 allows for fluid communication between the microfluidic cartridge and either the headspace of the introduction element (i.e., when cap is closed) or the atmosphere (i.e., when cap is opened).

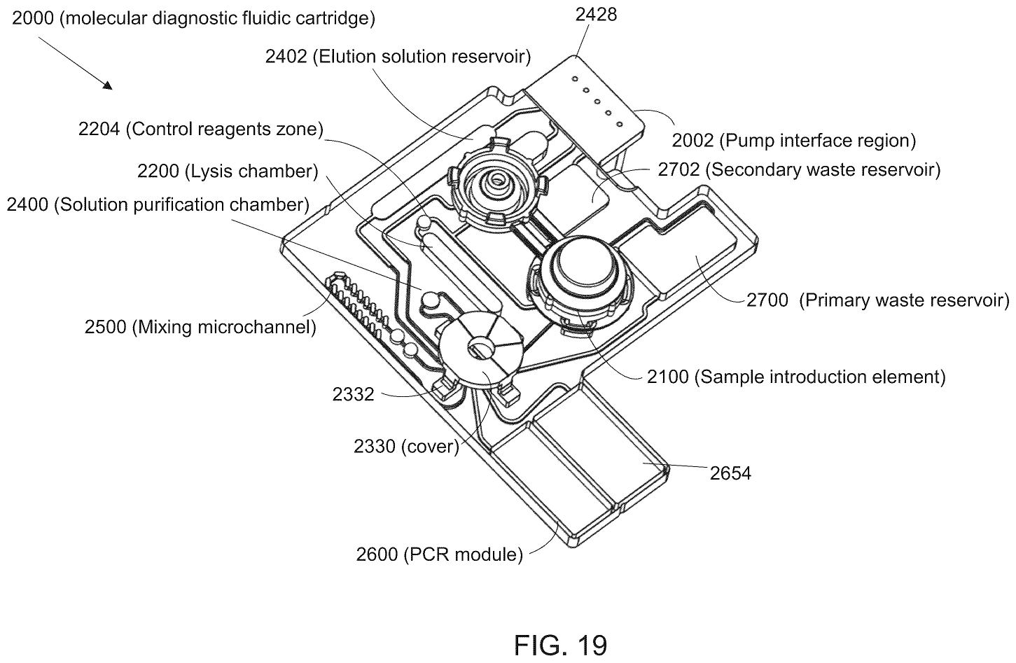

FIG. 19 depicts a bottom perspective view of the introduction element 2100 coupled to a semitransparent cartridge 2000. This image allows a view of the channels 2406, 2412 which are in fluid communication with the opening 2118 and the chimney 2120. Channels 2406, 2412 are also shown in FIG. 4. FIG. 4 shows chimney 2120 in fluid communication with port 2004C and opening 2118 in fluid communication with lysis element 2208 through channels 2406 and 2412, respectively. In some embodiments, the chimney allows air to escape the microfluidic cartridge during use. For example, if the cap is in a closed position the chimney may allow a fluid, in particular air to pressurize the inlet. In some embodiments, air pressure is applied at port 2004C to pressurize the introduction element 2100 during use.

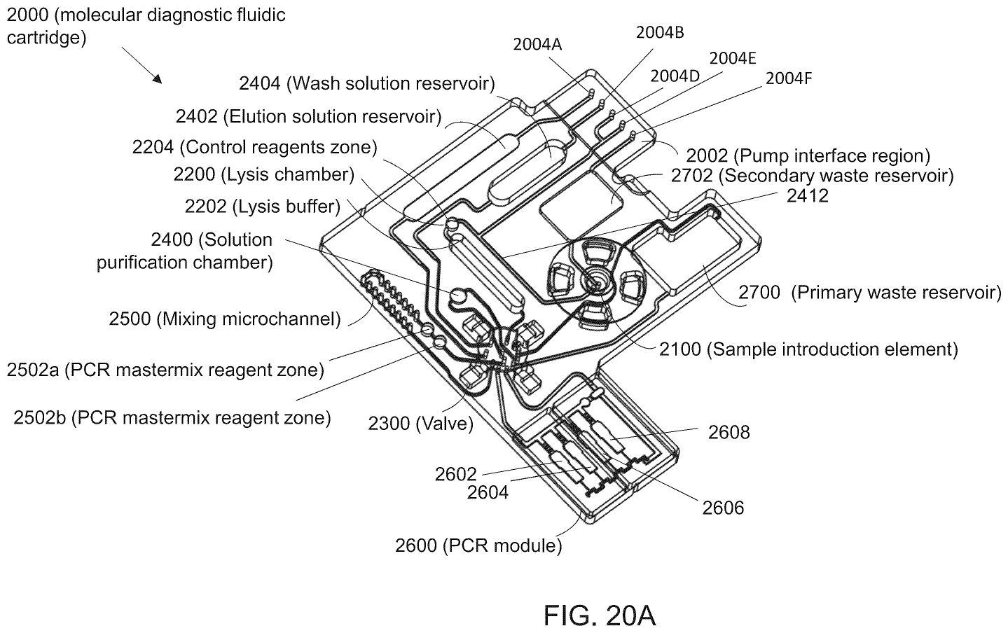

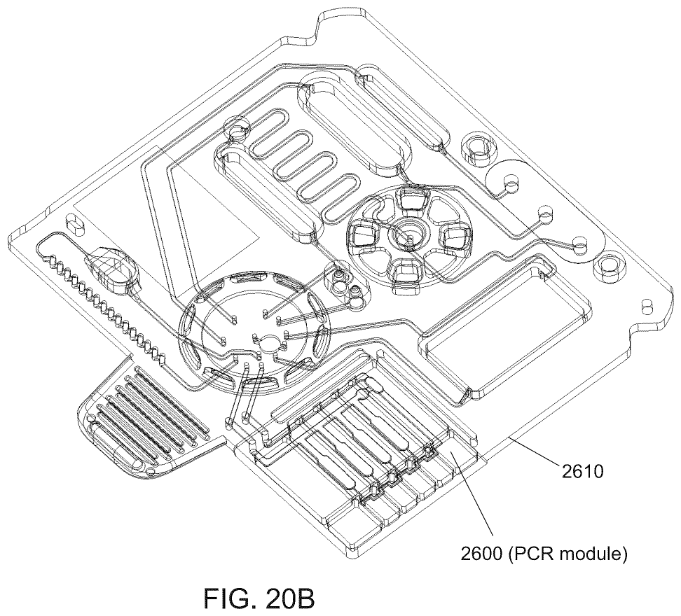

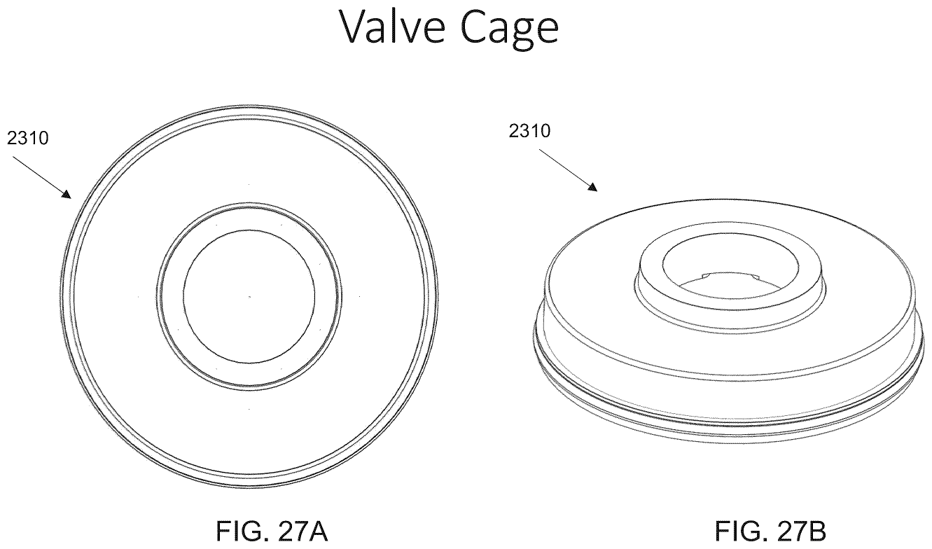

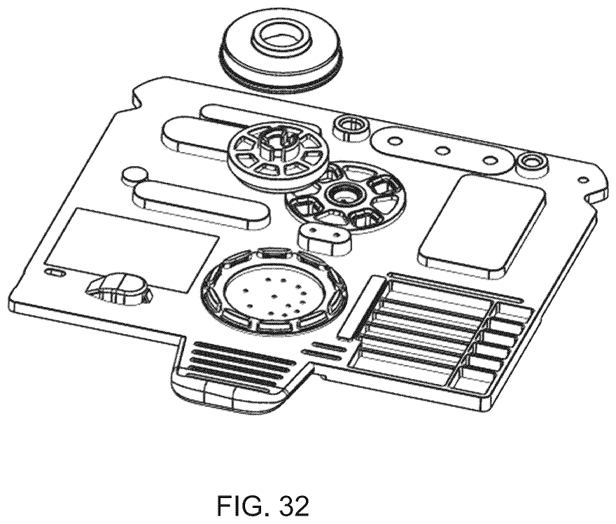

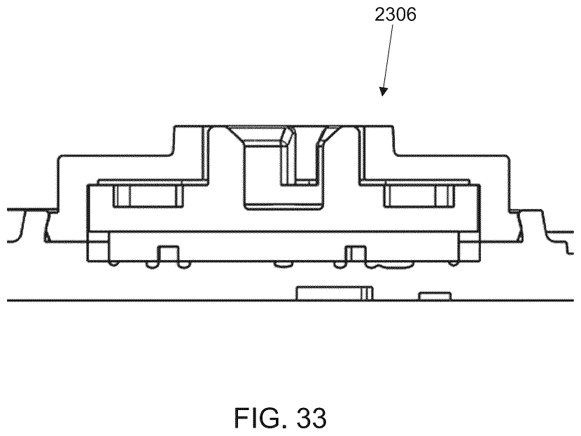

FIGS. 20-33 depict alternate configurations of cartridges 2000.

FIG. 20 depicts a bottom view of an alternate embodiment of a microfluidic cartridge. Channels, chambers, reservoirs, and reagent zones are shown in the absence of a bottom layer to indicate how these elements are positioned on the lower side of the microfluidic cartridge 2001 and extend into the microfluidic cartridge 2001. In some embodiments, reagents and/or solutions of interest may be positioned within elements of the microfluidic cartridge such that they are isolated. For example, reagents and/or solutions positioned in differing elements may be air-gapped from each other.

In addition, FIG. 20 illustrates examples of fluid flow paths through an embodiment of cartridge 2000. Microfluidic cartridge 2001 includes openings 2312 that are in communication with channels 2414, 2416, 2418, 2420, 2422, 2424, 2426. The microfluidic cartridge 2001 includes channels 2406, 2408, 2410, 2412, 2414, 2416, 2418, 2420, 2422, 2424, 2426 between the various elements such that some of the elements are in fluid communication.

In some instances, fluid can be moved through the microfluidic cartridge 2000 using openings at ports that are connected to a source of pressure. For example, pneumatic pressure provided to a channel at a port may be used to move fluids through the device. As shown in FIG. 20, ports 2004A, 2004B, 2004D, 2004E, and 2004F access different portions of the microfluidic cartridge. Thus, it is possible to selectively control fluid flow to different elements in the microfluidic cartridge.

Ports may, in some embodiments, be connected to outside sources of reagents if desired. Thus, channels, reservoirs, chambers, and zones which may be in fluid communication with each other and with ports may be in fluid communication allowing fluid entry via ports. In some embodiments, ports of a microfluidic cartridge may be used to monitor and/or control physical conditions of the microfluidic cartridge, for example, temperature, pressure etc. For example, a thermal control element can perform thermal cycling with heating and cooling and/or a pressure sensor can be used to indicate whether a port (e.g., a fluidic port or a pneumatic port) is blocked or has a leak and to identify the location of a blocked or leaking port.

As shown in FIG. 20, distribution element 2302 includes openings 2312 that extend from top side to bottom side of the microfluidic cartridge 2001. Distribution element 2302 is in fluid communication with reagent zone 2204, lysis chamber 2200, waste reservoir 2700, and ports 2004A, 2004B, 2004C. Lysis chamber 2200 is in fluid communication with distribution element 2302. At distribution element 2302 there are a series of openings 2312 and channels 2414, 2416, 2418, 2420, 2422, 2424, 2426 access to which is controlled by valve element 2306 (not pictured) that is coupled to the microfluidic cartridge 2001 on the top surface (not pictured) during use.

Channels 2414, 2416, 2418, 2420, 2422, 2424, 2426 emanating from the distribution element 2302 connect the distribution element 2302 to solution reservoirs 2402, 2404, extraction chamber 2508, reagent zones 2502, mixing channel 2500, waste reservoir 2700, and PCR element 2600 that includes PCR chambers 2602, 2604, 2606, 2608. As shown the mixing channel 2500 is a corkscrew-shaped channel which traverses the X, Y, and Z axes. As shown opening in distribution element 2302 connect to channel 2418 that provides fluid to the reactor chambers 2602, 2604, 2606, 2608 and channel 2420 that provide a pathway for the fluid back to the distribution element 2302. Thus, PCR chambers 2602, 2604, 2606, and 2608 are in fluid communication with valve 2300.

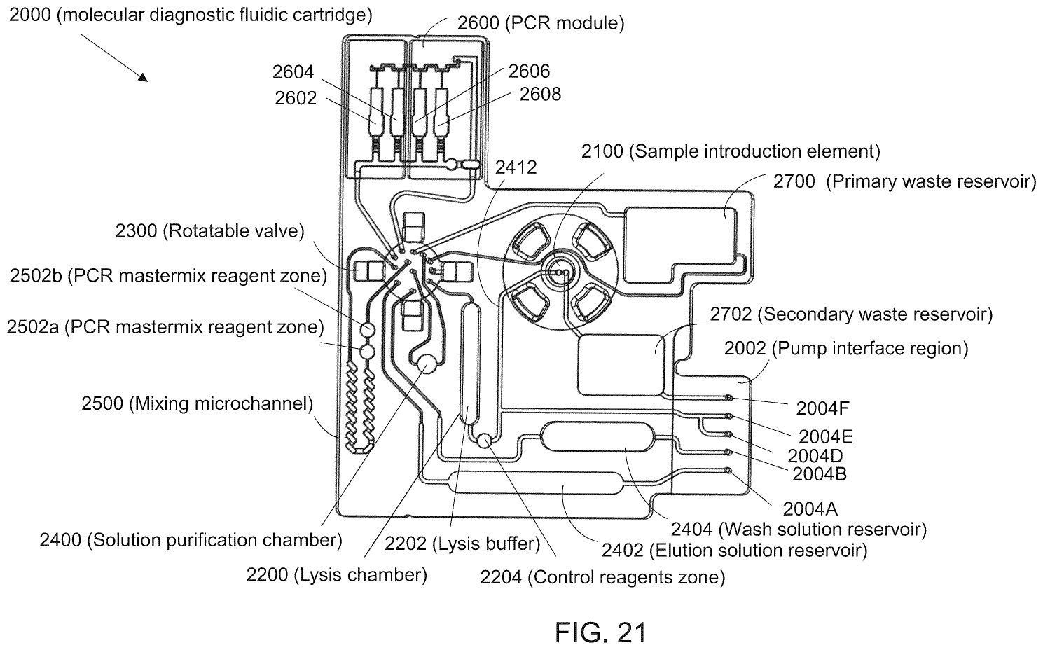

A blown up perspective view of a bottom side of microfluidic cartridge 2001 is shown in FIG. 21. The top side of the distribution element 2302 includes lip 2320 as can be seen in the translucent image of the microfluidic cartridge. Openings 2312 extend through the microfluidic cartridge 2001 to the bottom surface 2001b where the openings connect to channels as shown. Elements in the microfluidic cartridges, such as channels, chambers, reservoirs, and zones may vary in depth. For example, channels may vary in depth in particular at junctions between channels and chambers. As shown in FIG. 21, at junction 2328 between channel 2426 and chamber 2208, the channel depth matches the depth of the chamber and then the channel becomes more shallow. Depending on use depths of chambers, zones, channels, and zones may vary.

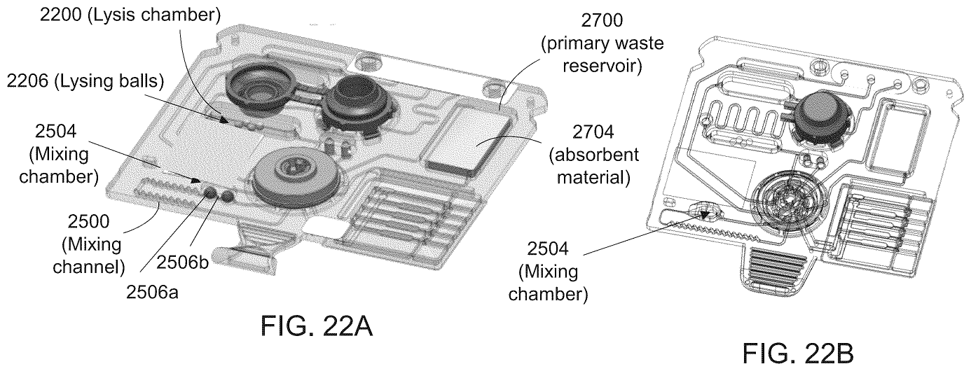

Another embodiment of an assembled cartridge 2000 is shown in FIG. 22, where both cover 2330 and introduction element 2100 are positioned such that flanges 2332 of cover 2330 and introduction element 2100 engage microfluidic cartridge 2001 during use. Further, lids 2654 are positioned over the PCR region 2600 and the pump interface region 2002.

In some embodiments, a microfluidic cartridge can includes recesses in microfluidic cartridge 2001. Openings may couple an element, such as a cover or introduction element 2100 (shown in FIG. 22) to the microfluidic cartridge.

FIG. 22A depicts an assembled cartridge 2000 that includes introduction element 2100 where a sample is provided during use. As shown, cartridge 2000 includes a microfluidic cartridge 2001 having four PCR chambers 2602 having a predetermined geometry. Channels 2416, 2426 emanate from distribution element 2302 that is under cover 2330 and valve (not shown). As shown in FIG. 22B, cover 2330 includes flanges 2332 that couple the cover to the microfluidic cartridge.

In some embodiments, a lysis element is provided to prepare the sample for analysis. Lysing biological materials is necessary to conduct certain analyses on samples. A lysis element for biological materials can include a lysing chamber 2200 and one or more magnetizeable balls 2206 in a microfluidic cartridge.

Depending on the pre-determined configuration of the microfluidic cartridge 2000 some components may be appear in multiple locations on the microfluidic cartridge. For example, an embodiment of a microfluidic cartridge may include multiple waste reservoirs, one or more of PCR mastermix zones, and/or multiple PCR chambers. In some embodiments, the introduction element is a sample introduction cup.

For example, the microfluidic cartridge 2000 may include, but is not limited to an introduction element, a rotatable valve, and a microfluidic cartridge having a mechanical lysis chamber, a extraction chamber, one or a plurality of waste reservoirs, a wash solution reservoir, an elution solution reservoir, PCR mastermix zones, a mixing channel, and/or PCR chambers. In some embodiments, a rotatable valve is controlled such that the valve allows for specific elements of the microfluidic cartridge to be in fluid communication with each other.

As shown in FIG. 3A, cartridge 2000 includes chambers 2602, 2604, 2606, 2608, channels, openings, pump interface region 2002, ports 2004, 2006, 2008, 2010, extraction chamber 2508, mixing chambers, reagent zones 2502a, 2502b, etc. Cartridges may include a sample receptacle to receive a sample and areas to perform functions such as cell lysis, DNA capture and wash, DNA amplification and DNA dilution. In some embodiments, a source of pressure, for example, air pressure, can be used to move liquids within the sample cartridge. For example, pressure may be selectively delivered to the microfluidic cartridge using ports in the pump interface region such that fluids are moved in a predetermined way.

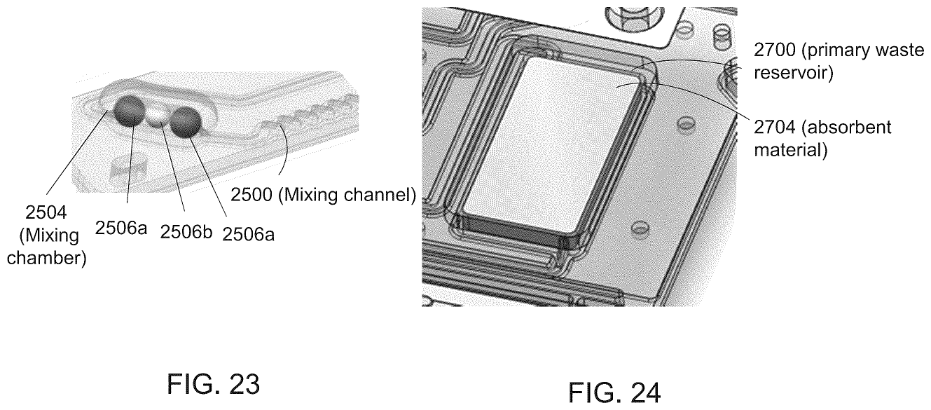

In some embodiments, mixing channels and/or chambers are combined to enhance mixing of materials. FIG. 23 show an alternate configuration that combines mixing chamber 2504 having multiple balls 2506a, 2506b having different sizes proximate the mixing channel 2500.

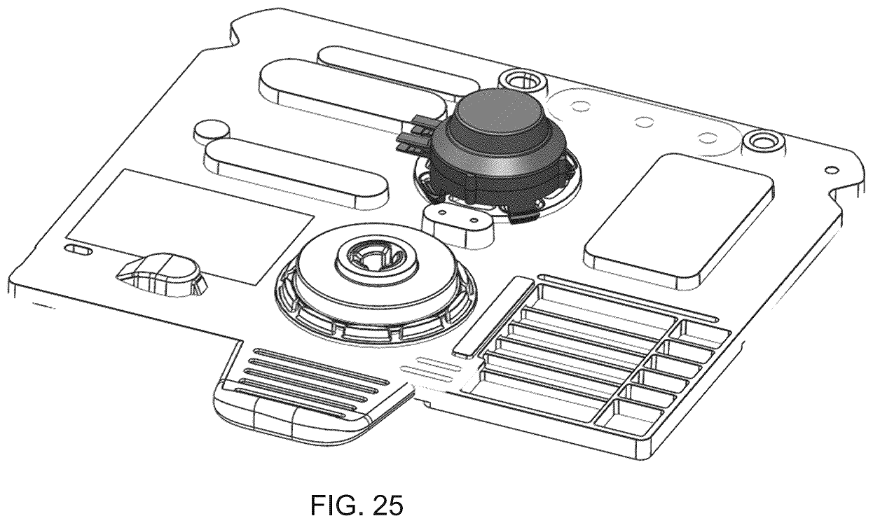

As shown in FIG. 25, a lysis element may be provided to prepare the sample for analysis. Lysing biological materials is necessary to conduct certain analyses on samples. A lysis element for biological materials can include a lysing chamber 2200 and one or more magnetizeable balls 2206 in a microfluidic cartridge.

For example, a lysis chamber 2200 are positioned in a microfluidic cartridge 2001 having a plurality of ball bearings 2206 positioned within the lysing chamber 2200 in the assembled cartridge 2000. A number of balls 2206 may vary between about 2 to 10. In some embodiments, as shown in FIG. 22A, four balls 2206 are present in the lysis chamber 2200.

In some instances, magnetizeable balls 2206 used in the lysis chamber 2200 are sized to the lysing chamber. FIG. 22A depicts magnetizeable balls 2206 of approximately the same size in lysis chamber 2200. In some instances, magnetizeable balls used in the lysing element may be uncoated ball bearings of a uniform size. For example, the lysing chamber and magnetizeable balls may be sized such that the balls move freely along a determined path for a predetermined distance in the lysing chamber. The magnetizeable balls may have a predetermined diameter. In particular, magnetizeable balls 2206 as shown in FIG. 9 have a diameter of about 0.09 inches (i.e., 2.29 mm).

Magnetizeable balls can include, but are not limited to balls having magnetic properties, metal balls, balls made of alloys such as stainless steel balls, ball bearings, and the like. In some embodiments, magnetizeable balls may be coated or uncoated ball bearings based on the requirements of use. For example, magnetizeable balls 2206 may be ball bearings plated with chrome, in particular 410 chrome.

Various methods may be used to move the magnetizeable balls 2206 within the lysing chamber. In some embodiments, the magnetizeable balls 2206 are magnetic. Subjecting magnetic magnetizeable balls 2206 to a variable magnetic field may move the magnetizeable balls in the lysis chamber.

For example, as shown in FIG. 25, mixing channel 2500 is in fluid communication with valve element 2306 as well as mixing chamber 2504. Geometries, surfaces, sizes of the mixing channel, and/or ratios of dimension of elements of the mixing channel, for example, a ratio of mixing channel length to the inlet and/or outlet may be selected to provide predetermined flow characteristics in the mixing channel.

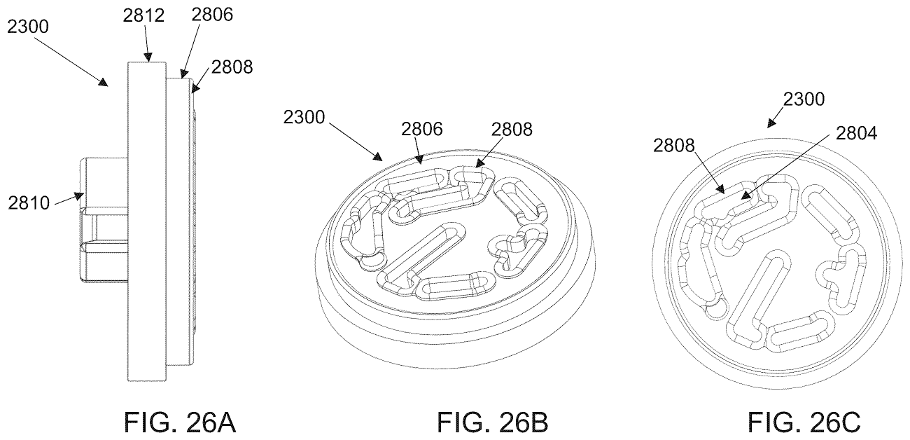

As shown in embodiments depicted in FIGS. 25-26 mixing channel 2500 is a semi-helical channel. FIGS. 25-26 depict semi-helical channels having discontinuously smooth walls and having straight regions 2522 and curved regions 2524.

In some embodiments, flowing fluids through a helical or semi-helical channel enhances mixing of fluids. Some embodiments of a mixing channel 2500 may include walls having variable smoothness. For example, a mixing channel 2500 may have discontinuously smooth walls. In some embodiments, regions of the channel may be straight and/or other regions of the channel are bent. As shown in embodiments depicted in FIGS. 25-26 mixing channel 2500 is a semi-helical channel. FIG. 25 shows an alternate configuration that combines mixing chamber 2504 having multiple balls 2506 having different sizes proximate the mixing channel 2500.

Balls or ball bearings may also be used to mix materials in the microfluidic cartridge. As shown in FIG. 25, mixing balls 2506a, 2506b are positioned in mixing chamber 2504 proximate mixing channel 2500. Mixing balls include balls of differing dimensions including balls 2506a that have a larger diameter than ball 2506b. Balls may be used to mix materials, for example, master mix and/or excipients.

Mixing channels and/or chambers may be combined to enhance mixing of materials. For example, a reagent admixture may be mixed to homogenize nucleic acid and mastermix reagents concentration throughout the volume of the admixture. In some embodiments, a PCR admixture is mixed to homogenize the nucleic acid and PCR mastermix reagents concentration throughout the volume of the PCR admixture.

In some embodiments, the semi-helical channel has discontinuously smooth walls, wherein some regions of the semi-helical channel are straight and other regions of the semi-helical channel are bent. The mixed PCR admixture obtained by the methods described herein is referred to as a “mixed PCR admixture.”

In addition, a lysis chamber 2200 may be positioned in a microfluidic cartridge 2001 having a plurality of magnetizeable balls (ball bearings) 2206 positioned within the lysing chamber 2200 in the assembled cartridge 2000. A number of magnetizeable balls may be 1, 2, 3, 4, 5, 6, 7, 8, 9, or 10 balls, or any number of balls ranging between any two of those numbers. In some embodiments a number of balls may vary between about 1 to about 10. For example, as shown in FIG. 25, four balls 2206a, 2206b are present in the lysis chamber 2200.

In an embodiment of a lysis element magnetizeable balls 2206 within the lysing chamber may be all the same size. FIG. 4 depicts magnetizeable balls 2206 of approximately the same size in lysis chamber 2200. In some instances, magnetizeable balls 2206 used in the lysing element may be uncoated ball bearings of a uniform size.

Dimensions of a lysis chamber 2200 may be determined by use. Embodiments of lysis chambers 2200 may have a width in a range between about 0.05 inches and 0.2 inches (1.3 mm to 5 mm) and a length in a range between about 0.35 inches and 1.3 inches (8.9 mm to 33 mm). For example, an embodiment may include a lysis chamber 2200 having a width of about 0.145 inches (3.7 mm) and a length of about 1 inch (25.4 mm)

In some instances, magnetizeable balls used in the lysis chamber may be sized to the lysing chamber. For example, the lysing chamber and magnetizeable balls may be sized such that the balls move freely along a determined path for a predetermined distance in the lysing chamber. The magnetizeable balls may have a predetermined diameter. In some instances, a ratio of a diameter of the ball bearings to a transverse width of the lysing chamber may in a range from about 0.03125 to about 0.125. Magnetizeable balls may have a diameter in a range from about 0.03125 inches to 0.125 inches (0.79 mm to 3.18 mm). In particular, magnetizeable balls may have a diameter of about 0.09 inches (i.e., 2.29 mm).

Magnetizeable balls can include, but are not limited to balls having magnetic properties, metal balls, balls made of alloys such as stainless steel balls, ball bearings, and the like. In some embodiments, magnetizeable balls may be coated or uncoated ball bearings based on the requirements of use. For example, magnetizeable balls may be ball bearings plated with chrome, in particular 410 chrome.

Various methods may be used to move the magnetizeable balls within the lysing chamber. In some embodiments, the magnetizeable balls are magnetic. Subjecting magnetic magnetizeable balls to a variable magnetic field may move the magnetizeable balls in the lysis chamber.

To ensure fluids within a microfluidic cartridge are properly mixed some elements may be provided in the microfluidic cartridge that enhance mixing. In some embodiments, constituent concentrations may be influenced and/or controlled using turbulent flow. In particular, fluid concentrations may be homogenized by turbulent flow mixing. For example, fluid flow may be controlled such that a predetermined constituent concentration at an outflow of a mixing element is within a predetermined range relative to the total fluid volume.

In some embodiments, turbulent flow mixing can be performed by a series of “push-pull” fluid compression steps, wherein the fluid path is moved forward, then reverse (or vice-versa), and repeated a selected number of instances. Fluid compression may be achieved by selectively applying pressure at ports when in fluid communication with a particular mixing element such as a channel and/or chamber. Pressure differentials throughout the microfluidic cartridge may influence fluid flow including, but not limited to turbulence and/or residence time of fluids in the microfluidic cartridge. For example, FIG. 20 depicts multiple ports 2004A, 2004B, 2004D, 2004E, 2004F, in fluid communication with introduction element 2100, reservoirs 2402, 2404, channels, and valve element 2306. In some embodiments, air may be introduced to a port at a predetermined pressure to cause movement within the microfluidic cartridge.

In some embodiments, mixing may occur in mixing channels. In particular, flowing fluids through a helical or semi-helical channel may enhance mixing of fluids. Some embodiments of a mixing channel may include walls having variable smoothness. For example, a mixing channel may have discontinuously smooth walls. In some embodiments, regions of the channel may be straight and/or other regions of the channel are bent. In alternate embodiments, channels may include projections and/or depressions in walls of channels.

For example, as shown in FIG. 25, mixing channel 2500 is in fluid communication with valve element 2306 as well as mixing chamber 2504. Geometries, surfaces, sizes of the mixing channel, and/or ratios of dimension of elements of the mixing channel, for example, a ratio of mixing channel length to the inlet and/or outlet may be selected to provide predetermined flow characteristics in the mixing channel.

As shown in embodiments depicted in FIGS. 25-26 mixing channel 2500 is a semi-helical channel. FIGS. 25-26 depict semi-helical channels having discontinuously smooth walls and having straight regions 2522 and curved regions 2524.

In some embodiments, mixing channels and/or chambers may be combined to enhance mixing of materials. FIGS. 25-26 show an alternate configuration that combines mixing chamber 2504 having multiple balls 2506 having different sizes proximate the mixing channel 2500.

In some embodiments, concentration homogenization can be performed by conveying a fluid through a helical or semi-helical channel. For example, a reagent admixture may be mixed to homogenize a nucleic acid and mastermix reagents concentration throughout the volume of the admixture. In some embodiments, a channel may be used to mix a PCR admixture to homogenize the nucleic acid and PCR mastermix reagents concentration throughout the volume of the PCR admixture.

In some embodiments, flowing fluids through a helical or semi-helical channel may enhance mixing of fluids. Some embodiments of a mixing channel 2500 may include walls having variable smoothness. For example, a mixing channel 2500 may have discontinuously smooth walls. In some embodiments, regions of the channel may be straight and/or other regions of the channel are bent. As shown in embodiments depicted in FIGS. 6-7 mixing channel 2500 is a semi-helical channel. FIG. 6 shows an alternate configuration that combines mixing chamber 2504 having multiple balls 2506 having different sizes proximate the mixing channel 2500.

As shown in FIG. 24, waste reservoir 2700 includes absorbent material 2704.

FIG. 2 depicts a perspective top view of an embodiment of a microfluidic cartridge with valve element 2306 and introduction element 2100. FIGS. 3-4 depict views of alternate embodiments of a microfluidic cartridge.

FIG. 22A shows an exploded perspective top view of a microfluidic cartridge. Magnetizeable balls 2206 and mixing balls 2506 are shown proximate lysis chamber 2200 and mixing chamber 2504. Absorbent material 2704 is positioned proximate the waste reservoir 2700 where it will be housed during use.

In this cartridge embodiment, microfluidic cartridge includes a top portion 2001a and bottom portion 2001b. Top portion includes reservoirs and elements used to connect to both introduction element 2100 and valve 2300. Bottom portion 2001b includes a matrix of channels 2044.

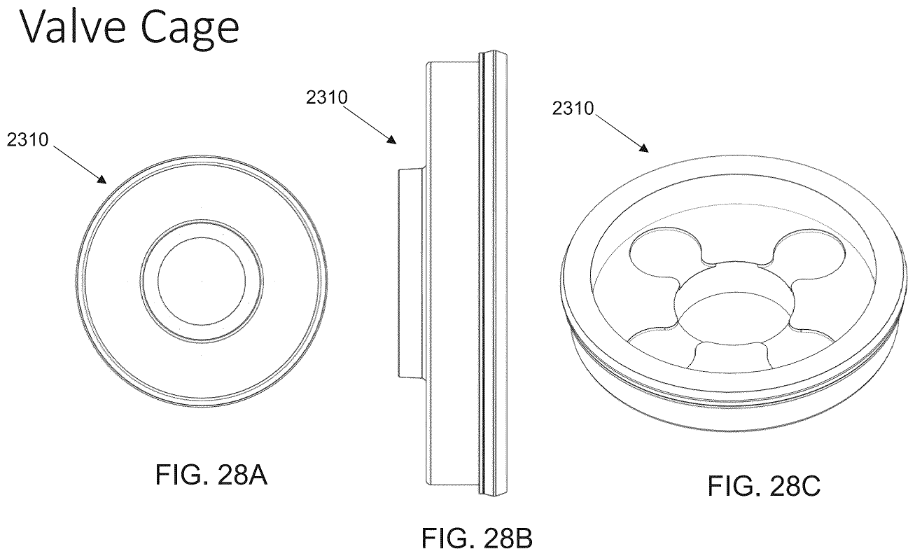

FIG. 2 depicts a top perspective view of a microfluidic cartridge 2001 where the top portion 2001a and bottom portion 2001b are assembled. Thus, the channels are positioned such that the reservoirs 2700, introduction element (2100), valve element (2300), PCR chambers 2602, 2604, 2606, 2608, lysis chamber 2200, and ports 2004A-C are capable of being placed in fluid communication when the microfluidic cartridge is assembled as shown in FIGS. 28-29. Valve element 2306 and introduction element 2100 are coupled to microfluidic cartridge 2001 during use as shown in FIGS. 28-29. The PCR elements of FIG. 26 may be sized substantially similarly to the PCR elements described in FIGS. 9-11. In some embodiments, the PCR element may include an alternative geometry.

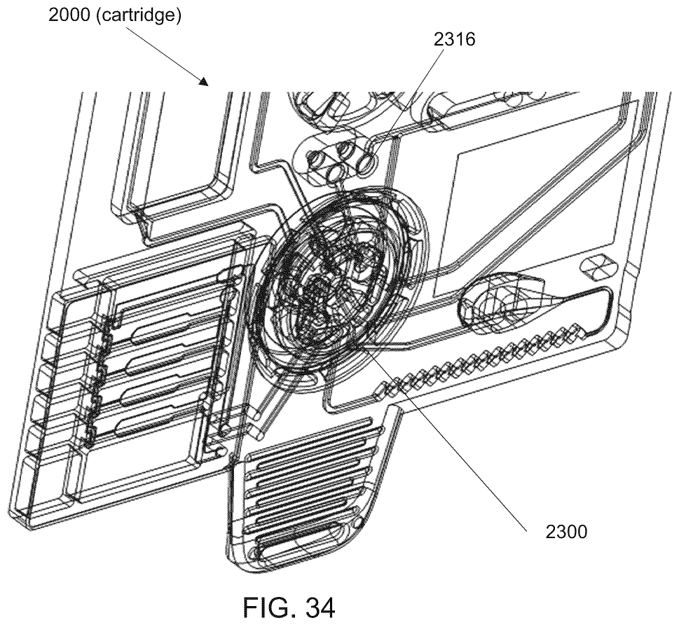

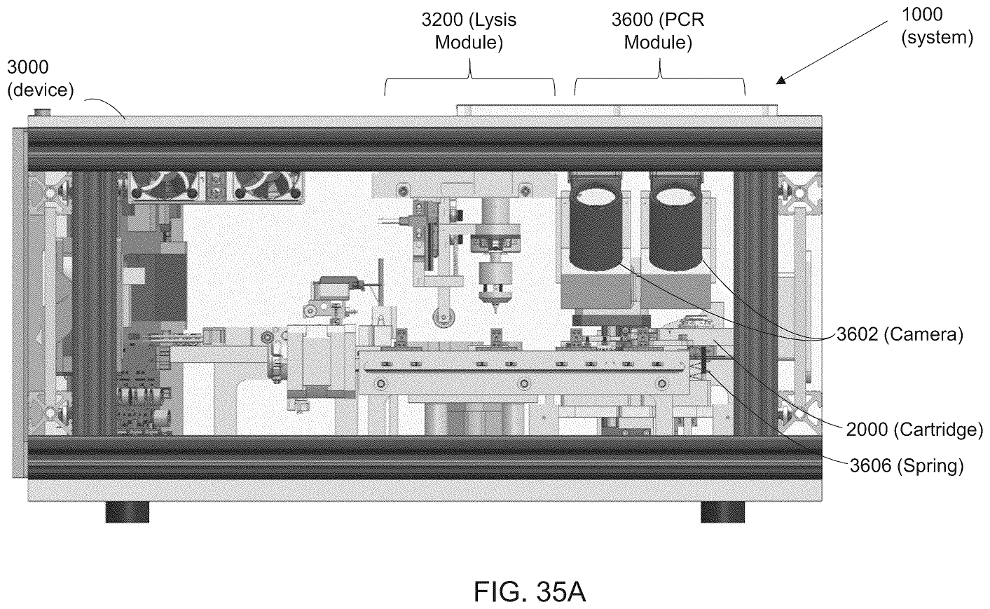

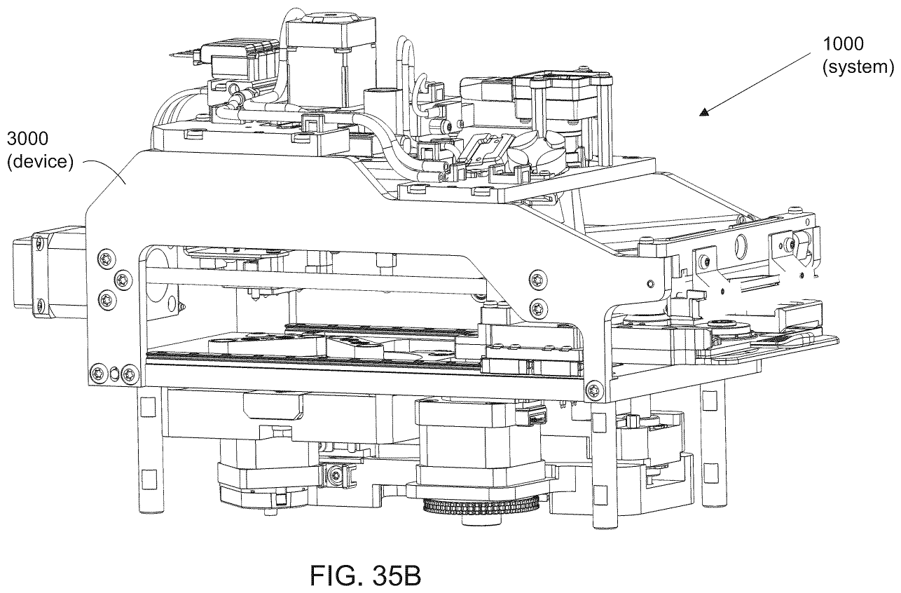

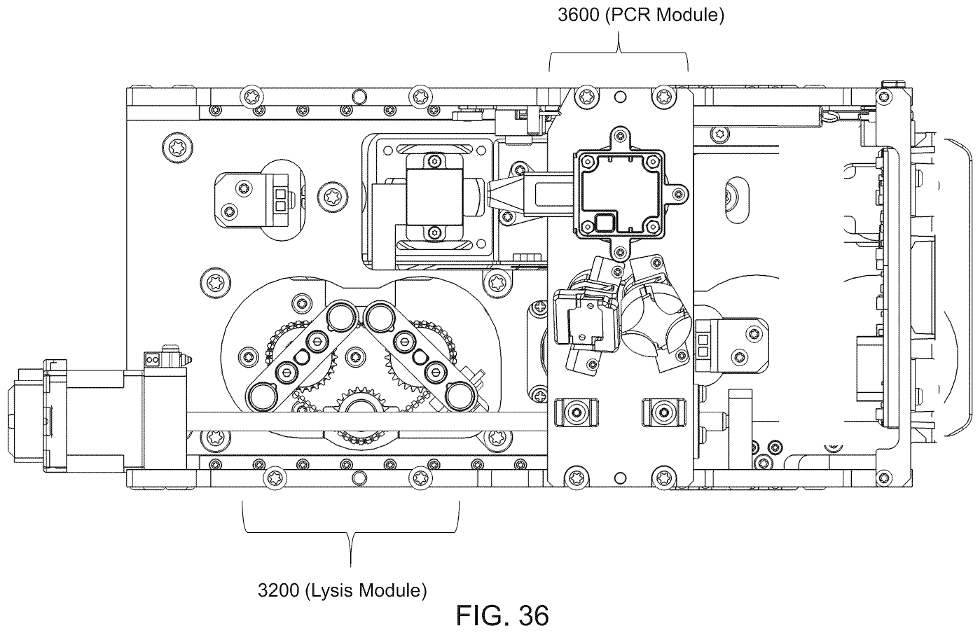

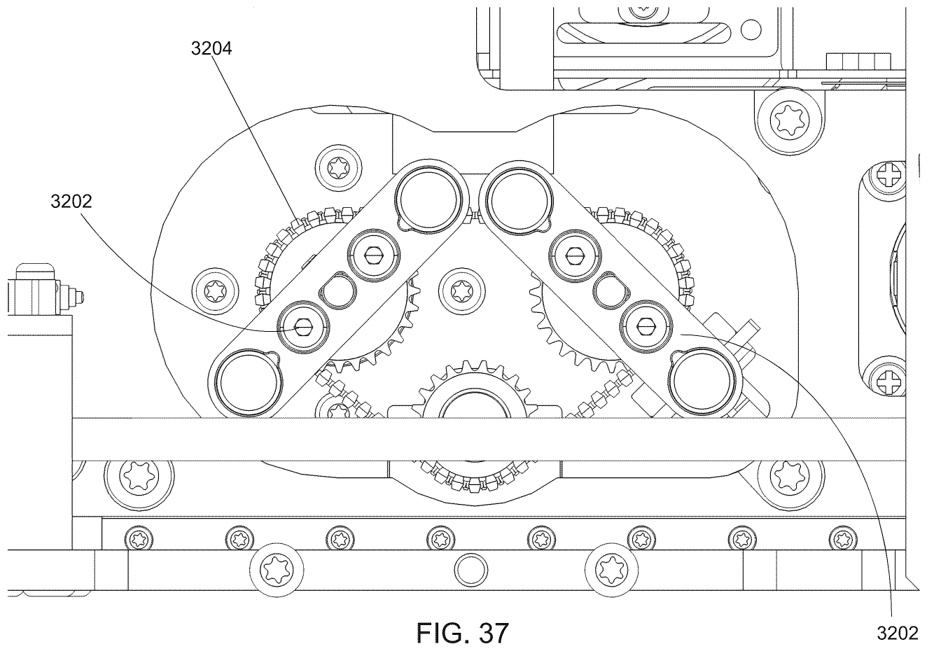

Valve element 2306 for use in cartridge shown in FIG. 28 includes both valve 2300 shown in in FIGS. 34-35 and cover 2310 shown in FIGS. 36-37. As shown in FIGS. 34-35, valve 2300 includes an engaging section 2810, base section 2812, and control section 2806. As described above, the engaging section may be formed from a material having a hardness capable of supporting attachment to an instrument for positioning the valve in the desired orientation. Materials used in the engaging section 2810 may include, but are not limited to plastics such has polycarbonate, polypropylene, etc.

FIGS. 13-15 depict views of a valve 2300 where the walls 2808 and pathways 2804 contained within the walls on the control section 2806 are visible. Wall heights may be in a range of about 0.10 mm to about 0.30 mm. For example, as shown in FIG. 13B walls 2808 have a height of about 0.127 mm. In addition, ring wall 2814 encircles control section 2806.

FIG. 14 depicts valve element 2306 that includes cover 2310 and valve 2300 positioned above distribution element 2302 that includes openings 2314 on a portion of a microfluidic cartridge 2001. The openings in the distribution element may be in fluid communication with channels in the microfluidic cartridge. Positioning of the control portion 2806 and specifically the walls 2808 and pathways 2804 on the surface of the control portion shown in FIGS. 15A-C controls fluid flow in the microfluidic cartridge at the distribution element 2302. As shown in FIG. 14, when assembled the control element 2806 of the valve is in contact with the openings 2312 in the distribution element 2302. Thus, the walls formed of flexible material may limit the flow of fluids at the distribution element to the pathways defined by the walls when the valve element is in a predetermined position. Materials used in the control element may be selected for a specific hardness and/or capacity for deformation.

As described above, the walls and/or the entire control element may be formed from a silicone. In an embodiment, the control section of the valve includes wall elements made from overmolded silicone. The silicone used in the control section of the valve may be selected based on the hardness of the material. In particular, silicones used in the wall element may be selected based on a reported hardness value of the material using the Durometer Shore A Hardness scale. For example, a silicone may be selected for use in a control section of a valve if the reported value on the Durometer Shore A Hardness scale is in a range from about 30 to 80. In some embodiments, a silicone material having a hardness in a range between 40 and 70 on the Durometer Shore A hardness scale. In a particular embodiment, the walls on the control section are formed from a silicone selected for having a valve of about 60 on the Durometer Shore A hardness scale.

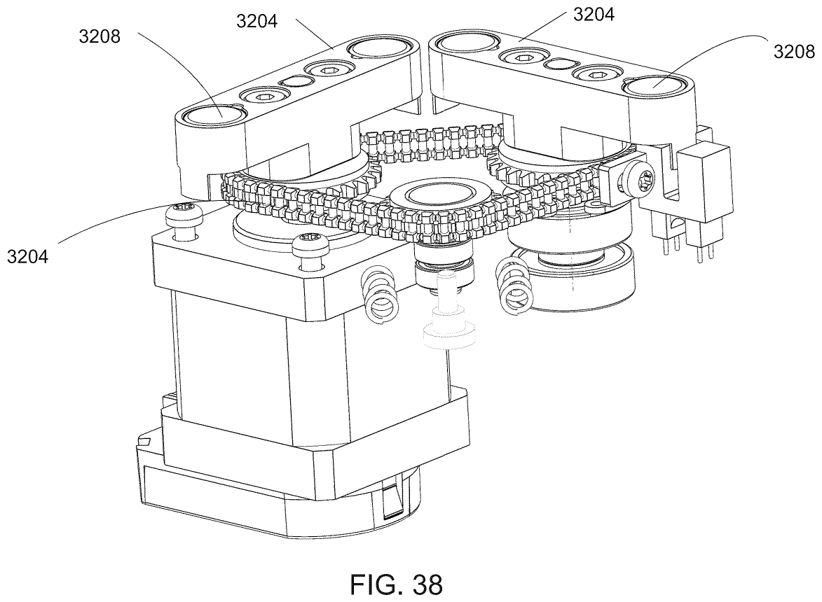

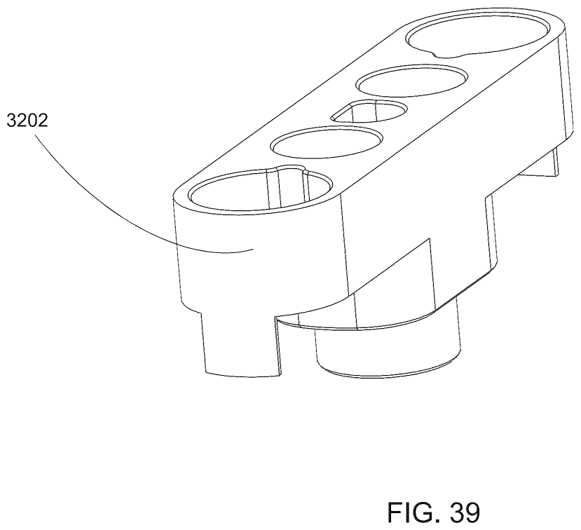

FIGS. 36-37 depict views an alternate embodiment of a valve cover 2310. FIGS. 38-40 depict views of an alternate embodiment of introduction element 2100.

To ensure that elements of the microfluidic cartridge are in fluid communication, in some instances, cartridges include a valve element, such as a rotatable valve having one or more pathways on a control section that direct movement of materials at the valve. In particular, turning the valve allows the control section to direct fluids into predetermined channels such that the fluids flow in a predetermined path through the microfluidic cartridge. Different positions of the rotatable valve may selectively allow any of the aforementioned elements to be in fluid communication. FIG. 35 depicts a partial cross-sectional top view of a microfluidic cartridge 2000 where the pathways 2804 on the control section 2806 of the valve element 2306 are visible. Pathways 2804 are bounded by walls 2808.

Pathways may allow for fluid communication between two unconnected channels when the valve element is positioned in a predetermined orientation. Pathways may define an area on the bottom surface of a valve element that is encompassed a wall of material surrounding an open area. As shown in FIG. 4, pathways 2804 extend above the outer surface of the valve 2300. The height of walls of the pathways above the valve may be in a range of about 0.10 mm to about 0.30 mm. For example, as shown in FIG. 4 an embodiment of pathways 2804 have a height of about 0.127 mm. Thus, the pathways can permit fluids to flow without escaping the confines of the valve. Further, ring wall 2814 encircles control section 2806. The ring wall may inhibit and/or limit flow of fluids at the valve. As shown in FIG. 4 ring wall 2814 encircles pathways 2804 to inhibit movement of fluid beyond the valve.

FIG. 18A depicts an exploded top view of a portion of a microfluidic cartridge.

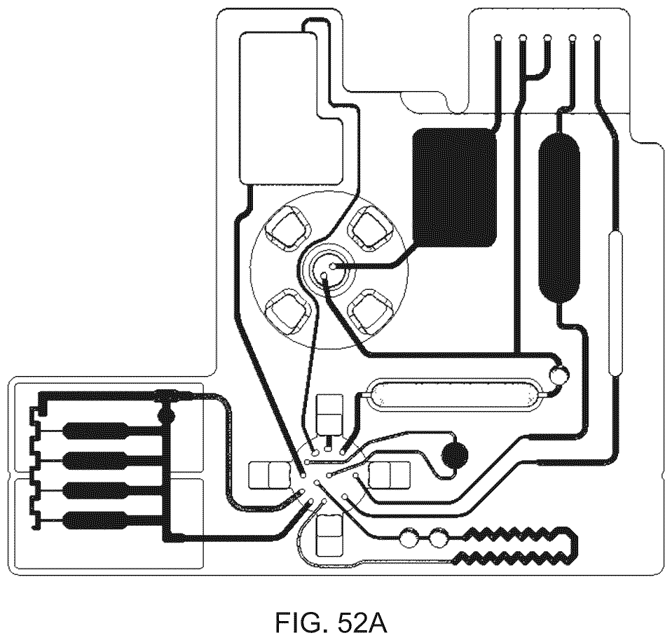

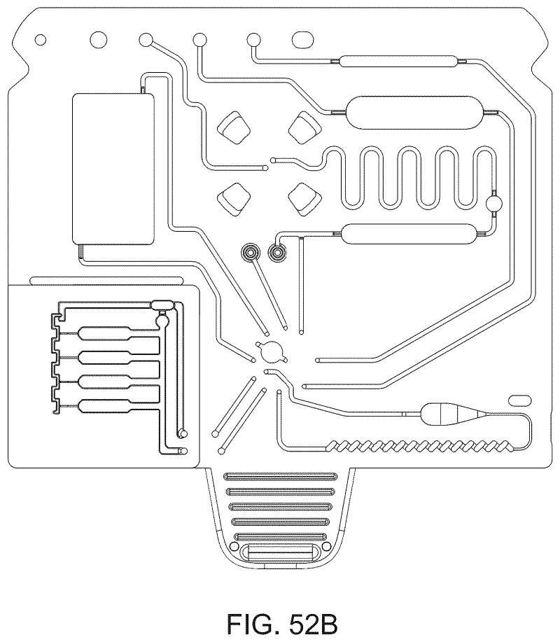

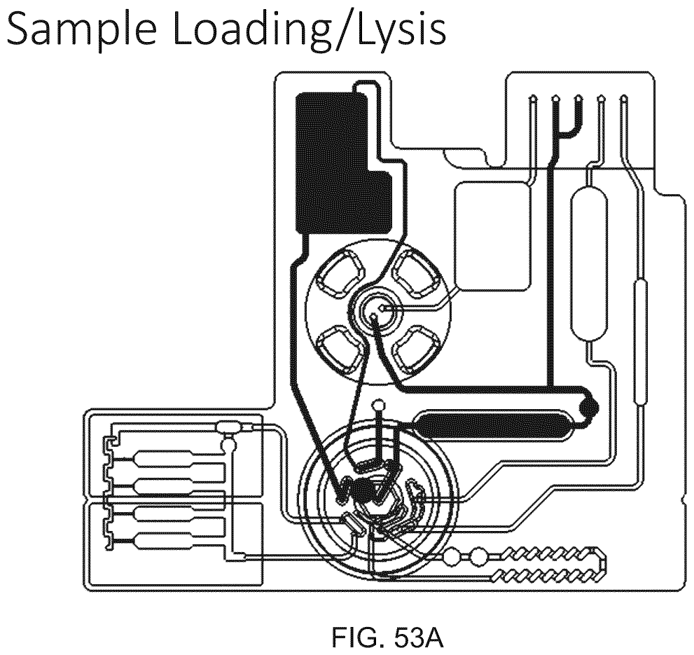

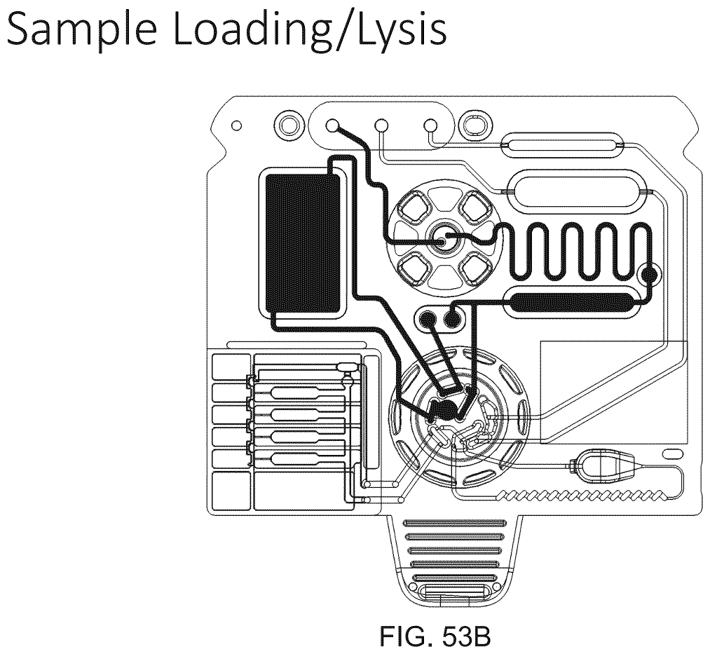

FIGS. 52A and 52B depict an alternate embodiment of a microfluidic cartridge.

The microfluidic cartridge embodiment depicted in FIG. 4 includes introduction element 2100 in fluid communication with port 2004c and lysis element 2208 via channels 2406, 2412. Lysis element 2208 includes reagent zone 2202, lysis chamber 2200, balls 2206. Lysis element 2208 is fluid communication with rotatable valve element 2306 positioned on the microfluidic cartridge 2001.

In FIG. 4 both introduction element 2100 and valve element 2306 are depicted in a transparent manner to allow visualization of the pathways, channels, etc. Rotatable valve element 2306 is in fluid communication with multiple elements including reagent zone 2528 proximate microchannel 2500, PCR element 2600 at both inlet 2510 and outlet 2512, extraction chamber 2508, wash solution reservoir 2404, elution solution reservoir 2402, and waste reservoir 2700.

As shown in FIG. 4, wash solution reservoir 2404 and elution solution reservoir 2402 are in fluid communication with ports 2004a, 2004b. As described herein, ports may be used to drive fluids toward and/or away from the valve element 2306. For example, port 2004c is connected to introduction element 2100 by channel 2406. Pressure, both positive and negative, applied at port 2004a may be used to control fluid flow through channels 2406, 2412, introduction element 2100, and lysis element 2208. Pressure applied at the port to drive fluids through the microfluidic cartridge may be less than about 15 psi. In some embodiments, pressure applied at the port to drive fluids may be less than about 12 psi. In a particular use, fluid pressure applied at a port will be equal to less than about 2 psi.

FIG. 4 depicts a bottom view of an embodiment of a microfluidic cartridge. This embodiment includes vent ports 2316 positioned proximate valve 2300. Vent ports may be placed in fluid communication with the valve and/or other elements when the valve is placed in a predetermined position. Depending on the amount of sample fluid present in a selected channel, excess fluid can be released when the valve is in a predetermined position allowing flow between the vent port 2316 and the valve.

In some embodiments, storage elements may include materials including but not limited to desiccated and/or lyophilized materials such as lysis buffers, elution buffers, wash buffers, collection buffers, etc., reagents such as mastermix reagents for, e.g., PCR, sequencing (e.g., Sanger or NGS), hybridization, or other detection or sample preparation method as described herein, polymerase, buffer, salt, nucleotides, primers, probes, enhancers, stabilizers, and nuclease-free water, control reagents such as standards, negative controls, positive controls such as a nucleic acid having a known sequence, carrier RNA (cRNA), and/or a polyA cRNA and/or combinations thereof.

In a particular embodiment, storage elements may include a volume of master mix. The master mix may be desiccated or lyophilized. In some embodiments, an amount master mix deposited in the storage elements may be determined based on a number of analyses to be performed, type and number of targets, and/or the type of analyses. A volume of master mix used in a microfluidic cartridge may be in a range from about 18 to about 33 microliters. In a particular embodiment, a volume of master mix used in a microfluidic cartridge may be in a range from about 23 to about 28 microliters. For example, a total volume of master mix deposited in the may be about 26 microliters. As shown in FIGS. 3-4, master mix may be deposited in multiple locations such as the mixing chamber 2504 depicted.

The device used to analyze samples in the microfluidic cartridges may include multiple modules for performing processes, for example, sample extraction, metered loading of a pre-determined sample volume into an analytical system, sample lysis, extraction of nucleic acids from the lysed sample, and detecting target nucleic acids in a microfluidic cartridge. In one embodiment, the present disclosure provides a microfluidic cartridge and system, subsystems, and methods for performing nucleic acid analysis, e.g., polymerase chain reactions in a microfluidic cartridge.

In some embodiments, two or more modules may be used in tandem. In some embodiments, the two or more module used in tandem are coupled to and controlled by a central processor. In some embodiments, two or more modules for nucleic acid analysis as disclosed herein may be used in tandem, In some embodiments, a module for nucleic acid analysis as disclosed herein may be used in tandem, simultaneously, or sequentially, with one or more other systems for analyzing nucleic acids or for analyzing polypeptides, peptides, and/or post-translational modifications of peptides, such as an automated lateral flow immunoassay system, or another lab-on-a-chip system.

The system may be used to analyze samples using methods including but not limited to sample extraction, metered loading of a sample volume into an analytical system, sample lysis, extraction of nucleic acids from the lysed sample, and detecting target analytes, e.g., nucleic acids, polypeptides or peptides, and/or post-translational modifications of polypeptides or peptides, such as phosphorylation or glycosylation.

Device may include multiple modules or subsystems for performing, e.g., sample extraction, metered loading of a pre-determined sample volume into an analytical system, sample lysis, extraction of nucleic acids from the lysed sample, and detecting target nucleic acids in a microfluidic cartridge. In one embodiment, the present disclosure provides a microfluidic cartridge and system, subsystems, and methods for performing nucleic acid analysis, e.g., polymerase chain reactions in a microfluidic cartridge.

FIG. 35B depicts a top perspective view of a system 1000 for analyzing biological samples that includes cartridge 2000 and device 3000. A biological sample may be placed in the microfluidic cartridge as shown in FIG. 3 prior to loading the microfluidic cartridge into the device. The sample to be loaded may include targets of interest. In some embodiments, the sample to be tested may undergo pre-treatment prior to deposition of a portion of the sample into the microfluidic cartridge. For example, lysis solution may be added to the sample in some embodiments. Lysis solution is, in some embodiments present in a sample collection tube into which the sample is placed. In other embodiments, lysis solution is added to the sample collection tube after the sample is placed in the sample collection tube. After combining the sample with the lysis solution, a portion of the biological sample may be transferred from a collection element (e.g., collection tube such as a dropper, pipette, or automated sample transfer system) to the microfluidic cartridge using the introduction element on the microfluidic cartridge. For example, as shown in FIG. 3 a portion of a sample is introduced to cartridge at cup 2108 of introduction element 2100. The introduced sample may have a volume of 100, 150, 200, 250, 300, 350, 400, 450, or 500 microliters, or have a volume in a range from about 150 to about 1000 microliters, from about 150 to about 500 microliters, from about 200 to about 500 microliters, from about 200 to about 300 microliters, or any volume between any of the forementioned volumes or the aforementioned volume ranges. In some embodiments, an introduced sample may have a volume of about 250 microliters. In some embodiments, a predetermined volume of the introduced sample may vary based on the type of analysis, target molecules, geometry of the microfluidic cartridge, and/or volume of the pi dropper used to dispense the sample into the sample introduction cup. For example, a single use dropper may be used to directly deposit the sample into introduction element. In some embodiments, the dropper may be an exact volume single use eyedropper.

After introduction of the sample, the cap 2318 of the introduction element is closed. The cap may be secured in place using one or more of an interlocking, and/or interference fit (e.g., friction fit).

Cartridge 2000 is placed in the device 3000 at portal 3010. In some embodiments, the microfluidic cartridge may be positioned in a bracket (not shown). A motor (not shown) may move the microfluidic cartridge into the device. In some embodiments, the motor may be on a cantilever. In some embodiments, pneumatics may be used to position and/or move the microfluidic cartridge within the device.

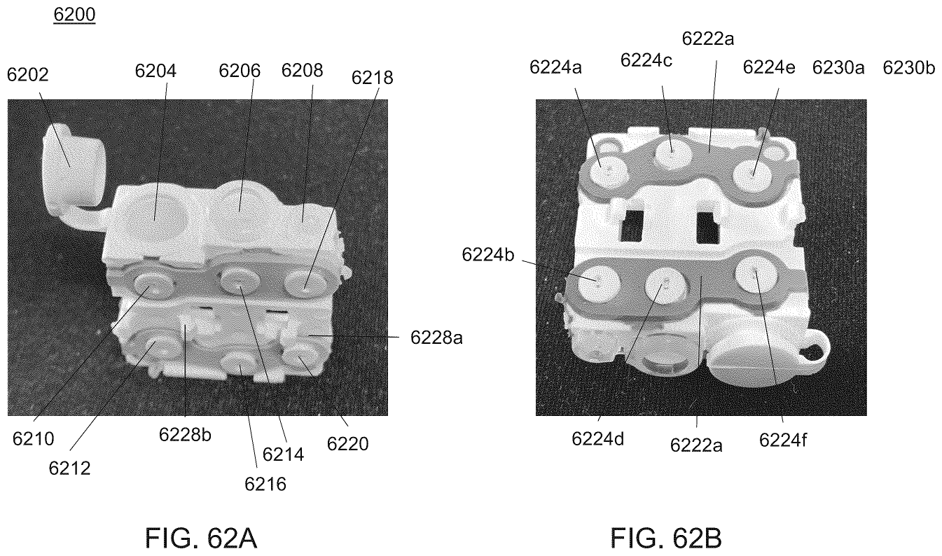

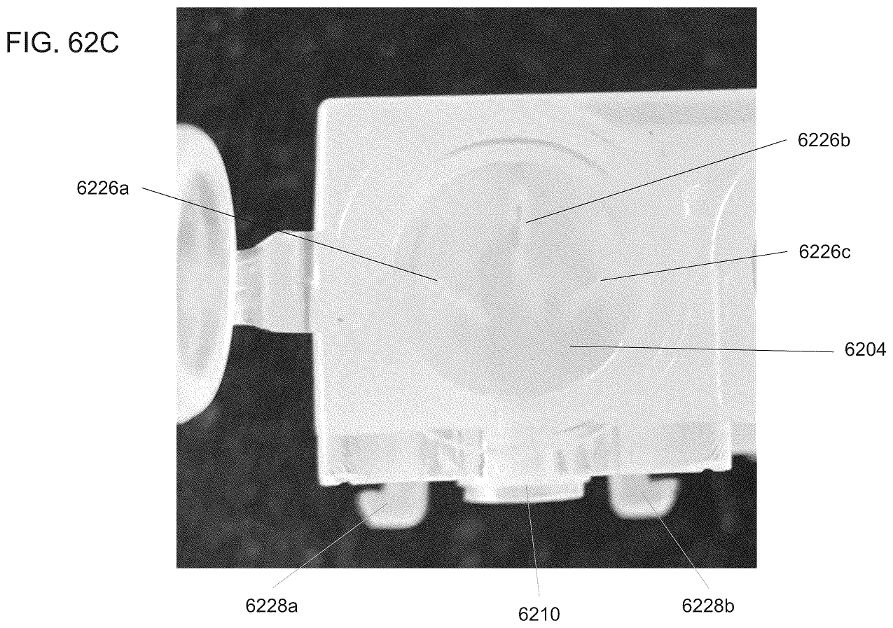

In some embodiments, the sample introduction is performed on a separate sample input cartridge 6200. As shown in FIG. 62A-C, a sample swab (not shown) comprising a sample can be inserted into a sample input chamber 6204. The swab can be rotated against the inner wall of said sample input chamber against one or a plurality of vertically extended blades 6226a, 6226b, and 6226c, which extend inward from the inner wall to increase the amount of sample released from the sample swab. The swab is removed and a resealable cap 6202 is then used to seal said sample input chamber 6204. The sample input cartridge 6200 can further comprise separate chambers containing different fluids, for example a wash solution chamber 6206 can comprise a wash buffer solution, and a elution solution chamber 6208 can comprise an elution buffer solution. The wash solution chamber 6206 and the elution solution chamber 6208 can be sealed with a rubber seal to enclose the respective chambers from external environment and maintain pressure within the chambers when pressure is applied through wash fluid chamber entrance port 6214 and elution fluid chamber entrance port 6218. The respective solutions exit the respective chambers through the wash fluid chamber exit port 6216 and the elution fluid chamber exit port 6220. The entrance ports are fluidically connected with an external pressure source as described herein through a microfluidic channel.

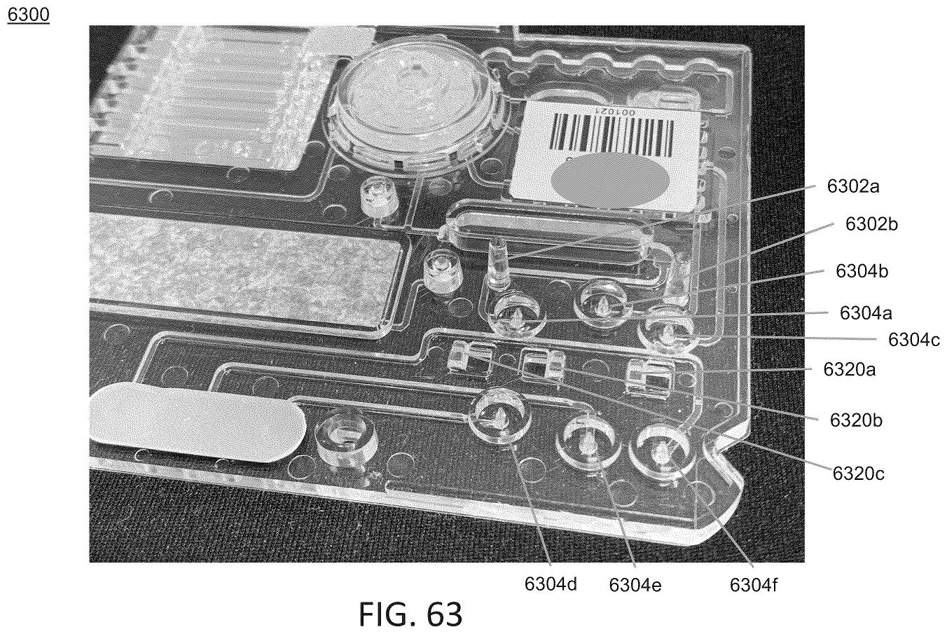

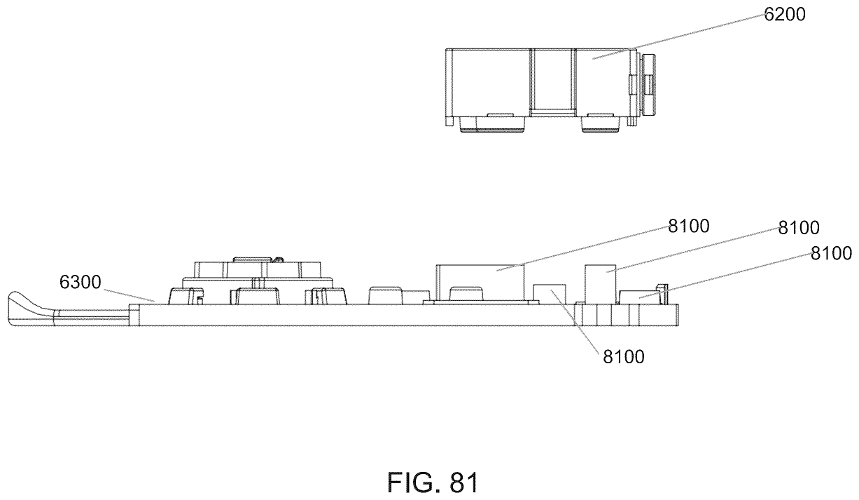

The sample input cartridge can comprise one or more alignment holes 6230a, 6230b, which align the sample input cartridge 6200 with the microfluidic cartridge alignment posts 6302a, 6302b. The sample input cartridge 6200 is mated to the microfluidic cartridge 6300, as shown in FIG. 63, the alignment posts 6302a and 6302b insert into the alignment holes 6230a and 6230b. The sample input cartridge 6200 can further comprise one or more binding clips 6228a, 6228b, extending from the surface of the sample input cartridge 6200 which interfaces with the microfluidic cartridge 6300. The one or more binding clips 6228a, 6228b for a pressure fit with one or more receiving clips 6320a, 6320b, and 6320c on the microfluidic cartridge 6300 to further enforce the integrity and seal of the mating of the sample input cartridge 6200 and microfluidic cartridge 6300. In some embodiments, the microfluidic cartridge 6300 can comprise receiving and alignment walls 8100 (see, e.g., FIG. 81) which are configured to align one or more sides of the sample input cartridge with the microfluidic cartridge 6300, and which may comprise a cage.

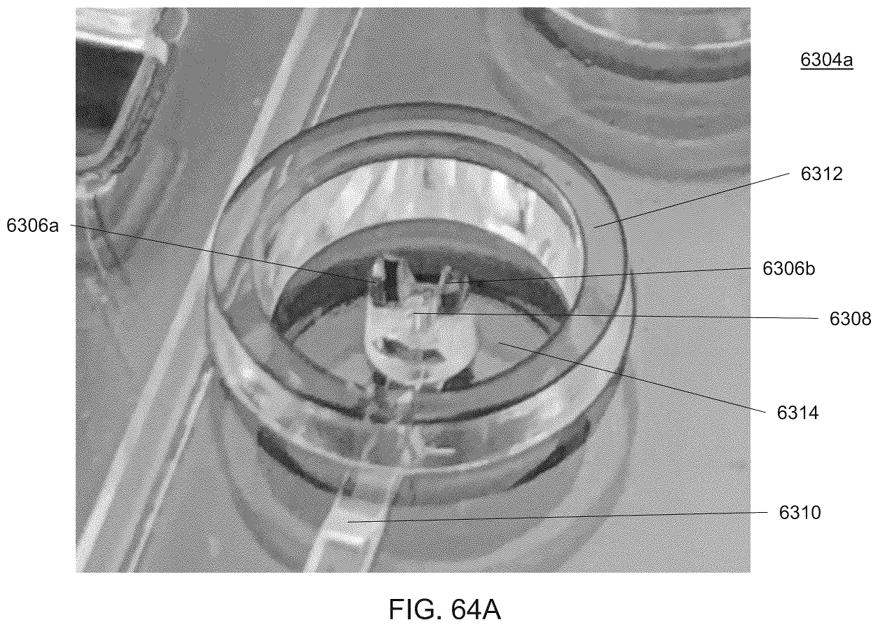

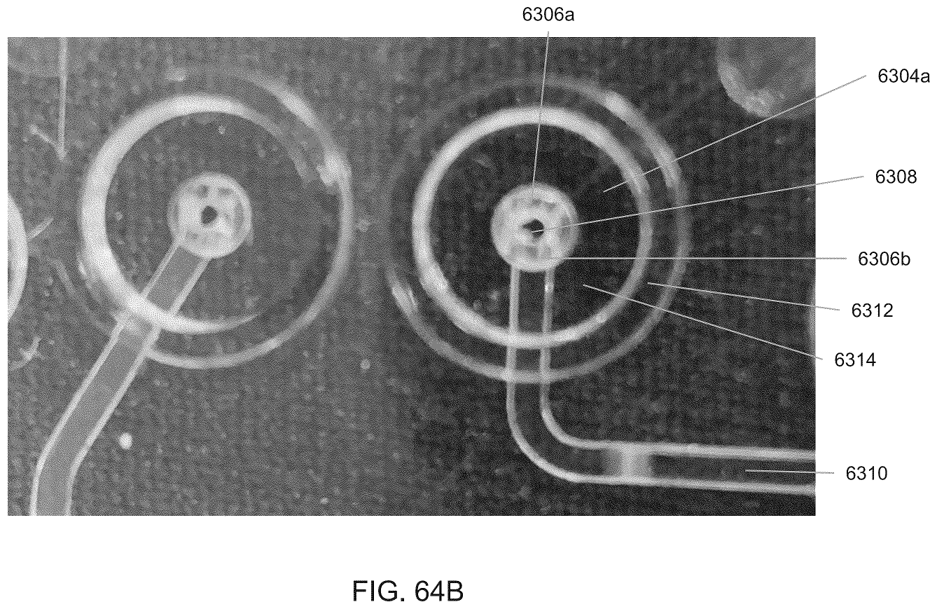

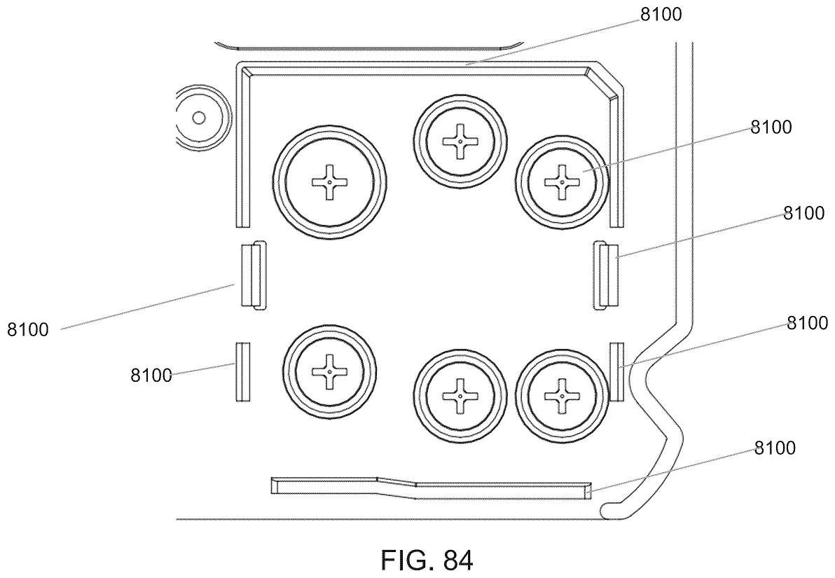

The sample input cartridge can comprise one or more gaskets 6222a and 6222b which increase the integrity of the seal of the entrance ports and exit ports of each of the sample chamber, wash fluid chamber, and elution fluid chambers. In some embodiments, the gasket is a single piece which covers multiple ports. In some embodiments, the gasket is an overmold which separate surrounds each of the ports. In some embodiments, the entrance ports and exit ports of each of the sample chamber, wash fluid chamber, and elution fluid chambers are initially covered with a pierceable seal. The pierceable seal can be a thin film thermally bonded to the ports. The pierceable seal can be pierced by the pricking post system 6304a, 6304b, 6304c, 6304d, 6304c, and 6304f which are aspects of the embodiment of a microfluidic cartridge 6300 upon mating the sample input cartridge with the microfluidic cartridge. FIG. 64A and FIG. 64B shows some embodiments of a pricking post system. The pricking post systems 6304a, 6304b, 6304c, 6304d, 6304c, and 6304f each independently comprise two or more piercer elements 6306a, 6306b, an opening 6308 which is fluidically connected to a microfluidic channel 6310. The piercer elements pierce the pierceable seals 6224a,b,c,d,e,f, on the sample input cartridge 6200. The piercer elements further comprise a collection surface 6314 and a round enclosure wall 6312, wherein fluid exiting the sample collection cartridge 6200 through an exit port will pass through the opening 6308 and may be collected within the round enclosure wall 6312 before entering the microfluidic channel 6310. In some embodiments, the collection surface 6314 can be flat or conically angled downward along the direction of gravity so that any collected fluid will enter the microfluidic channel assisted by gravitational force. In some embodiments, the piercer elements can be continuous or discrete. When the piercer elements are continuous, the piercer elements can be shaped like a volcano, with a single hole the top. In some embodiments, the juncture of the collection surface and opening 6308 can comprise a plurality of sub-openings to allow for fluidic connection between any collected fluid contained within the round enclosure wall to flow through the opening 6308 into the microfluidic channel 6310. FIG. 84 shows an alternative embodiment of six piercer elements.

In the device, the microfluidic cartridge is transferred to a port engagement module (not shown). In some embodiments, the port engagement module may include a pneumatics, for example, pumps such as disc pumps (not shown). In some embodiments, as a microfluidic cartridge moves within the device in X-Y plane, it may activate a lever causes one or more pneumatic components to engage the microfluidic cartridge. For example, in a specific embodiment as a microfluidic cartridge moves in an X-Y plane, portions of the microfluidic cartridge may activate an angled lever which pushes a fulcrum on a separate member which causes a plurality of pneumatic components to engage with the microfluidic cartridge.

Pressure may be applied at the engagement module to a predetermined portion of the microfluidic cartridge. For example, a pneumatic element (not shown) may engage a port. In particular, the pneumatic element may push air into the sample delivery channel 2406 via port 2004C as shown in FIG. 4. This pressure may force a portion of the sample into channel 2412 toward lysis element 2208. In some embodiments, the pressure also may force a lysis buffer into the sample delivery cup 2108 which then pushes sample from the introduction element into the lysis chamber. In some embodiments, the rotatable valve is turned to a predetermined position depending on where the fluid should be moved. For example, predetermined positions of the rotatable valve may direct fluid toward the lysis component and/or the waste reservoir. In some embodiments, the rotatable valve may be positioned such that fluid is inhibited and/or prevented from “sloshing around” the lysis chamber or another component prematurely. The backpressure can be measured to verify that the sample has been moved from the sample cup 2108 into the lysis chamber while the rotary valve is in the closed position and air is vented out the lysis vent port 2316. Upon fluid contacting the vent port 2316 the pressure increases and the instrument knows the chamber has been filled. A camera then inspects the chamber to ensure that the chamber has been 100% filled and that the user provided sufficient sample volume.

In some embodiments, cameras may be positioned in any location that provides a clear view of the lysis chamber. The purpose of the camera images of the lysis chamber is to confirm the complete filling of the lysis chamber with sample and lysis buffer. In some embodiments, a selected region of a top or bottom surface of the lysis chamber can be patterned with surface features such that when liquid reaches the patterned region, the refractive index will change which can be detected by a camera. In some embodiments, the bottom surface (the surface in which the microfluidic channels are etched or imprinted or embossed into) comprises the patterned region. The surface features can be selected from a finish (polish), hatching, lines, dots, grid, checkerboard pattern, or any other pattern which imparts a refractive index change when a liquid covers said pattern relative to when no liquid covers the pattern. In some embodiments, a camera transmits an image of the patterned region to a computer processor. The computer processor can analyze the image to determine whether the patterned region is contacted with a fluid. If the patterned region is not contacted by a fluid, the computer processor can transmit an alert signal to an operator that an insufficient volume of sample and/or lysis buffer was inserted into the microfluidic cartridge. In some embodiments, a light source emits light to the patterned region while the camera images said region. In some embodiments the light source is a light bulb. In some embodiments, the light source is a LED light source of any wavelength detectable by the camera, or a combination of wavelengths.

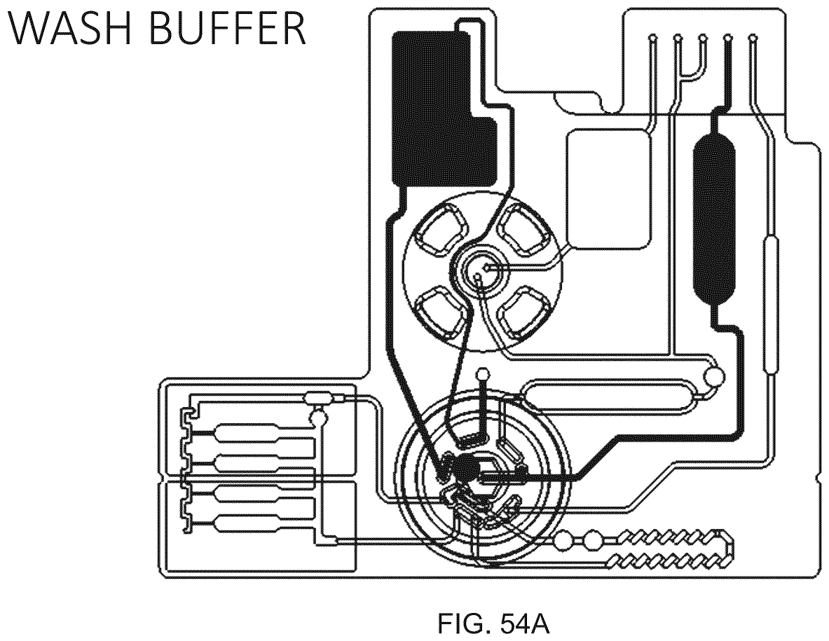

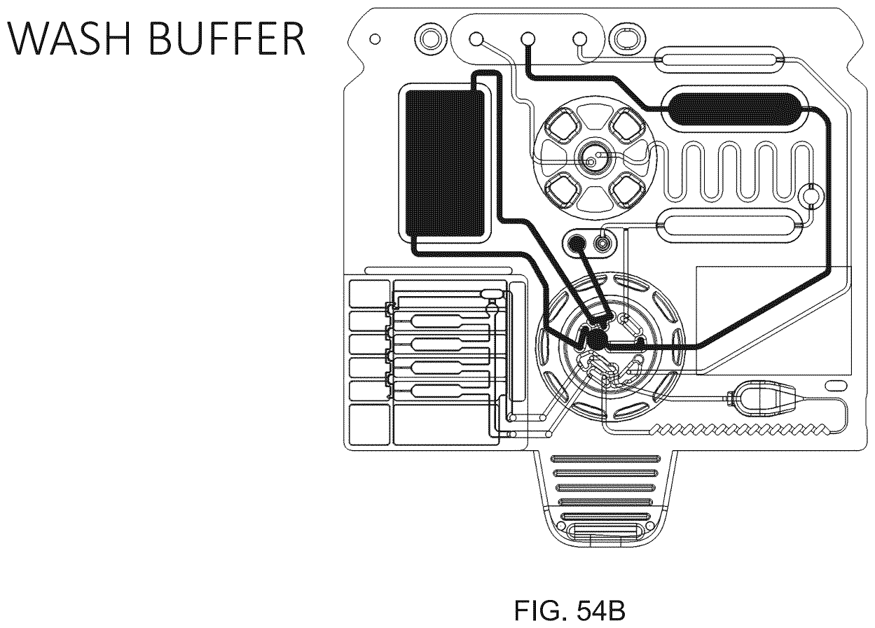

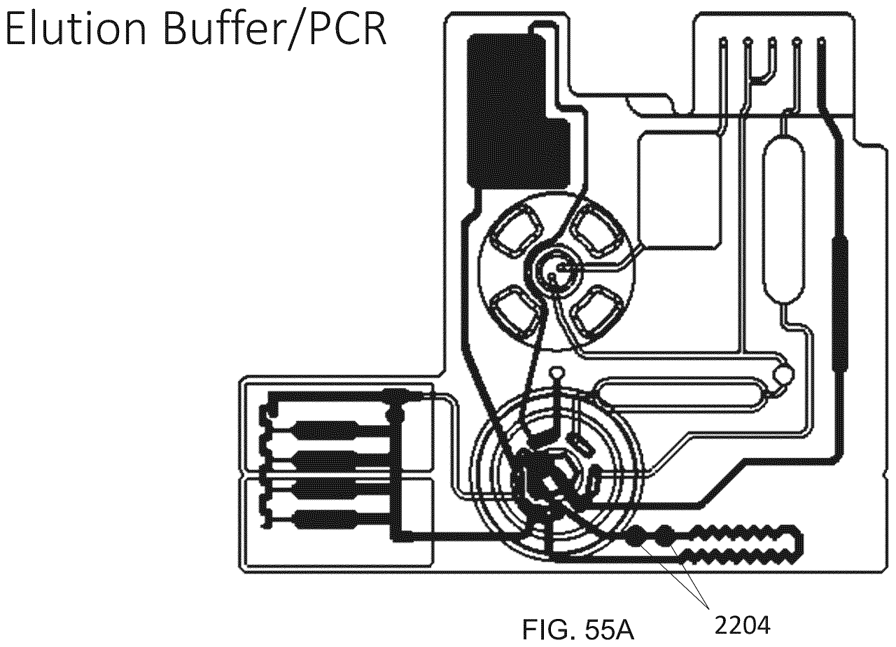

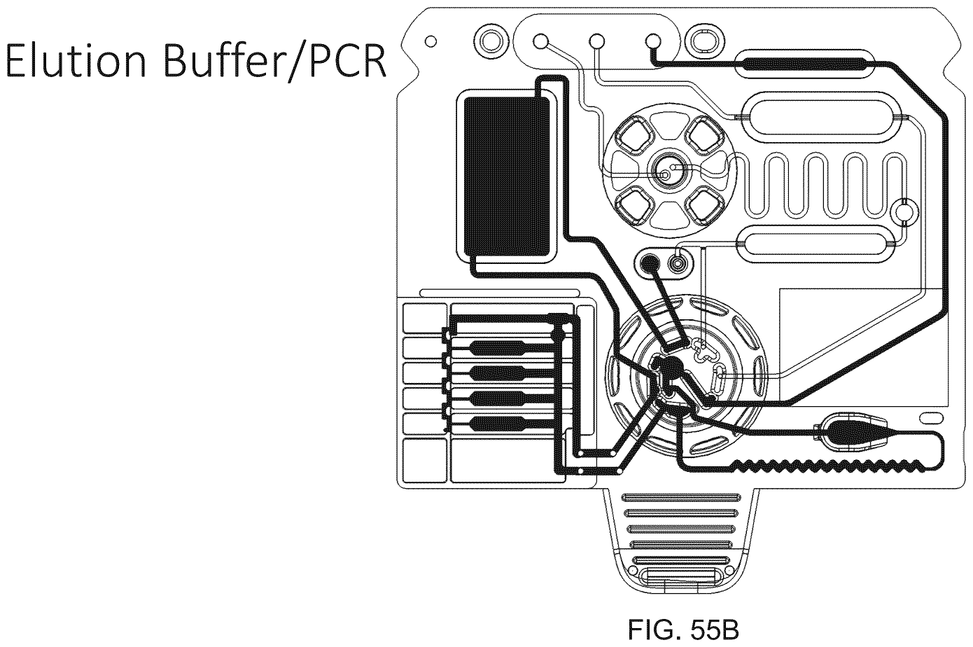

After the sample fluid is in place, the valve on the microfluidic cartridge may be rotated into a predetermined position that ensures that the sample stays in the lysis component. The device moves the microfluidic cartridge into position proximate a lysis module 3200 as shown in FIGS. 54, 55, 56.

Lysing biological materials may be necessary to conduct certain analyses on samples. A lysis module for biological materials can include a lysing chamber and one or more magnetizeable balls. Magnetizeable balls can include, but are not limited to balls having magnetic properties, metal balls, balls made of alloys such as stainless steel balls, ball bearings, and the like. In some embodiments, magnetizeable balls may be coated or uncoated ball bearings based on the requirements of use. For example, magnetizeable balls may be ball bearings plated with 410 chrome.

Magnetizeable balls may have a diameter in a range from about 0.01 inches to 0.50 inches (0.254 mm to 12.7 mm). Magnetizeable balls may have a diameter in a range from about 0.03125 inches to 0.125 inches (0.79 mm to 3.18 mm). In some embodiments, magnetizeable balls may have a diameter of about 0.9 inches (i.e., 22.9 mm). In an embodiment of a lysing module, magnetizeable balls within the lysing chamber may be all the same size. In some instances, magnetizeable balls used in the lysing module may be uncoated ball bearings of a uniform size.

Conditions in the lysing chamber may be controlled to influence the length of time needed to complete lysis of the biologic material. In some instances, lysis may be performed for 90, 85, 80, 75, 70, 65, 60, 55, 50, 45, 40, 35, 30, 25, 20, 15, 10, 5, 4, 3, or 2 seconds, or any time between any of the aforementioned time periods. In some instances, conditions in the lysis module may be controlled such that the biological constituents in the sample lyse in 90, 85, 80, 75, 70, 65, 60, 55, 50, or 45 seconds or less. In some instances, conditions in the lysis module may be controlled such that the biological constituents in the sample lyse in 60 seconds. In some instances, conditions in the lysis module may be controlled such that the biological constituents in the sample lyse in 60 seconds or less. In particular, conditions that can be controlled include the speed of the rotatable members, the amount of fluid in the chamber, the concentration of sample in fluid in the chamber, the path of the rotatable member, the number, size and/or composition of magnetizeable balls, etc.

Use of a lysis module in a device and a lysis component in a microfluidic cartridge may reduce time needed for lysis to be completed. For example, lysis utilizing a lysis module and lysis component may be complete in less than about 60 seconds. For example, samples such as targets such as RNA, DNA, candida (yeast) in less than 60 seconds-including respiratory and saliva samples. In some embodiments, the lysis can be completed in 60 seconds or less regardless of the target-RNA, DNA, protozoa, bacteria, fungus, virus or other pathogen. The inventors have recognized that the mechanical lysis method described herein degrades co-factors and PCR inhibitors present in saliva or nasal samples. While mechanical lysis is known to cleave nucleic acids, the inventors have recognized that the size of the cleaved nucleic acids (which can include or exclude DNA or RNA) is about 200 bp (basepairs, also referred to as “nucleotides” or “nt”) or less. The PCR methods described herein are designed to target the 200 bp or less cleaved nucleic acids, such that nucleic acid cleavage introduced by the mechanical lysis is a suitable PCR target. In addition, the inventors have discovered that under the lysis conditions described herein, minimal cleavage of nucleic acids below 200 bp is observed.

The lysis chamber comprises magnetizeable beads which are in magnetic communication with helicopter blades (also referred to herein as magnet rotors). The helicopter blades are positioned so that the beads move from end to end of the lysis chamber. The helicopter blades comprise magnets within the blades, and further comprise a position sensor such that the location of the blades can be detected. In some embodiments, the helicopter blades are configured to be detected by an optical switch to confirm the position of the helicopter blades at a selected position.

In some embodiments, the magnetizeable beads traverse the length of the lysis chamber about two lengths of the chamber for every rotation of a helicopter rotation. The resulting variation in the magnetic fields moves the magnetizeable balls within the lysis chamber. Generally, the magnetizeable balls move in a linear movement from a first wall to a second wall of the chamber that corresponds to a value in a range from about 100 to about 3200 strokes per minute. In some embodiments, the linear movement of the magnetizeable balls may be in a range from about 325 to about 2350 strokes per minute. In particular, an embodiment may include using the lysis module to move the magnetizeable balls at a rate of in a range between about 750 and 2000 strokes per minute. In some embodiments, the magnetizeable balls may be move within the lysing chamber at a rate of 1500 strokes per minute.

Various methods may be used to move the magnetizeable balls 2206 within the lysing chamber 2200. In some embodiments, the magnetizeable balls 2206 are magnetic. Subjecting magnetic magnetizeable balls 2206 to a variable magnetic field may move the magnetizeable balls 2206 in the lysis chamber 2206. In some embodiments, during use movement of the at least two rotatable members having magnetics on each end of the rotatable members causes variable magnetic fields. For example, a rotating member may have magnets at both of its ends. In particular, a magnet positioned on a first end of a rotating member may has a polarity opposite that of a magnet positioned on a second end of the rotating member.

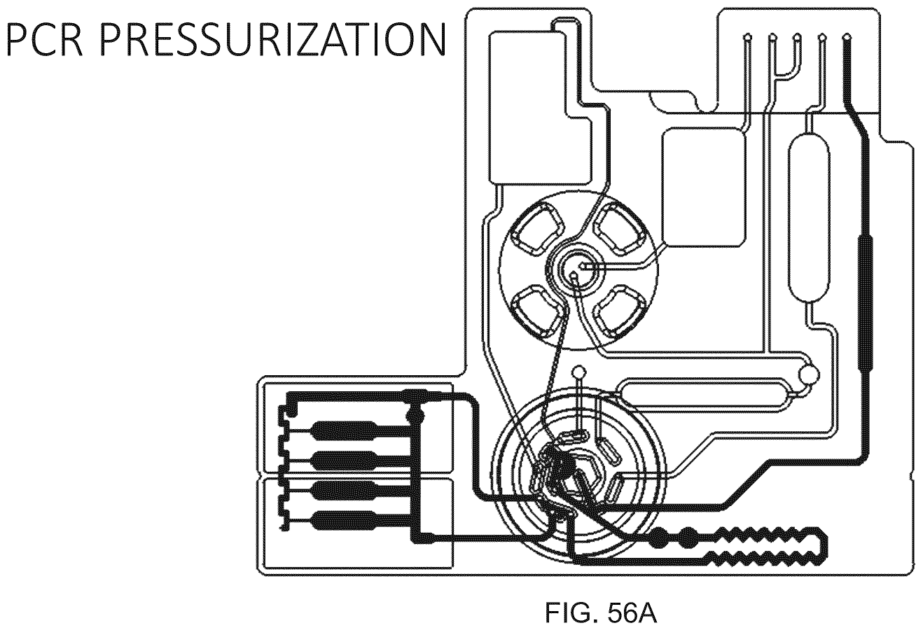

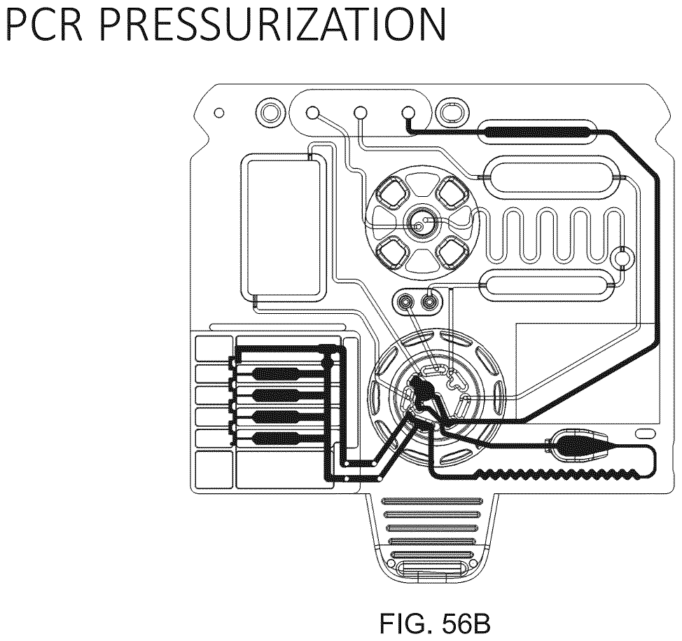

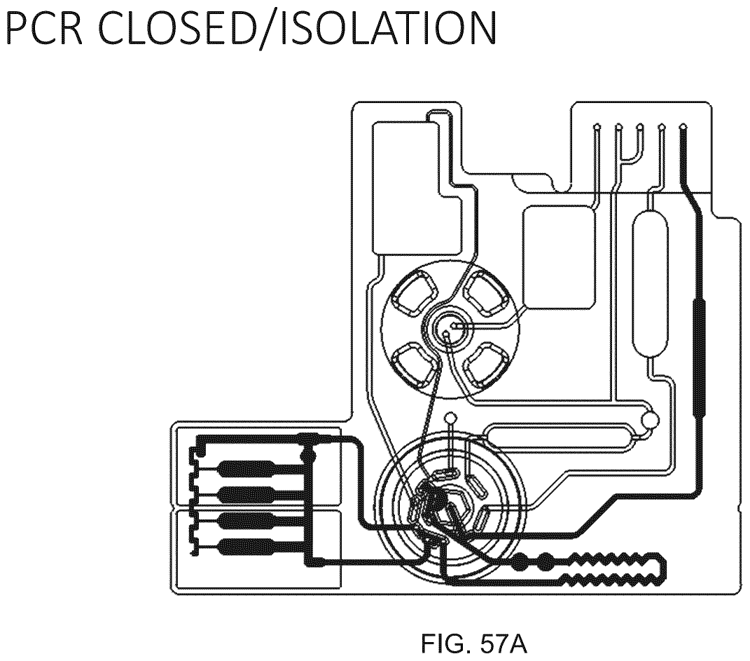

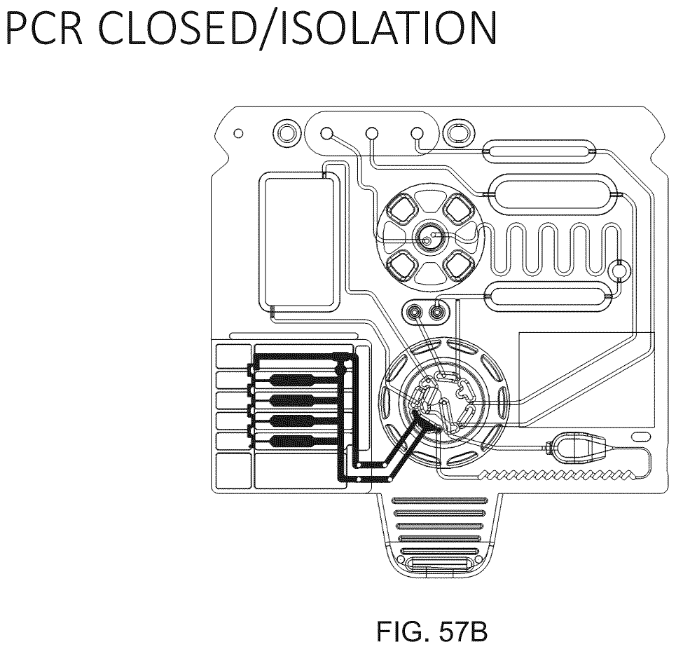

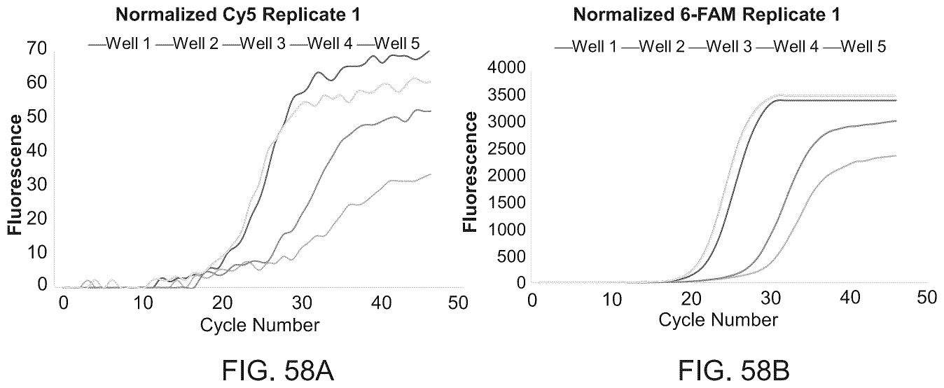

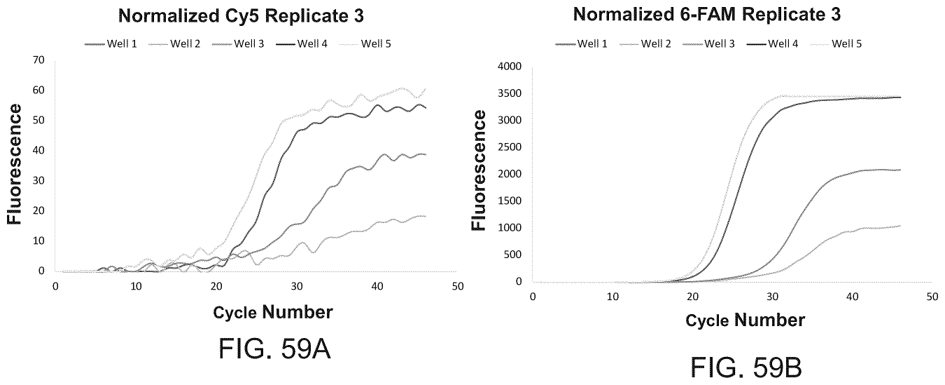

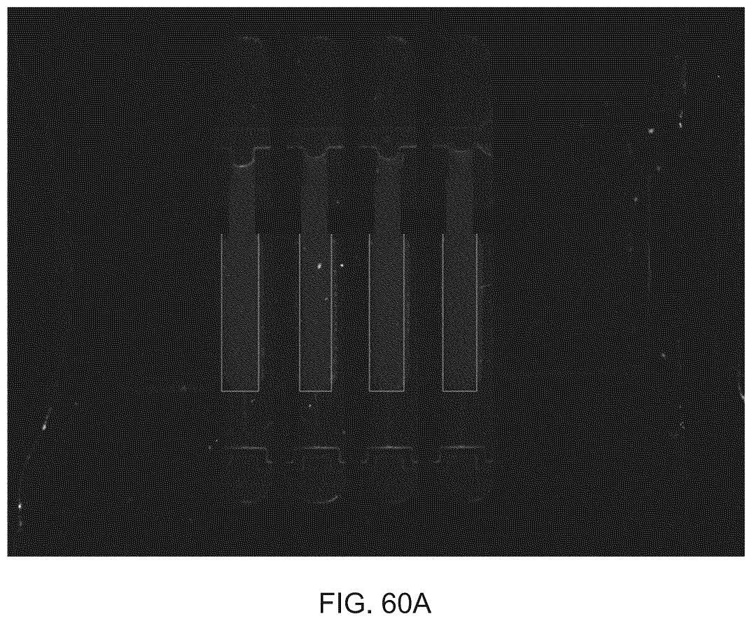

The lysis module 3200 includes rotating members 3202 coupled together using a band 3204 as shown in FIGS. 56-57. The rotating members may be magnetic. In some embodiments, the entire rotating member may be a magnet. Alternatively, a portion of the rotating member may have magnetic properties. For example, rotatable members may include magnets on both ends. In an embodiment, two separate rotatable members may be positioned proximate a lysing chamber. Each of the separate rotatable members may have magnets at each end.

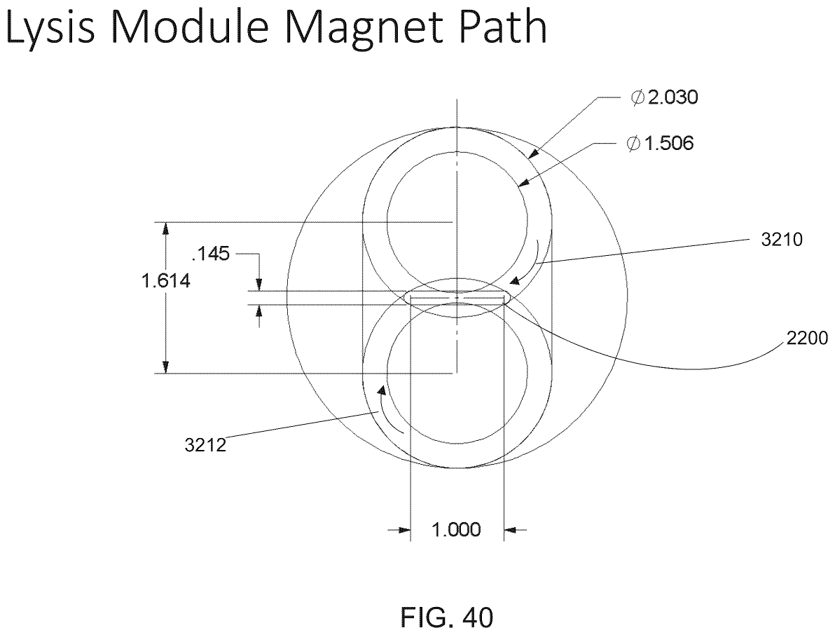

The band may be used to move the rotating members during use. As shown in FIG. 38, rotating members 3202 may positioned relative to the band 3204 such that when the band turns so do the rotating members 3202. Rotating members may be positioned proximate each other. For example, when the band and rotating members rotate, the rotating members may traverse the same area at least in part. As shown in FIG. 38, the rotational positions of the rotating members 3202 are offset to allow them to rotate without contact. Rotating member 3202 as shown in FIG. 37 includes a magnetic element 3208. Based on the orientation of the rotating members and the band depicted in FIG. 38, the rotating members 3202 appear to move in opposite directions relative to the lysis chamber 2200 as shown in FIG. 40. This results in a changing magnetic field at the lysis chamber.

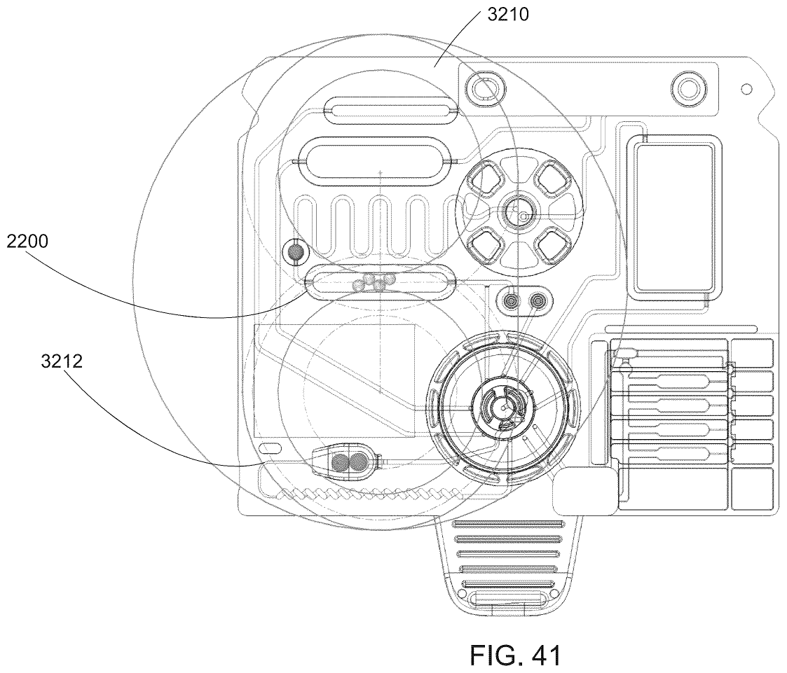

Due the action of the band 3204 (shown in FIGS. 37, 38) and the positioning of the rotating members the paths 3206 of the magnetic rotating members 3202 relative to a lysis chamber 2200 are shown in FIGS. 40-41. As shown in FIG. 40, positioning of the lysis element 2208 relative to the rotating members creates a changing magnetic field proximate the lysis chamber 2200 and in the paths 3210, 3212 of the rotating members. Movement of the rotatable members in the configuration described results in the rotatable members appearing to move in opposite directions at the lysis chamber 2200.

In some instances, the two rotatable members may rotate in the same direction such that they do not contact each other. This may be achieved using a different orientation of the rotatable members and/or the band. Further, in some embodiments, the rotating members may be controlled separately from each other using another mechanism. For example, separate motors may drive each of the rotatable members in some embodiments.

Movement of the magnetizeable balls may be controlled using rotatable members positioned proximate the lysing chamber. During use the rotatable members rotate in a plane proximate the lysing chamber. For example, the rotatable members may be positioned above the lysing chamber and rotate in a plane above the lysis chamber.

In some embodiments, the rotatable members are substantially parallel to a surface of the lysing chamber. The movement of the rotatable members and polarity of the magnets positioned on the rotatable members may cause the magnetizeable balls to move back and forth in the lysing chamber during use. In some instances, the magnetizeable balls move within the lysing chamber from one end of the chamber to the other. In alternate embodiments, the movement of the rotatable members may be controlled to limit the movement in the lysis chamber to a predetermined path.

For example, as shown in FIG. 40 paths 3210, 3212 of the rotatable members 3202 appear to overlap at the lysis chamber 2200. Even though the rotatable members may be positioned such that they move in opposite directions over the lysis chamber. The movements of the rotatable members may be time to inhibit and/or avoid the two rotatable members being positioned over the lysis chamber at the same time.

Due to the movement of the rotatable members the magnetic field at the lysis chamber 2200 changes with each pass of a rotatable member which drives the magnetizeable balls to move from a first end 2200a of the chamber to a second end 2200b of the chamber 2200, thereby creating a stroke. The speed at which the band and rotating members are rotating may be controlled using a stepper motor and/or gear reduction. In some embodiments, a speed of the rotating members may be controlled to control the stroke rate and/or the degree of lysis achieved in the sample.

In some embodiments, the rate of the lysing ball movements may be predetermined based on the target of interest, the analysis to be conducted, the pretreatment, and/or constraints of the system. For example, based on a number of these factors it may be determined that the magnetizeable balls should move within the lysing chamber at a rate of 1000, 1050, 1100, 1150, 1200, 1250, 1300, 1350, 1400, 1450, 1500, 1550, 1600, 1650, 1700, 1750, 1800, 1850, 1900, 1950, or 2000 strokes per minute, or any rate between any two of the recited rates.

Lysis of a sample may result in constituents in the lysate having a size in a range from about 100 to about 1000 base pairs. In some embodiments, the conditions in the lysis chamber and/or the rotating members may be controlled such that lysis of a sample results in constituents in the lysate having a size in a range from about 180 to about 300 base pairs. For example, lysis may be controlled (i.e., the speed and/or length of time) in manner that favors target particles of a particle length.

In some embodiments, PCR interfering substances may be separated or eliminated from the sample by the movement of the one or more magnetizeable balls. For example, lysis may be controlled (i.e., the speed and/or length of time) in manner that reduces and/or eliminates PCR interfering substances.

In some embodiments in the device, the lysis module may be positionable within the device relative to a lysis chamber. This may allow for adjustment of the magnetic field used to move the magnetizeable balls in the lysis chamber. In some embodiments, the position of the magnetizeable balls can be controlled by the controlled position of the magnetic helicopter rotors. The position of the magnetizeable balls can be selected to be in the middle of the lysis chamber to minimize backpressure when moving the lysed sample to the extraction chamber.

After lysis is complete the device may move provide pneumatic pressure to a portion of the microfluidic cartridge to drive the lysed solution from the lysis chamber into the extraction chamber. In some embodiments, the extraction chamber may include a reversible binding membrane, for example, a porous silica membrane to which extracted DNA binds. The rotatable valve may be moved by the device to allow any excess lysis solution to go to the waste reservoir.

A pneumatic element in the device may drive a wash solution across the porous silica membrane in the extraction chamber and any then into the waste reservoir. This action may reduce an amount of non-DNA present by washing away non-DNA in the extraction chamber. The rotatable valve may then be switched to divert any future liquid streams into the mixing chamber.

An elution solution may be pushed within cartridge by action of a pneumatic element at a port. In particular, as shown in FIG. 4, a pneumatic element (not shown) of the device acts on a microfluidic cartridge 2000 at port 2004A causing elution solution to flow from elution reservoir 2402 to extraction chamber 2508. The elution solutions may cause a target (e.g., a nucleic acid chain, RNA, DNA) to stop binding to the silica membrane. The released targets may be driven from the extraction chamber into the mixing chamber. The solution leaving the extraction chamber includes targets (e.g., a nucleic acid chain, RNA, DNA) eluted from the silica membrane. In some embodiments, the silica membrane is round and configured to conform to the edge of the extraction chamber. The diameter of the silica membrane can be from 1.5 mm to about 8 mm. In some embodiments, the diameter of the silica membrane can be about 4 mm.

The pneumatic elements described above with respect to the device may be separate elements, a single element capable of engaging the microfluidic cartridge at different locations, and/or a combination of both. In some embodiments, pneumatic elements may have differing connections capable of interacting with the microfluidic cartridge in different manners. For example, a particular embodiment may include multiple, different disc pumps.

In some embodiments, one or more pneumatic elements may be used to generate pressure differentials in a portion of the microfluidic cartridge. For example, one or more disc pumps and/or piezoelectric micropumps may be used to generate positive and negative pressure at elements that couple to a portion of the microfluidic cartridge. This may allow for reciprocal mixing by switching pneumatic elements and/or solenoid valve on and off. In some embodiments, solenoids can be used with a valve to selectively apply pressure to each of the separate microfluidic channels within the microfluidic cartridge.

A pneumatic element may also be used to drive the mixed fluid into the PCR chambers. As the chambers fill up, beginning with the first chamber, and the solution enters each chamber. Fluid flow may be controlled in part by the geometry of the chambers. For example, flow into a particular chamber may slow down or stop when the fluid reaches the far end of that chamber where the chamber tapers to a very narrow outlet. In some embodiments, a port may be provided proximate a far end of the PCR chamber. These ports may allow for gas to exit the PCR element. For example, these ports may reduce pressure build up, that is reduce and/or prevent backpressure.

Surface tension confines fluid within the PCR chamber. PCR chambers may have a large inlet and a smaller outlet. In alternate embodiments, the depths and/or heights of the inlet and/or outlet may change. For example, in some embodiments a change in the depth or relative height of an inlet to an outlet may increase turbulence of the fluid and/or mixing.

PCR chambers may include desiccated and/or lyophilized reagents based on the needs of the analysis and/or the identity of the target. In some embodiments, PCR chambers may be designated for analysis of a particular target such as predetermined genetic material such as nucleic acid strands, molecules, biomarkers, and/or genetic loci. For example, PCR chambers may be designated for the analysis of Covid, Influenza, Strain1 of Covid (e.g., Delta variant), and/or a different Covid strain (e.g., Omnicron variant), or any other infectious disease. In some embodiments, the infectious disease can include or exclude: HIV, Herpes Simple Virus (Genital Herpes (HSV-1, HSV-2)), Trichomonas Vaginalis, Trichomoniasis, Parainfluenza, Respiratory syncytial virus (RSV), Human metapneumovirus (hMPV), Syphilis, norovirus, rotavirus, astrovirus, coronavirus, enterovirus (including enterovirus serotype coxsackievirus A16, also referred to as hand-foot disease), Borrelia burgdorferi (Lyme disease), Borrelia mayonii (rare cause of Lyme disease), Mycoplamsa genitalium, Human Papillomavirus (HPV), Neisseria meningitides, Bordetella pertussis, Gonorrhea, Chlamydia trachomatis bacterium, Chlamydia trachomatis, Neisseria gonorrhoea, Leptospira, Rabies virus (RABV), Zika virus, west nile virus, poliovirus, Cytomegalovirus (CMV), Middle East Respiratory Syndrome Coronavirus, Orthopox (monkeypox), arbovirus of the flavivirus genus (yellow fever), Highly pathogenic avian influenza (HPAI) A (H5N1) virus, Salmonella, and Exanthematous virae (which can include or exclude: varicella-zoster virus (chickenpox), rubeola (measles), human herpesvirus (HHV) type 6 (roseola), and mpox virus). Thus, in each PCR chambers PCR primers specific for a particular target (e.g., molecule, biomarker, and/or genetic locus).

When the all of the PCR chambers are filled, the rotatable valve is then switched to an off position, that is, no additional material flows to the chambers. In some instances, a portion of the microfluidic cartridge may be pressurized.

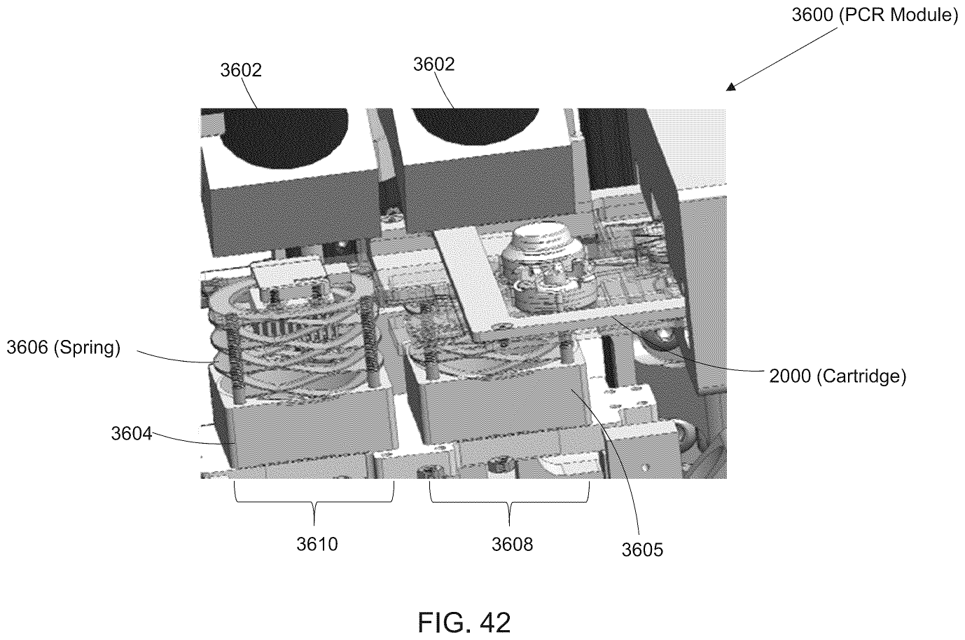

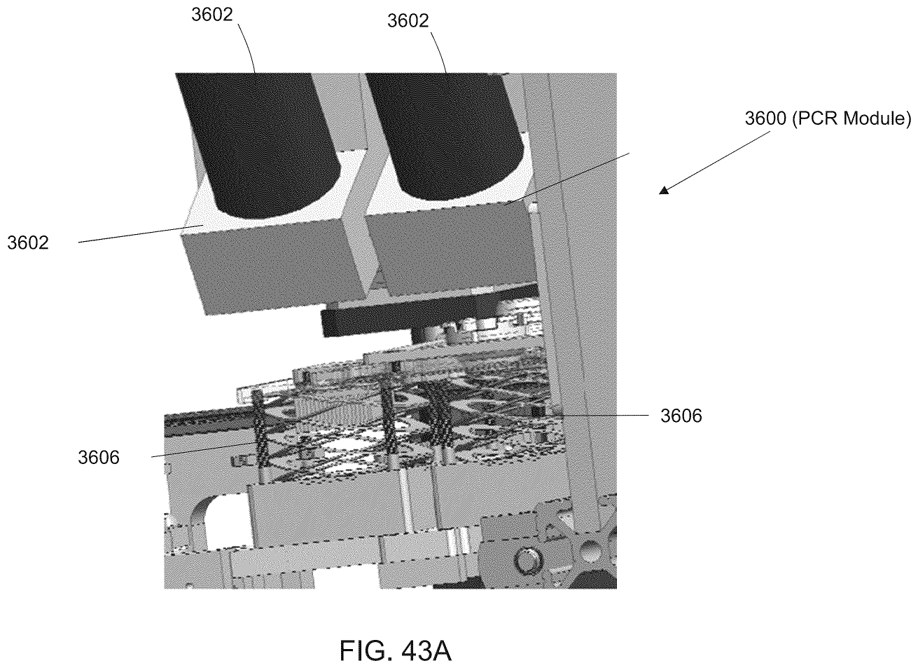

In some embodiments, device 3000 then moves the microfluidic cartridge 2000 to the PCR module 3600 as depicted in FIG. 42. The microfluidic cartridge may be moved by the device between two separate heating blocks in the PCR module, each of which is at a different temperature. As shown in FIG. 42, heating blocks 3604, 3605 are positioned proximate each other so that the microfluidic cartridge can moved back and forth between the blocks 3604, 3605.

In alternative embodiments, the microfluidic cartridge is positioned to be stable while the heating blocks move to contact the microfluidic cartridge. The heating blocks can be of different heights such that when a first heating block (or first movable heating zone) contacts the PCR chamber section of the microfluidic cartridge, the second heating block (or second movable heating zone) is not contacting the PCR chamber section of the microfluidic cartridge. In such a configuration, when the second heating block contacts the PCR chamber section of the microfluidic cartridge, the first heating block is not in thermal contact with the microfluidic cartridge. The inventors have made the surprising discovery that moving the heating blocks in the Z-axis direction only, while the microfluidic cartridge moves in the X-axis results in a more rapid and facile temperature zone change because moving the heating blocks is faster and involves less momentum, and therefore is more controllable than moving the heating blocks in a X-axis direction (due to gravity).

Heating blocks may have different functions as determined by the target and/or the analysis method. Depending on the target and/or process used heating blocks may be controlled to achieve predetermined temperatures. Temperatures at the heating blocks may differ. In particular, a temperature at a first heating block may be controlled at a temperature of in a range between about 45° C. and 65° C. and a temperature at a second heating block may be controlled at a temperature of in range from about 90° C. to about 99° C. For example, a temperature at a first heating block is controlled within a range from about 50° C. and 60° C. while a temperature at a second heating block is controlled in a range from about 94° C. and about 96° C.

Temperatures at the heating blocks may be controlled to modulate temperatures at the cartridge in a first range between about 55° C. and 65° C. and/or in a second range between about 90° C. and 98° C. A temperature profile to which the cartridge is subjected to may vary. Alternately, in some embodiments a cartridge may be subjected to a temperature between about 90° C. and about 96° C. at an denature zone and a temperature between about 55° C. and about 61° C. at an anneal zone.

In some embodiments, to modulate the temperature at the cartridge a temperature at the heating zones (e.g., heating blocks) may be greater than the selected temperature for the cartridge. A temperature at the cartridge may be maintained at a first selected temperature for a selected time.

Temperatures may be controlled at heating blocks such that temperatures increase at a rate of about 1° C./minute. In some embodiments, temperatures of one or both of the heating blocks may be controlled such that the temperatures are cycled.

In an embodiment, one heating block may be a high temperature block. The high temperature block may be held at a constant temperature of about 95° C. The low temperature block may be held at a temperature equal to or less than about 60° C. In some embodiments, the low temperature block may controlled such that a temperature at the low temperature block controlled to have is have small deltas in temperature.

As shown in FIGS. 62-64, springs 3606 may be present in heating blocks 3604, 3605. The structure of springs described herein may enhance cooling at the heating blocks of the denature and/or annealing elements. The open structure of the springs allows for air flow around the heaters to increase cooling when desired.

In particular, FIG. 42 depicts cartridge 2000 positioned proximate a denaturing element 3608. As shown, the spring (not shown) of the denaturing element 3608 is not visible and is compressed. In contrast, the spring 3606 in the annealing element 3610 is fully extended. Springs used in the system may be selected based on a predetermined value for a pressure to compression. Springs providing pressure from about 1 psi (6.89 kPa) to about 15 psi (103.4 kPa). In a particular embodiment, springs providing pressure up to about 14 psi (96.5 kPa), 13 psi (89.6 kPa), 12 psi (82.7 kPa), 11 psi (75.8 kPa), 10 psi (68.9 kPa), 9 psi (62.0 kPa), 8, psi (55.2 kPa), 7 psi (48.3 kPa), 6, psi (41.4 kPa), 5 psi (34.5 kPa), 4 psi (27.6 kPa), 3, psi (20.7 kPa), 2 psi (13.8 kPa), 1 psi (6.89 kPa), or any pressure or fractional pressure between any of the aforementioned values, or a range of pressure between any two for the aforementioned values or fractional values. In some embodiments, the spring provides about 11 psi (75.8 kPa).

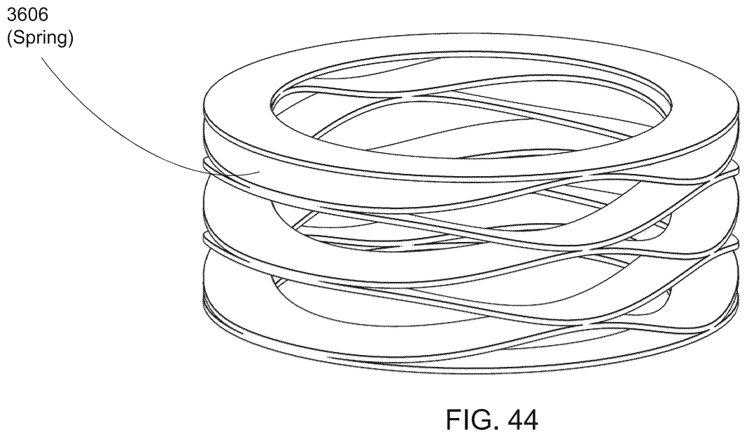

Springs may be used to control proximity of heating elements of the heating blocks to the microfluidic cartridge. In this manner, the heat provided to the microfluidic cartridge may be controlled. Springs 3606 for use in the device are shown in FIG. 44. Springs may ensure homogeneous thermal contact between a microfluidic cartridge or a portion thereof and a heating block, in particular, a heater plate.

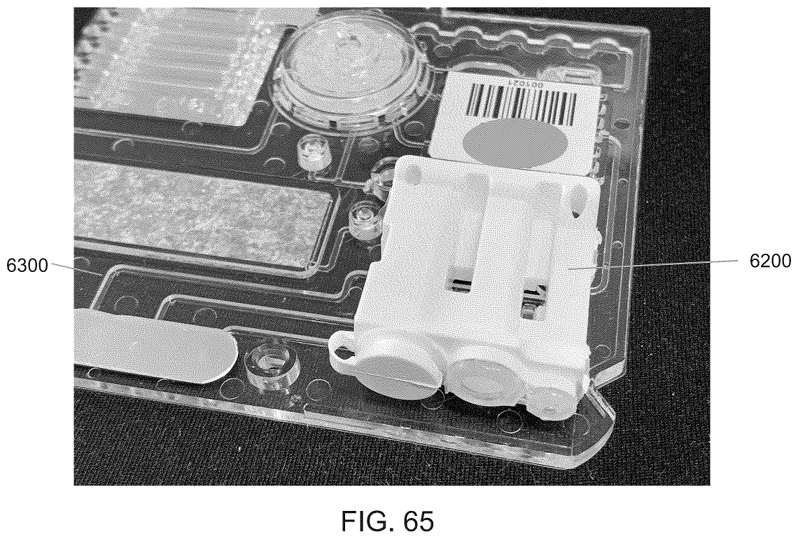

An embodiment of a heating module that includes a denature element 3608 and an anneal element 3610 is shown in FIG. 42A. A denature element may encompass a high temperature heating block and an anneal element may encompass a low temperature heating block in some embodiments. In some embodiments, the relative heights of the denature element 3608 and anneal element 3610 are offset as shown in FIG. 42B. The relative heights of the denature element 3608 and anneal element 3610 enable the respective elements to alternatively contact the microfluidic cartridge while the microfluidic cartridge is in a fixed Z-axis position while the respective elements are moved in the Z-axis to be in contact with the PCR chambers of the microfluidic cartridge. In some embodiments, the microfluidic cartridge is only moved on an X-axis to be positioned over the heating blocks, and a selected heating block is raised (on the Z-axis) to make the heating block contact the PCR chamber of the microfluidic cartridge. In some embodiments, the heating module is positioned such that the heating elements move to contact the PCR chambers of the microfluidic cartridge while the microfluidic cartridge is in a fixed position. In some embodiments, the denature element 3608 and anneal element 3610 are at different relative heights so that each element (denature or anneal) can contact the PCR chambers of the microfluidic cartridge while the respective other element is not in contact with a separate section of the microfluidic cartridge, as shown in FIGS. 65B and 65C. In some embodiments, the PCR chambers of the heating block comprise an aluminum sheet (e.g., aluminum tape) proximate to the bottom surface of the microfluidic cartridge directly below the region where the PCR chambers are located to transfer heat from the heating blocks into the microfluidic cartridge at the region where the PCR chambers are located.

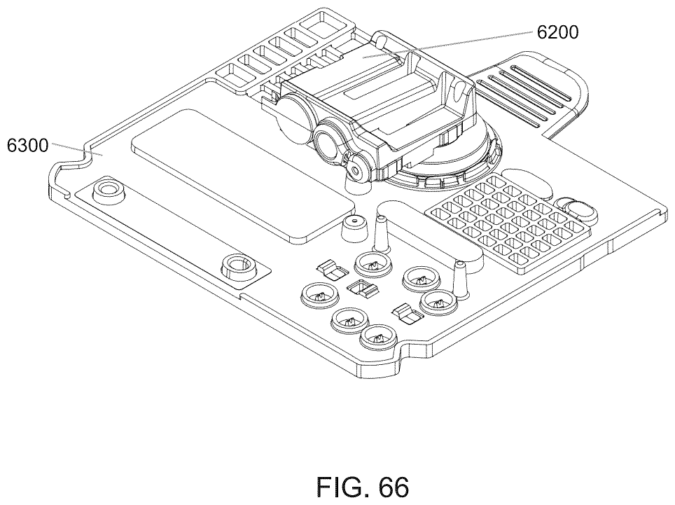

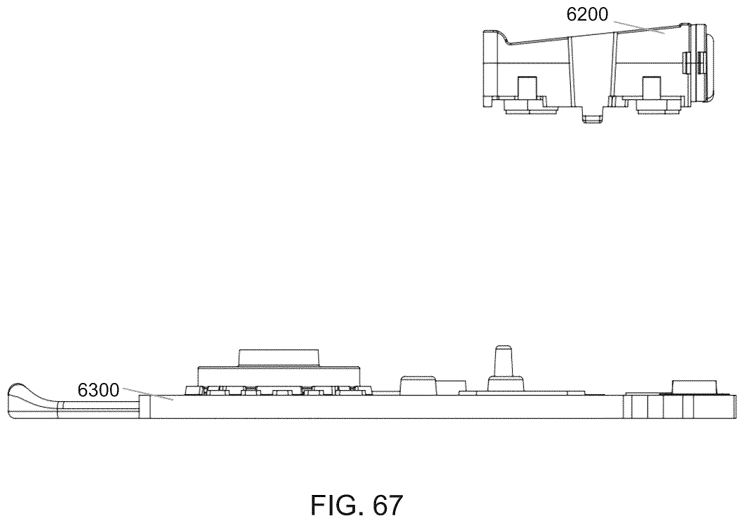

A high temperature heating block (also referred to herein as part of the denature element 3608) is depicted in FIGS. 66A-C. The high temperature heating block 3604 includes a heater plate 3612, heater 3614, heater mount plate 3616, a thermistor 3618, and a thermal interface pad 3620. In some embodiments, a high temperature heating block may be used to provide heat to the microfluidic cartridge such that some constituents in the sample are denatured. A heat plate may include cavities. For example, a heat plate may include a cavity to allow for positioning a thermistor. As shown in FIGS. 67A and 67B, thermistor 3618 is positioned in cavity 3624. The thermistor can monitor temperatures of the heating block in this manner. The thermistor allows for a thermal feedback loop such that the temperature can be rapidly modulated to a controlled range by the application of a voltage to the thermistor to achieve a selected temperature range.

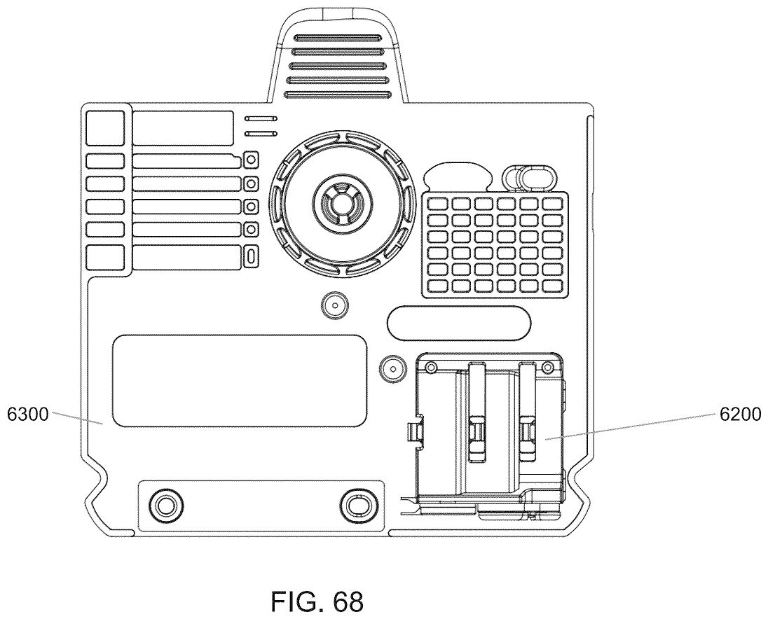

FIGS. 68A-C depict a low temperature heating block (also referred to herein as part of the anneal element 3610). The low temperature heating block 3605 includes a heater plate 3612, heater 3614, heater mount plate 3616 with heat sink 3622, a thermistor 3618, and a thermal interface pad 3620. In some embodiments, a heating block may include a heat sink. For example, heater mount plates for a low temperature heating block may include a heat sink. The heat sink enables the rapid dissipation of heat from the heat element on the low temperature heating block. In some embodiments, a low temperature heating block may be used for annealing and referred to as an annealing module. In some embodiments, the heat sink is contiguous with the heating block such that they are machined from the same part.

Heaters, for example, thermal interface pads as shown in FIGS. 66B-C, 67B, and 68B-C may be formed from a thin polyimide films. In some embodiments, heating elements and/or thermal interface pads may be formed from materials including, but not limited to metals such as copper, copper with a silver plate, films such as polyimide films and/or multi-layered metallic thin films. For example, a heating element may be formed from copper and plated with silver. In some embodiments, the silver plate may have a thickness in a range of about 0.1 to about 0.5 mm thick. In a particular example, the heating element is made using copper and has a 0.3 mm layer of silver plate. In some embodiments, the heating element for the denaturing heating zone (a first heating zone) comprises copper tape. In some embodiments, the heating element for the re-annealing heating zone comprises aluminum tape. The tapes can act to rapidly transfer heat from the heater to the heat sink.

In an alternative embodiment, a heating block may include a fan and/or a thermoelectric cooler (TEC) to control temperatures at the heating block. In particular, in some embodiments it may be desirable to conduct thermocycling at the heating blocks during the course of the method. For example, fans may be used to cool the heating blocks by providing air flow in the area under the heating blocks proximate the springs.

In some embodiments, a fan or a TEC may be used to control a temperature at a heating block. For example, a fan or TEC may be used to regulate temperature at heating block according to a predetermined schedule. In particular, if a fan or TEC is used with a low temperature heating block to maintain a temperature in a range between about 50 to 60° C. the fan or TEC may be adjusted based on whether the fan or TEC is preparing to contact a microfluidic cartridge from the 95° C. heater or whether contact has been already been made and the temperature of the TEC is being driven to 60° C.

A fan or a thermoelectric cooler (TEC) may be energized to drop the temperature at the heating block to one or a plurality of selected temperatures, for example, less than about 60° C. In particular, a temperature at this heating block may be in a range from about 50 to about 55° C. A first temperature block may be positioned proximate the PCR chambers of the microfluidic cartridge where the first temperature block is positioned proximate a heater held at a temperature of about 95° C. After the predetermined residence time proximate the high temperature heating block, the second (low) temperature block is moved to a position proximate the PCR chambers of the microfluidic cartridge. At the low temperature block, the latent heat from the microfluidic cartridge will warm up the heater on the low temperature heating block while cooling the microfluidic cartridge. In this way, the temperature of the heater and the temperature of the microfluidic cartridge will meet at the predetermined temperature of about 60° C. In some embodiments, the thermal set points can be adjusted while the first and second temperature blocks are moving towards and away from the PCR chambers of the microfluidic cartridge. In some embodiments, for the first PCR cycle, the thermal set points can change to, e.g., 55, 57, or 59° C. such that the PCR chambers of the microfluidic cartridge meet a heating block at 59° C. but then is maintained at a temperature between 55° C. and 57° C. during the thermal contact period. After the thermal contact period, the temperature set point can be readjusted to account for the reduced temperature from the heat transfer to the microfluidic cartridge. The inventors have recognized that the heat loss from the temperature block to the microfluidic cartridge can affect subsequent temperature settings on the temperature block such that the thermal set point can be modulated at the meet point of thermal contact, during the thermal contact period, and during the post-contact period. The impact of dynamically modulating the thermal set point is to minimize the thermal contact time by reducing the ramp time from contact temperature to the effective temperature in the PCR chambers.

In an embodiment where a TEC is used, the hot side of the TEC will be used to control the temperature at the low temperature heating block, that is the TEC will be used as a heater. Thus, to lower the temperature at the low temperature heating block the power (i.e., voltage) can be dropped to lower the temperature.

In some embodiments, temperatures of the thermal blocks is controlled using a proportional-integral-derivative controller (PID). The PID controller may use pulse-width modulation (PWM) to drive the heaters to the correct temperature. The PID controller may be coupled to a thin polyimide film heater and/or a thermoelectric cooler (60° C.). For example, the PID controller may control thin polyimide films at a temperature of about 95° C. and/or in a range of temperatures between about 50° C. and about 60° C.

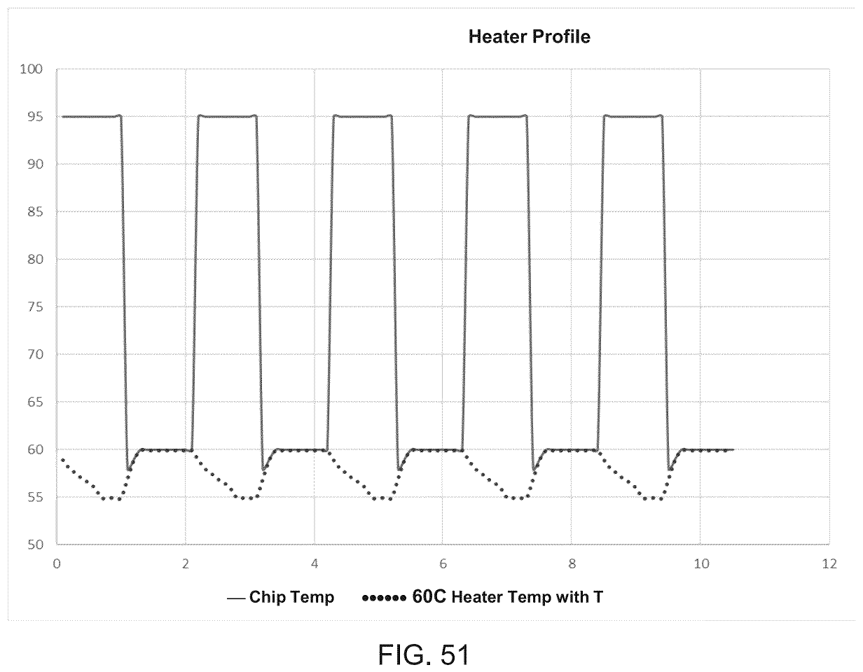

As shown in FIG. 51, a heater profile of the temperatures that the fluid in the microfluidic cartridge achieves is depicted. In this embodiment, the microfluidic cartridge is moved between a high temperature block held at about 95° C. and a low temperature block that is held at a temperature equal to or less than about 60° C. As the microfluidic cartridge is cycled between the low temperature heating block and the high temperature heating block a fan or a thermoelectric cooler (TEC) may be used to regulate a temperature of the low temperature heating block. In particular, a microfluidic cartridge may be moved from the low temperature heating block and then a fan will be energized to drop the temperature of the heater on the low temperature heating block to a temperature less than about 60° C. Specifically, a temperature at this heater may be at one or a plurality of selected temperatures in a range from about 50 to about 55° C. During this time the microfluidic cartridge may be positioned proximate the high temperature block where the microfluidic cartridge is positioned proximate a heater held at a temperature of about 95° C. After the predetermined residence time proximate the high temperature heating block, the microfluidic cartridge is moved to a position proximate the low temperature block. At the low temperature block, the latent heat from the microfluidic cartridge will warm up the heater on the low temperature heating block while cooling the microfluidic cartridge. In this way, the temperature of the heater and the temperature of the microfluidic cartridge will meet at the predetermined temperature of about 60° C. The weighted average thermal mass is such that when the microfluidic cartridge is in contact with the high temperature heating block or the low temperature heating block, the selected temperature is rapidly achieved because of the pre-set temperatures of the respective heating blocks.

In an embodiment where a TEC is used, the hot side of the TEC will be used to control the temperature at the low temperature heating block, that is the TEC will be used as a heater. Thus, to lower the temperature at the low temperature heating block the power (i.e., voltage) can be dropped to lower the temperature.

Temperatures at the first heating block may be controlled within a range from about 50° C. to about 55° C. and the temperature at the second block may be controlled at about 95° C. For example, a temperature at the block may be controlled such that it changes about 1 to 5 degrees per second and hold for period of time. Once a predetermined temperature is reached this predetermined temperature may be held for 4 seconds or in some embodiments a predetermined temperature may be held for 8 seconds.

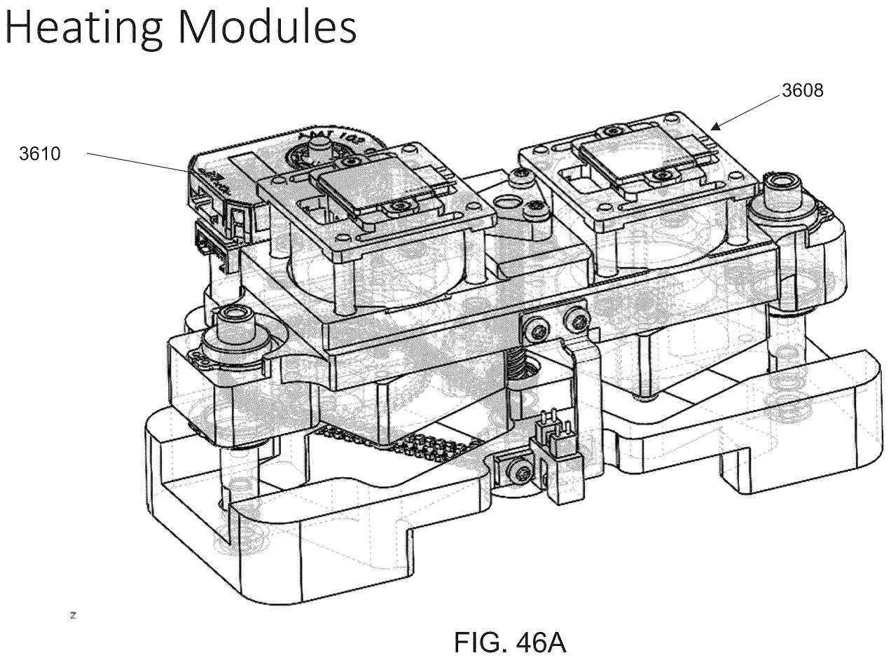

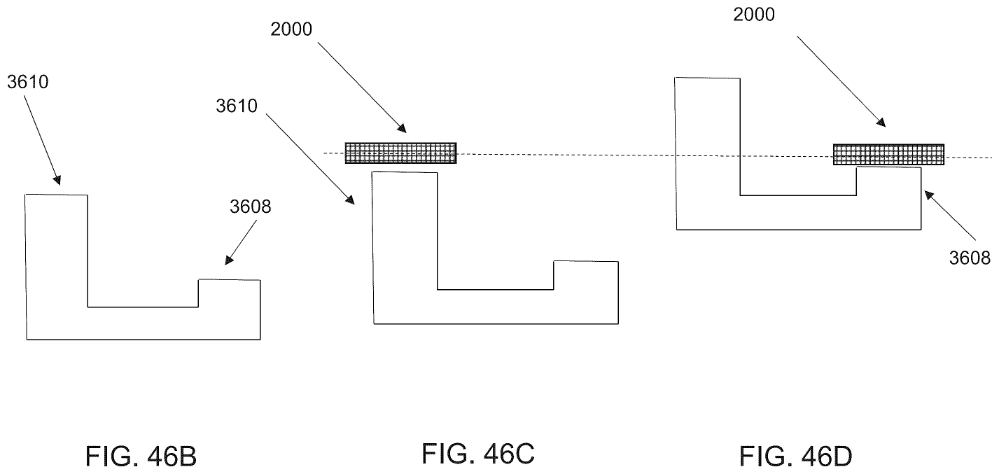

As shown in FIG. 46A, PCR module 3600 includes denature element 3608 and anneal element 3610. Cartridge 2000 is shown positioned proximate denature element 3608. Each time the microfluidic cartridge is moved between the denature element and the anneal element that corresponds a cycle. In some embodiments, prior to analyzing the PCR elements of the microfluidic cartridges are moved between the denature and anneal elements such that they are cycled in range between 20 and 100 times. Cycle time may be dependent on the target, the method used, and sample type. In some embodiments, the cycle time can range from about 0.3 to about 20 seconds. In some embodiments, the cycle time can range from about 1 to about 6 seconds. In some embodiments, the cycle time is about 5 seconds. The inventors have designed the system and heating elements of this disclosure to minimize cycle time which minimizes the overall PCR analysis time. In some embodiments, the overall PCR analysis time is less than 15, 14, 13, 12, 11, 10, 9, 8, 7, 6, 5, 4, 3, or 2 minutes. In some embodiments, the overall PCR analysis time is less than 6 minutes. In some embodiments, the overall PCR analysis time is about 5.5 minutes.

Temperatures of the heaters may be continually monitored. For example, a thermistor may be used to continually measure a temperature of the heaters. Temperature measurements may be used as feedback to control temperatures using a proportional-integral-derivative controller (PID). In some embodiments, the temperature may be monitored by a thermistor, thermocouple, or RTD (resistive temperature detector).

The heating zones can be offset in a vertical dimension relative to each other such that each heating zone can separately contact the PCR chambers in a controlled manner.

Cameras may be used to detect nucleic materials in the samples. In some embodiments, commercially available cameras are used. In particular, a camera have a numerical aperture of greater than about 0.6 may be used. Depending on the target, method of analysis, and/or ambient conditions different filters may be used when using the cameras to take images of the samples. In some embodiments, samples may be exposed to light sources such as one or a plurality of light emitting diode (LED) when images are captured. In a particular embodiment, at least two light sources are used during imaging.

Light sources used during analysis may provide light in a continuous manner. Alternately, light may be provided in a predetermined sequence. In some instances, at least one of the light sources may be used while the temperature of the heating block proximate which the PCR element of the microfluidic cartridge is positioned is modulating to a predetermined temperature.

In some aspects, light is provided from a light source the temperature has modulated to a selected temperature. In some aspects, the light source is discontinuous. In some aspects, light may be presented in a discontinuous manner at each denature (control) and anneal (selected nucleic acid) step during cycling.

In particular, fluorescence of the samples may be measured to determine an amount and/or type of nucleic material present. In some embodiments, the fluorescence may be measured at several different wavelengths. Fluorescent dyes may be used to label targets of interest such as proteins, nucleic acid conjugates, and/or oligonucleotides. In particular, fluorescent dyes having a excitation maximum in a range between about 450 and 700 nm and a emission peak in a range between about 400 and 750 nm may be preferred. For example, fluorescent dyes used may include but are not limited to fluorescein such as 6-Carboxyfluorescein (FAM6), and cyanine dyes such as Cyanine-5 (Cy5). Any fluorescent dyes common to those used in PCR methods can be used.

In some embodiments, cameras may be positioned in any location that provides a clear view of the PCR chamber of interest. In some embodiments, a light source may be used to excite targets. In some embodiments, the light source is an LED (light emitting diode).

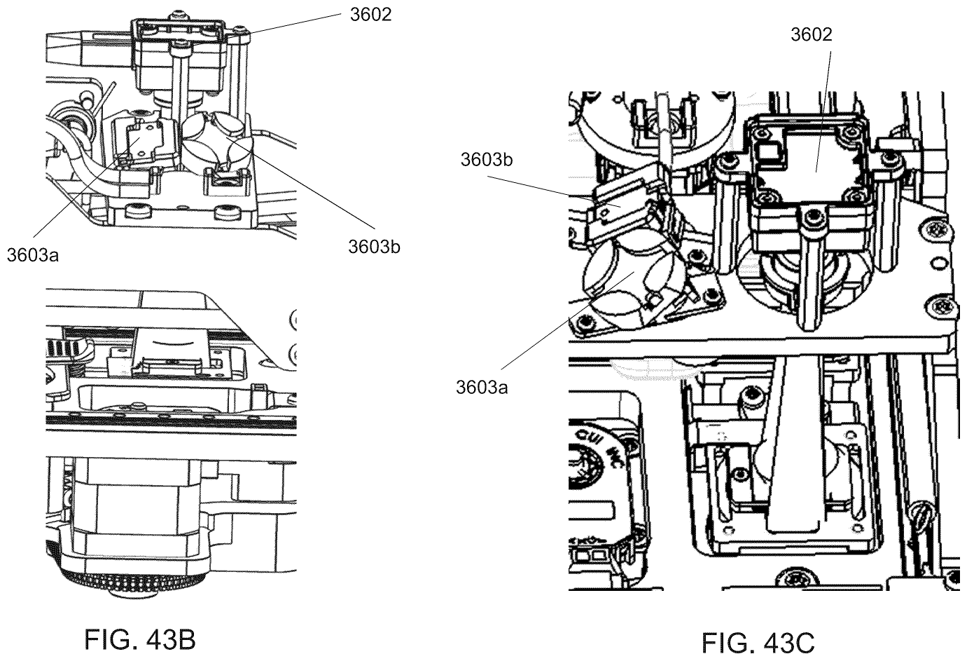

As shown in FIGS. 42-43, cameras 3602 are positioned above and slightly offset from the position where the microfluidic cartridges 2000 are analyzed. For example, FIG. 42 depicts cartridge 2000 positioned at least partially above denature zone (i.e., high temperature heating block 3604) and camera 3602 positioned above and slightly offset from a plane perpendicular to the microfluidic cartridge. Thus, in the embodiment shown the cameras are viewing the PCR chambers at an angle.

In alternate embodiments, cameras may be positioned above the PCR chambers, on a side of the PCR chambers, and/or both (i.e., the cameras may be offset from the PCR chambers such that the cameras view the PCR chambers at a predetermined angle).

In an embodiment, one camera is positioned on the anneal side (i.e., lower temperature side), and the other camera is positioned on the denature (i.e., higher temperature side) side. In a particular embodiment, a test sample may be analyzed using a camera on the anneal side and a control sample may be analyzed using a camera on the denature side. In some embodiments, the relative fluorescence intensity (e.g., relative to the signal intensity of the first PCR cycle) may be analyzed using the camera positioned on the anneal side. Due to the nature of the method, one side may be one-half cycle behind the other side.

In an alternate embodiment, two cameras are on the anneal side (the lower temperature side).

In addition, some embodiments may include a camera for quality control. For example, additional cameras may be used to comply with the quality control guidelines of the clinical laboratory improvement amendments (CLIA).

In some embodiments, multiple cameras may be combined with multiple light sources. In some instances, a fluorescent dye may be added to the analyzed sample to enhance signal intensity in the sample.

Amplification of nucleic material using the system and method described is capable of amplifying a specific nucleic material and detecting the material using fluorescence in a predetermined amount of time. For example, the system and method may amplify and detect at least 100 copies of a specific DNA element in about 5 minutes. Alternately, the system and method described may amplify and detect at least 100 copies of a specific RNA element in about 10 minutes. In some embodiments, the system and method may amplify and detect at least 100 copies of a specific DNA element or RNA element in about 2, 3, 4, 5, 6, 7, 8, 9, 10, 11, 12, 13, 14, or 15 minutes, or any time, including fractional times, between any two of the aforementioned times.

The PCR chambers of the microfluidic cartridge are subject to dual heating zone exposure a predetermined number of times, which corresponds to requisite number of PCR cycles. In some embodiments, targets are amplified using a temperature cycling reaction that repeats up to a predetermined number of times. Each iteration may be considered an amplification cycle. In some embodiments, the amount of genetic material increases after each cycle. In some instances, target materials may double after each cycle. A number of amplification cycles necessary to create enough copies of the target materials to be detected is called the cycle threshold or Ct value.

For example, the more target nucleic material present in a sample, the few cycles are needed to detect it.

In a particular example, utilizing fluorescent dyes having a preselected excitation maximum in a range between about 450 and 700 nm and a emission peak in a range between about 400 and 750 nm (e.g., FAM6 and Cy5), 100 copies of a target DNA may be made in 5 minutes and 100 copies of a target RNA can be made in 10 minutes.

After cycling is complete the microfluidic cartridge may be removed from the system. In some embodiments, the microfluidic cartridge can be discarded in the appropriate waste container.

### Dynamic Thermal Adjustment

In some embodiments, the weighted average thermal mass of the PCR module of the microfluidic cartridge and the contact surface of the denature or anneal heating module can be configured to minimize transition time the PCR module is exposed to during the transition between the denature and anneal PCR steps. The inventors have recognized that for the lysed nucleic acid samples prepared by the mechanical lysing steps described herein which results in relatively short DNA or RNA strands (e.g., about 200 bp), PCR can be performed in a fast and efficient manner so as to yield a measurable probe signal in a time period which enables the use of the systems and methods described herein to be performed in under 10 minutes.

When the PCR module of the microfluidic cartridge is placed on a heating block, the heating block temperature can be dynamically adjusted before, during, and/or after the interaction with the microfluidic cartridge to prepare the heating block for the next interaction with the microfluidic cartridge. The inventors recognized that the PCR module comprises a thermal mass, and when approaching a particular heating block during the PCR cycles will be at a temperature which is different from the desired final temperature for a particular stage of the PCR cycle (denature/anneal). To reduce the time for the PCR module to come into thermal equilibrium with the desired temperature for a particular PCR cycle stage, the particular corresponding heating stage can be adjusted so as to either be cooler (for anneal), or hotter (for denature) before the PCR module contacts said stage. The temperature adjustment gradient can be set per the local environment and heat loss of the particular heating stage (e.g., a more humid environment may be slower to heat up and slower to cool down, thereby requiring a different rate of temperature adjustments than when the method is performed in a relatively more arid environment). A fan or a thermoelectric cooler (TEC) may be energized to drop the temperature at the heating block to one or a plurality of selected temperatures, for example, less than about 60° C. before the PCR module interfaces with the annealing thermal block. In particular, a temperature at this heating block may be in a range from about 50 to about 55° C. When the PCR module interfaces the annealing thermal block, the temperature of the annealing thermal block can be raised to about 60° C. during that stage of the PCR cycle. The PCR module will interface with the anneal stage heating block for a selected period of time (e.g., from 0.3 to 30 seconds). After the PCR module completes a particular stage of the PCR cycle, the PCR module will be moved to the denature (higher temperature) thermal block. While the PCR module is moved to the denature thermal block, the annealing thermal block can be set back to a temperature in a range from about 50 to about 55° C. to reset the anneal thermal block for the next PCR cycle. A similar method can be applied to the denaturing thermal block wherein the temperature of the denature thermal block can be set above 90° C. (e.g., 92, 93, 94, 95, 96, or 97° C.) or a temperature between any of the aforementioned temperatures) before interfacing with the PCR module component of the microfluidic cartridge. When the PCR module contacts the denature thermal block, the denature thermal block temperature can then be set to about 90° C. for the duration of the denature step of the PCR cycle (e.g., from 0.3 to 30 seconds). After the PCR module leaves the denature thermal block, the temperature of the denature thermal block can be reset to a temperature above 90° C. (e.g., 92, 93, 94, 95, 96, or 97° C.) to reset the denature thermal block for the next PCR cycle. At the low temperature block, the latent heat from the PCR module component of the microfluidic cartridge will warm up the heater on the low temperature heating block while cooling the microfluidic cartridge. In this way, the temperature of the heater and the temperature of the microfluidic cartridge will meet at the predetermined temperature of about 60° C. In some embodiments, the thermal set points can be adjusted while the anneal and denature temperature blocks are moving towards and away from the PCR chambers of the microfluidic cartridge. In some embodiments, the thermal set points can change to 55, 57, or 59° C. such that the PCR chambers of the microfluidic cartridge meet a heating block at 59° C. but then is maintained at a temperature between 55° C. and 57° C. during the thermal contact period. After the thermal contact period, the temperature set point can be readjusted to account for the reduced temperature from the heat transfer to the microfluidic cartridge. The inventors have recognized that the heat loss from the temperature block to the microfluidic cartridge can affect subsequent temperature settings on the temperature block such that the thermal set point can be modulated at the meet point of thermal contact, during the thermal contact period, and during the post-contact period. The impact of dynamically modulating the thermal set point is to minimize the thermal contact time by reducing the ramp time from contact temperature to the effective temperature in the PCR chambers.

### Computer Controller and Software

The device may be controlled by software using a computer and/or controller. In some embodiments, a user interface that may receive instructions from a user which are transmitted to the computer and displays information from the computer to the user. In some cases, the computer and/or controller may include a communication system configured to send information to a remote server and to receive information from a remote server.

Software and/or user interface may be modular. For example, in some embodiments a device may be customized based scale by changing user interface.

### Assay Targets

In some embodiments, the system, device, and/or cartridge may be configured for use in identifying specific predetermined targets. Targets may include genetic material that can identify viruses by strain and/or variants. For example, the device and/or microfluidic cartridges may be preconfigured to test for targets that can identify multiple Covid variants and/or Influenza strains. In some embodiments, the device and/or cartridges may be configured to identify multiple Covid variants (e.g., Alpha, Beta, Delta, Omnicron) and strains of Influenza (e.g., Type A, Type B). In some embodiments, the device and/or cartridges may be configured to identify an infectious disease, which can include or exclude: HIV, Acquired Immune Deficiency Virus (AIDS), Herpes Simple Virus (Genital Herpes (HSV-1, HSV-2)), Trichomonas Vaginalis, Trichomoniasis, Parainfluenza, Respiratory syncytial virus (RSV), Human metapneumovirus (hMPV), Syphilis, norovirus, rotavirus, astrovirus, coronavirus, enterovirus (including enterovirus serotype coxsackievirus A16, also referred to as hand-foot disease), Borrelia burgdorferi (Lyme disease), Borrelia mayonii (rare cause of Lyme disease), Mycoplamsa genitalium, Human Papillomavirus (HPV), Neisseria meningitides, Bordetella pertussis, Gonorrhea, Chlamydia trachomatis bacterium, Chlamydia trachomatis, Neisseria gonorrhoea, Leptospira, Rabies virus (RABV), Zika virus, west nile virus, poliovirus, Cytomegalovirus (CMV), Middle East Respiratory Syndrome Coronavirus, Orthopox (monkeypox), arbovirus of the flavivirus genus (yellow fever), Highly pathogenic avian influenza (HPAI) A (H5N1) virus, Salmonella, and Exanthematous virae (which can include or exclude: varicella-zoster virus (chickenpox), rubeola (measles), human herpesvirus (HHV) type 6 (roseola), and mpox virus). In some embodiments, targets may include bacterium or yeast. In some embodiments reagents specific to a particular target may be preloaded into a microfluidic cartridge. In some instances, a user interface and/or control algorithm may be configured to identify particular targets.

### ELISA Configuration

In some embodiments, the microfluidic cartridges and methods of this disclosure can be used to detect an analyte other than a nucleic acid within a sample. In some embodiments, the sample comprises an analyte selected from: protein, peptide, amino acid, metabolite, vitamin, saccharide, polysaccharide, or small molecule (having a molecular weight of less than 750), or combinations thereof. The reagents for detecting the analyte can be configured in an immunoassay format. In some embodiments, the immunoassay format can be an ELISA assay (Enzyme-linked immunosorbent assay). In some embodiments, the ELISA assay is a sandwich ELISA assay. In some embodiments, the bottom surfaces of the “PCR chambers” comprise a surface-tethered capture enzyme on a top or bottom surface of the PCR chamber. The reagents for detecting the analyte can be configured to be selectively introduced into the PCR chamber after introduction of the sample with analyte into the PCR chambers. The reagents for detecting the analyte can be, separately or combined in the same mixture, labelled detection enzyme, and substrate for the labelled detection enzyme. In some embodiments, this disclosure provides for a method for detecting the presence of an analyte in a sample comprising: presenting the sample to a microfluidic cartridge of this disclosure, wherein first a sample comprising an analyte selected from: protein, peptide, amino acid, metabolite, vitamin, saccharide, polysaccharide, or small molecule (having a molecular weight of less than 750), or combinations thereof; presenting lysis conditions to the sample whereby the analyte is converted to a cell-free format; contacting the cell-free analyte with a filtration substrate; washing said filtration substrate to elute the cell-free analyte from said filtration substrate; contacting the cell-free analyte with a substrate which comprises a capture antibody (also referred to as a primary antibody) to form an capture antibody-cell-free analyte complex; contacting the capture antibody-cell-free analyte complex with a label antibody (also referred to as a secondary antibody) to form a capture antibody-cell-free analyte-label antibody complex; optionally contacting the capture antibody-cell-free analyte-label antibody complex with a substrate for the label; detecting a signal from the label. In some embodiments, the label is a fluorescent or chemiluminescent label. In some embodiments, the label antibody is introduced from a separate reagent reservoir within the microfluidic cartridge which can be selectively in fluidic communication with the “PCR chambers” (which do not contain PCR analytes but instead the ELISA complex). In some embodiments, the label substrate is introduced from a separate reagent reservoir within the microfluidic cartridge which can be selectively in fluidic communication with the capture antibody-cell-free analyte-label antibody complex. In some embodiments, the label antibody is conjugated to horseradish peroxidase (HRP) or alkaline phosphatase (AP). In some embodiments, the substrate can include or exclude: 3,3′,5,5′-tetramethylbenzidine (TMB), 2,2′-azino-di-[3-ethylbenzthiazoline-6-sulfonic acid] (ABTS), 3,3′-diaminobenzidine (DAB), luminal (3-Aminophthalhydrazide), luciferin, pyrogallol, purpurogallin, gallic acid, and umbelliferone. Other ELISA formats are also contemplated and can be used with the microfluidic cartridges of this disclosure to detect one or a plurality of analytes and can include or exclude: Indirect ELISA, Direct ELISA, Sandwich ELISA, and Competitive ELISA.

### Examples

### Example 1. Representative Microfluidic Cartridge and System for Performing PCR

Cartridges including microfluidic cartridges having differing dimension were made to evaluate the method and cartridge.

A microfluidic cartridge as shown in FIG. 2 was formed and included PCR elements having the following dimensions. Values for the various depths were as follows: the CD was equal to 0.254 mm, the SD was equal to 0.381 mm, the FCS-D was equal to 0.127 mm, the SCS-D was equal to 0.0635 mm, and the SD was equal to 0.0847 mm. Further, values for the various widths in the PCR element as follows: inlet width in well 2624 (IWW) was equal to 1.41 mm, the well width 2626 (WW) was equal to 2.5 mm, the well restriction width 2628 (WRW) was equal to 0.2344 mm, the Zig-Zag channel width 2630 (ZZW) was equal to 0.625 mm, inlet restriction width 2632 (IW) was equal to 1.25 mm, tub diameter 2634 (TD) was equal to 2.5 mm, the Zig-Zag channel section length 2636 (ZZL) was equal to 2.25 mm and the well spacing 2638 (WS) was equal to 4.5 mm. In addition, values for the various lengths were as follows: the channel length (CL) was 15 mm, the restriction section length (RSL) was 3.45 mm, a length of first restriction step (FRSL) was about 1.725 mm, and a length of second restriction step (SRSL) was 1.725 mm.

Examples of elements of the system are depicted in FIG. 4 and FIG. 17. FIG. 4 depicts an embodiment of a standalone lysis element 2208 that includes balls 2206 within three separate lysis chambers 2200. As shown in FIG. 4, a PCR element 2600 includes five PCR chambers 2602.

FIG. 17 depicts a cartridge 2000 embodiment having PCR element 2600 including four PCR chambers 2602, introduction element 2100, distribution element 2302 and multiple channels.

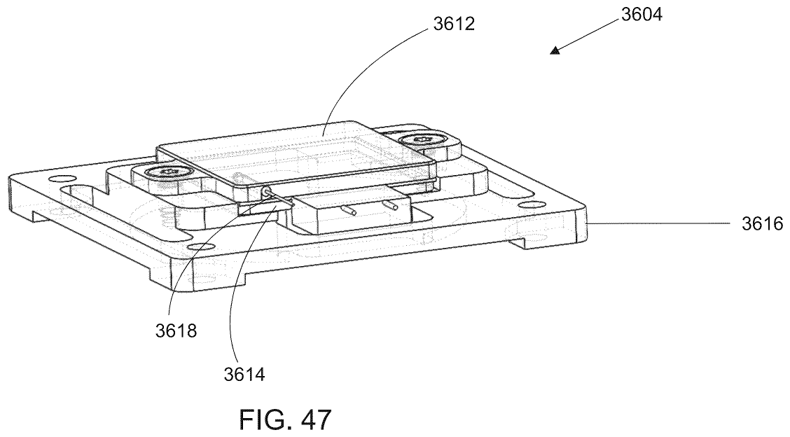

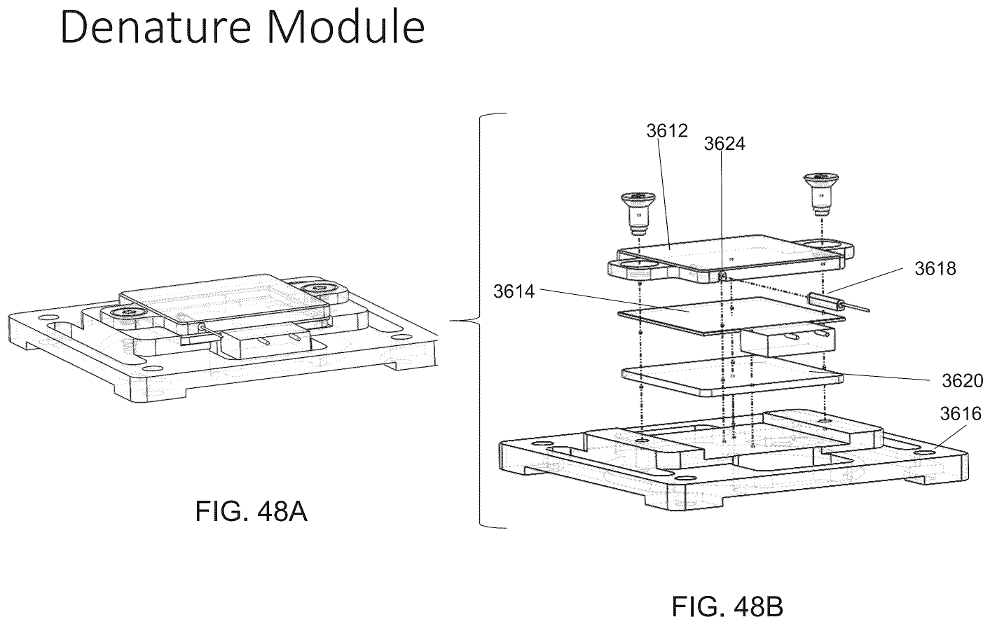

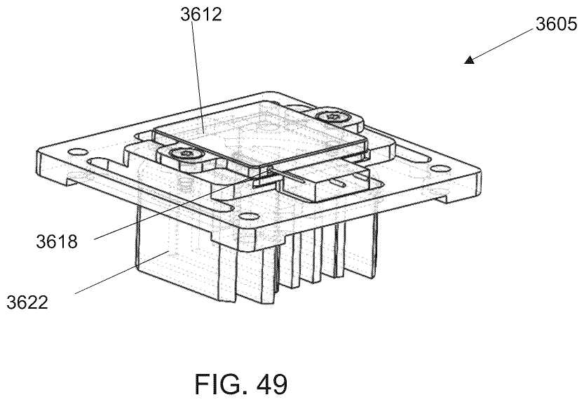

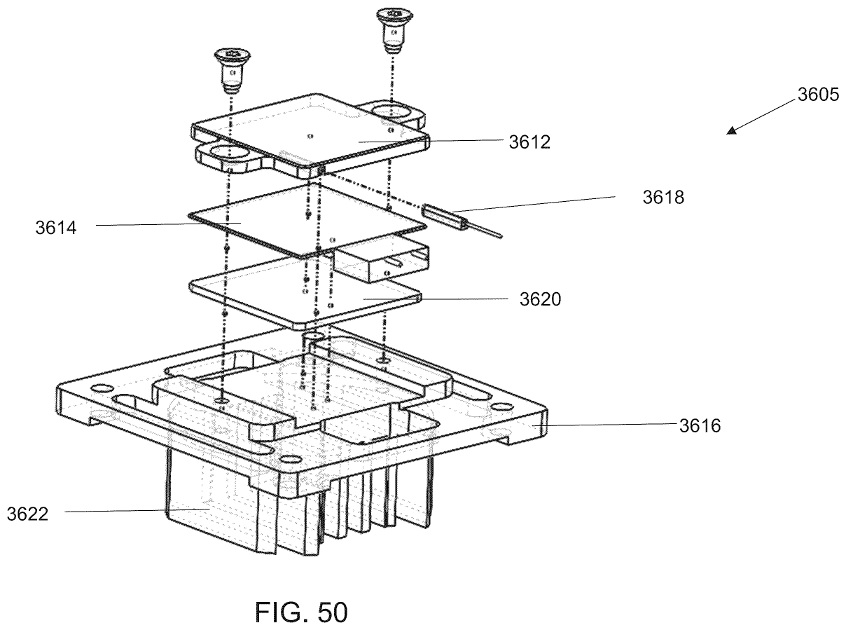

As shown in FIG. 47, heating element 3614 includes a thin material. This heating element was incorporated into heating module 3626 that incorporates an anneal element and a denature element.

### Example 2. Amplification of Target Nucleic Acid in a Representative Microfluidic Cartridge

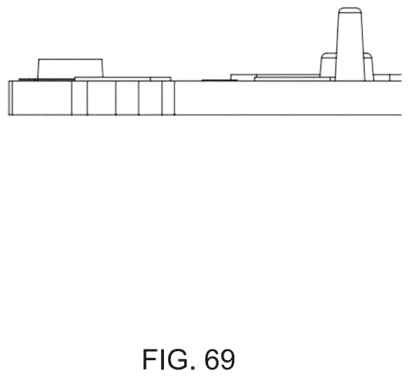

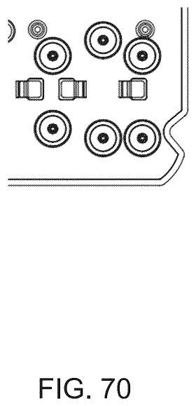

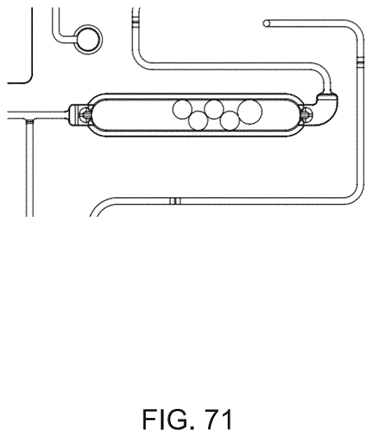

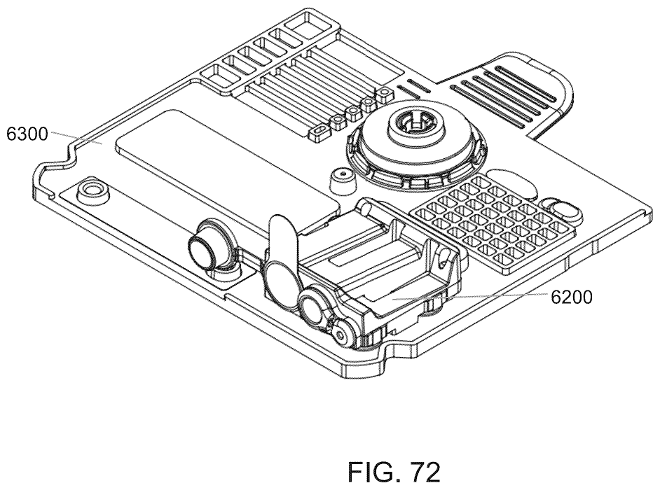

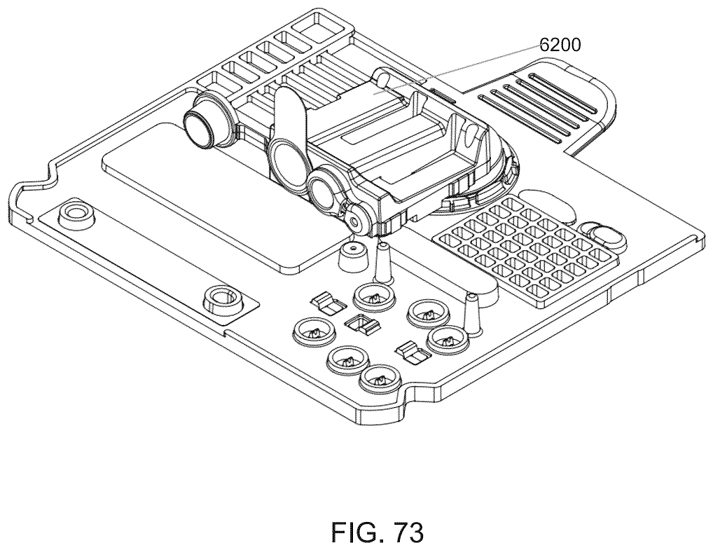

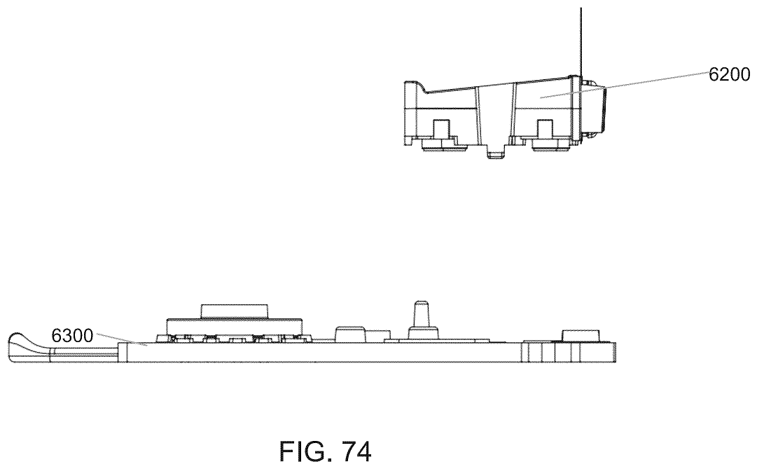

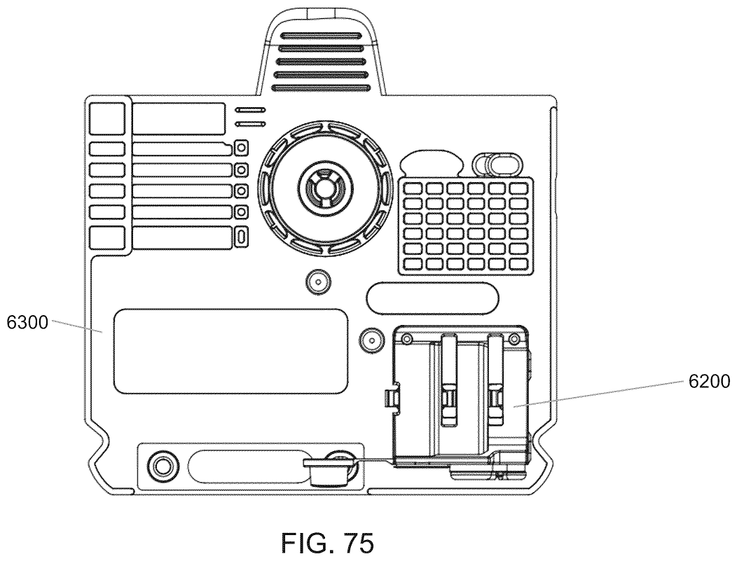

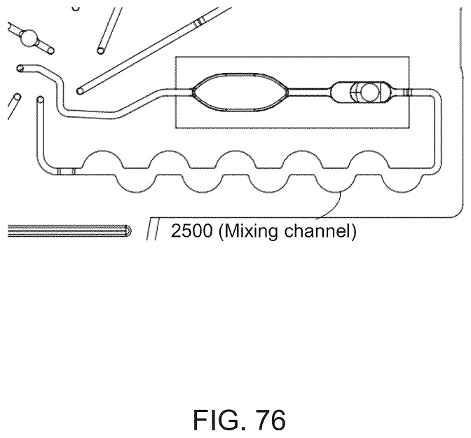

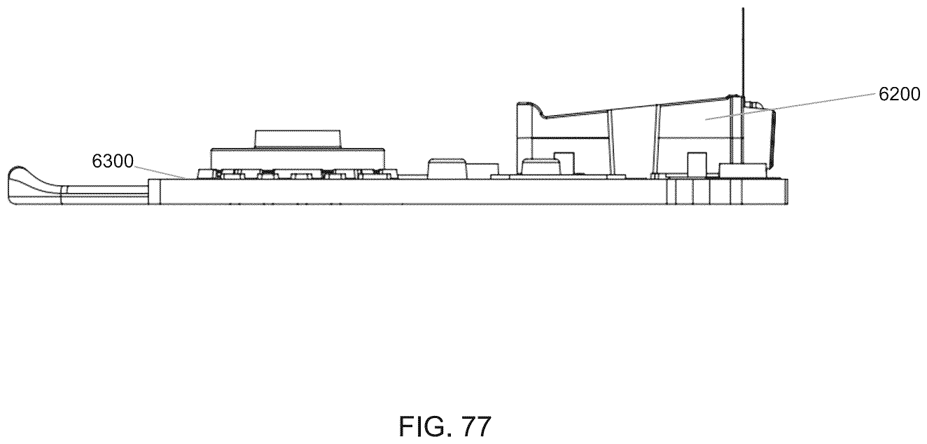

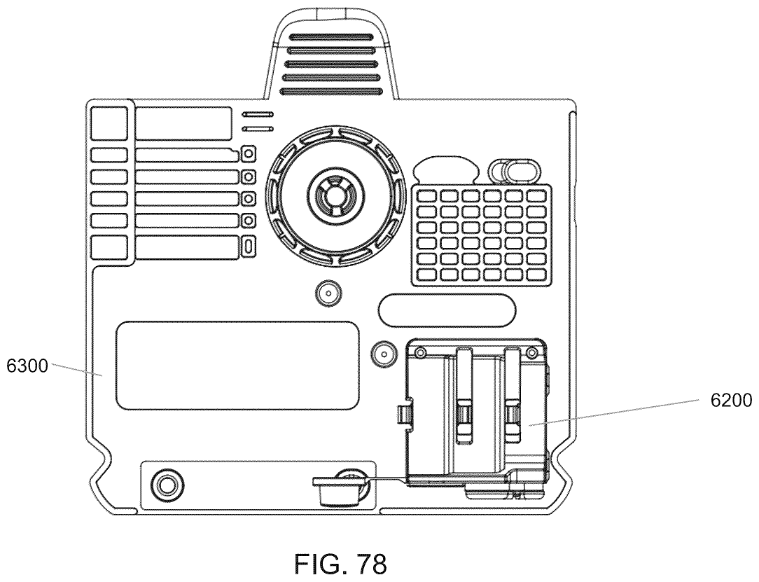

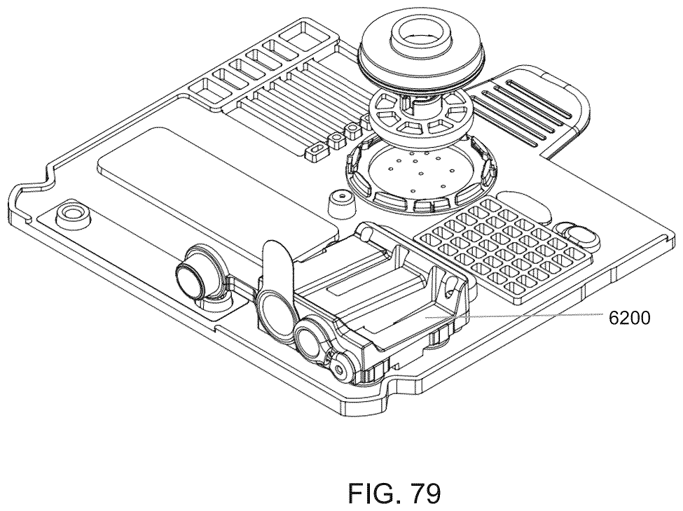

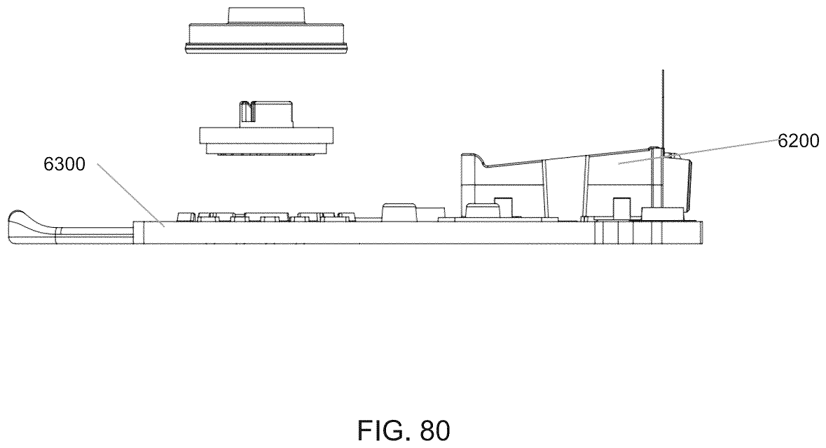

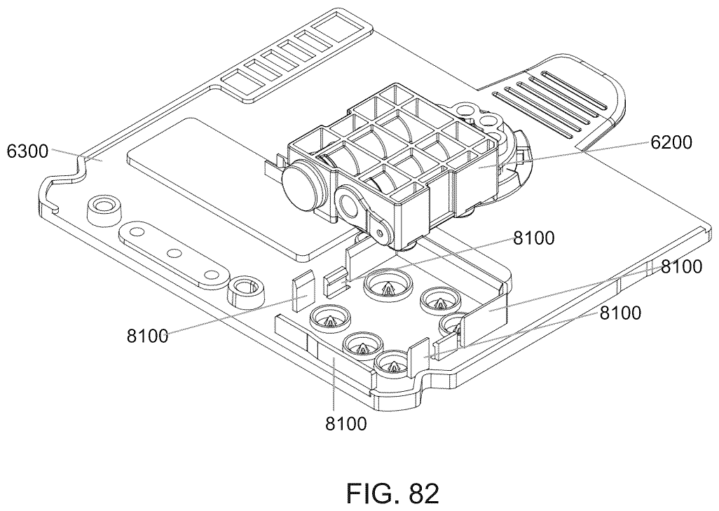

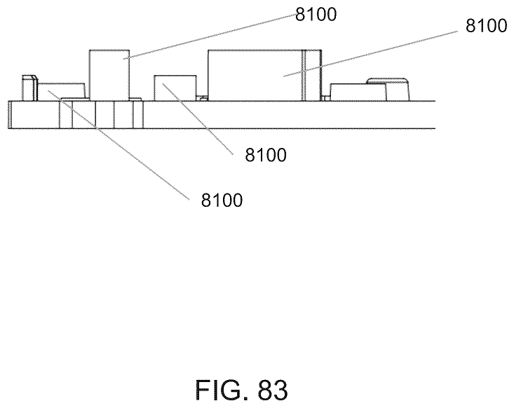

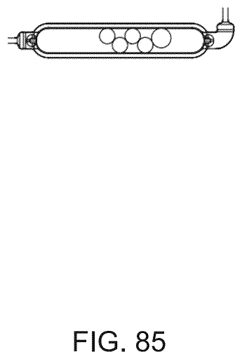

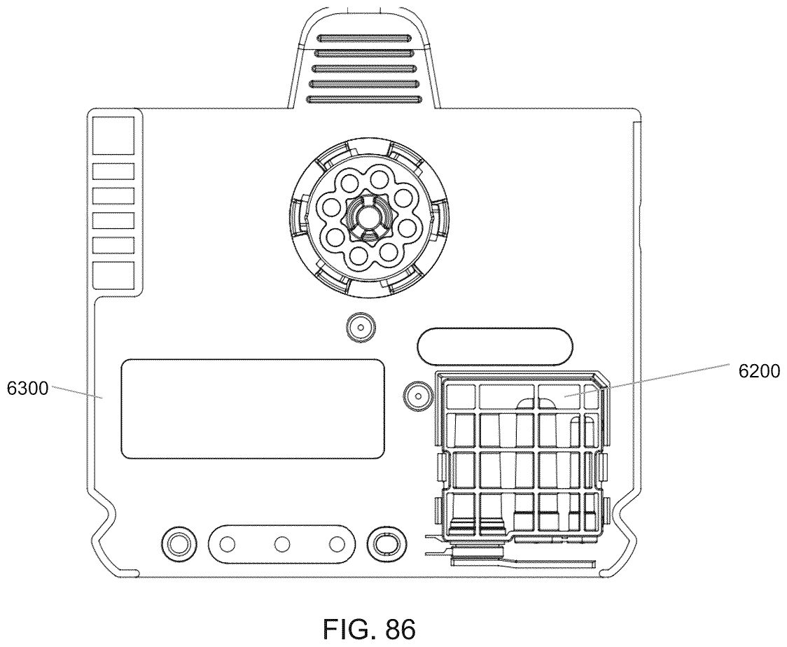

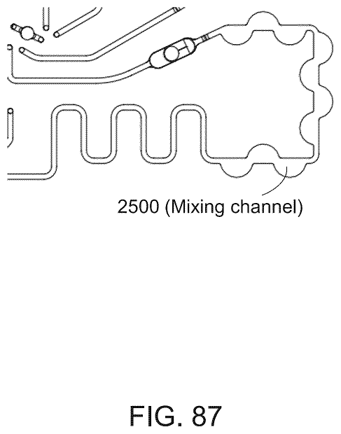

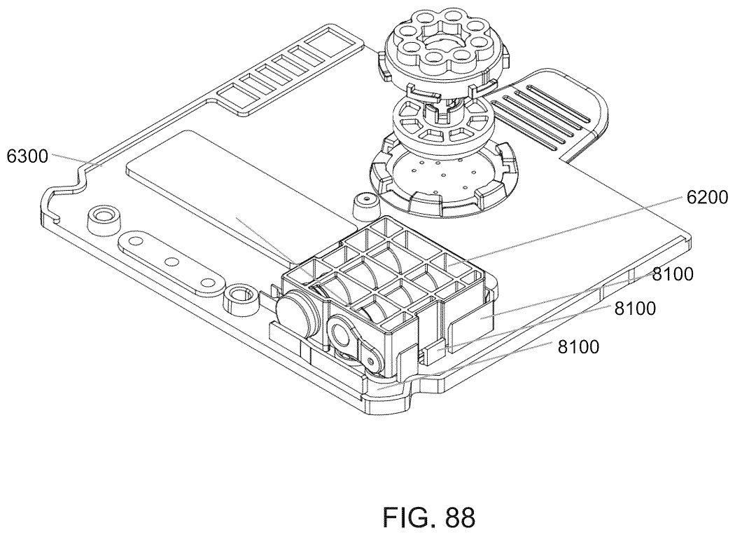

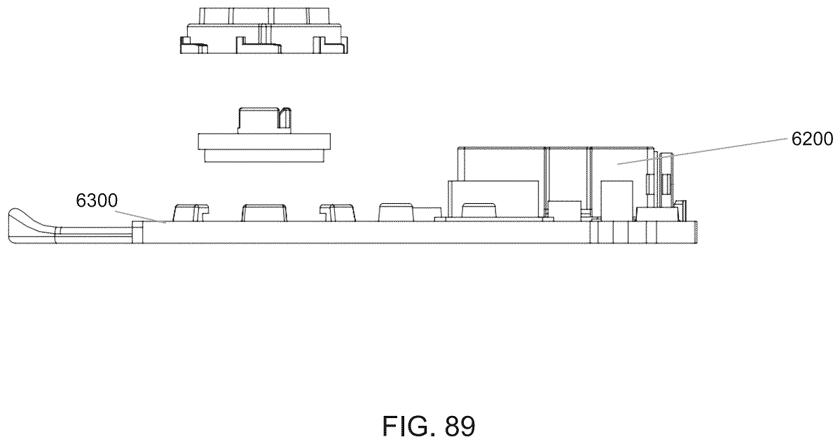

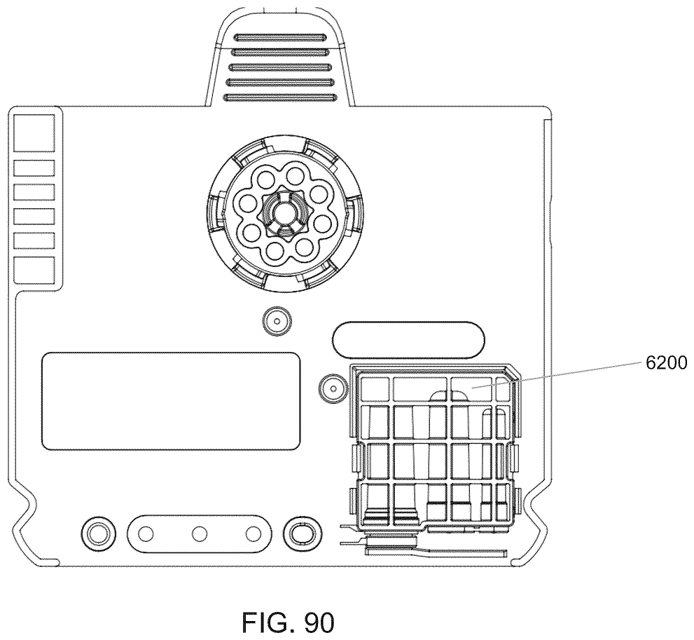

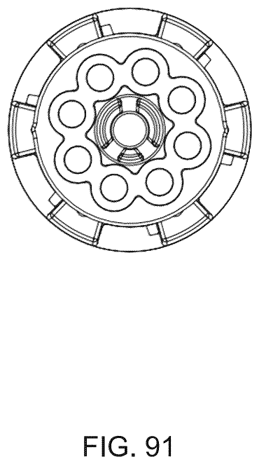

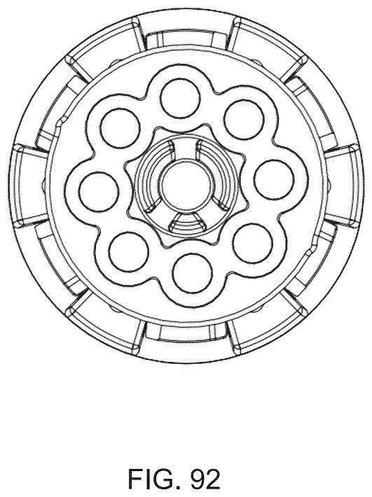

In an experiment, the system as described herein, in particular with reference to FIGS. 69 and 81-104, was able to analyze a biological sample in under five minutes by amplifying 100 copies of a target and detecting fluorescence of the target. This has been demonstrated for both DNA and RNA assays. A brief summary of the DNA assays performed is further described below.

A series of PCR reactions were performed using a representative microfluidic cartridge system of this disclosure. PCR was performed on a microfluidic cartridge pre-impregnated with reagents and solutions. A lyophilized beads of a PCR master mix comprising PCR enzyme, that contained all reagents needed for PCR except for the template DNA and PCR primers was pre- in the PCR Master Mix Reagent Zone in the form of lyophilized beads (Applied Biosystems™ TaqMan™ Fast Environmental Master Mix Beads were used, but alternative lyophilized beads can include or exclude G-Dots from G-biosciences, Lyophilized Ready-to-Use and Load PCR Master Mix, and Leadgene® 5× One-Step Probe RT-qPCR Master Mix). The MS2 gene (NCBI Entrez Gene: 100271694) was introduced as a control and pre-placed in the control DNA region on the microfluidic cartridge and lyophilized MS2 forward and reverse PCR primers and probes of the following sequence were pre-impregnated into the 4 separate PCR chambers.

MS2 forward primer:
(SEQ ID NO: 2)
GTTTCCGTCTTGCTCGTATC
MS2 reverse primer:
(SEQ ID NO: 3)
TTTCACCTCCAGTATGGAACC
MS2 probe:
(SEQ ID NO: 4)
/5Cy5/CGCAAGTTC/TAO/TTCAGCGAAAAGCAC/3IAbRQSp/

TAO is the IDT TAO double-quenched internal probe; 5Cy5 is the 5′ Cy5 modified base; and 3IAbRQSp is the 3′ Iowa Black RQ quencher (all available from IDT DNA, Inc.).

Biological samples were collected via nasal swabs and loaded into the sample collection tubes that comprises a cell lysis solution. The biological samples were then manually transferred via a dropper from the sample collection tube through a sample introduction cup on a microfluidic cartridge. The sample introduction cup was sealed and the microfluidic cartridge was placed into a microfluidic cartridge analysis system of this disclosure.

The biological sample was transferred to a lysis chamber from exogenous pressure applied by a pressure pump through the sample introduction cap through the chimney. The biological sample was then lysed in under 60 seconds within the microfluidic cartridge by the rapid movement of magnetizable metal beads pre-placed within the lysis chamber moved by the magnetic interaction with external magnetic rotors. Sensors on the external magnetic rotors control the location of the rotor arms such that the position of the magnetic beads within the lysis chamber can be controlled. Two magnetic rotors acting in combination move the beads within the lysis chamber. After lysis, the biological sample was transformed into a lysed biological sample.

The lysed biological sample was then purified in under 60 seconds by the extraction chamber within the microfluidic cartridge. Exogenous pressure and selective fluidic communication by means of adjusting the position of the rotor valve transferred the lysed biological sample from the lysis chamber to the extraction chamber, where the extracted DNA was bound to a porous silica membrane. The extracted DNA was washed as a third disc pump pushed a wash solution over the porous silica membrane in the extraction chamber and then into the waste reservoir. The extracted DNA was then eluted as an exogenous pressure pump pushed an elution solution into the extraction chamber and into the mixing chamber.

The extracted DNA was then transferred by exogenous pressure and selective fluidic communication by means of adjusting the position of the rotor valve to the mixing channel. A PCR Master Mix Reagent Zone was configured to be within the fluidic path to the mixing channel, wherein the PCR mater mix with lyophilized beds was pre-placed. The rotatable valve was then switched to allow a disc pump to move the mixed fluid into the PCR chambers containing the pre-placed PCR primers.

The microfluidic cartridge was then fluidically sealed and alternatively contacted with two separate heating blocks as described herein for a selected number of cycles to perform the PCR reaction. The heating blocks were configured to heat the PCR chambers to about 60° C. and 95° C. The microfluidic cartridge was moved between the two heating blocks for a total of 46 cycles, spending 4 seconds at each heating block for a total of 8 seconds/cycle. Cy5 and 6-FAM fluorescence was measured several times during each cycle. FIGS. 81-104 show normalized DNA amplification curves acquired in each of the 4 PCR chambers after 42 PCR cycles using this described system.

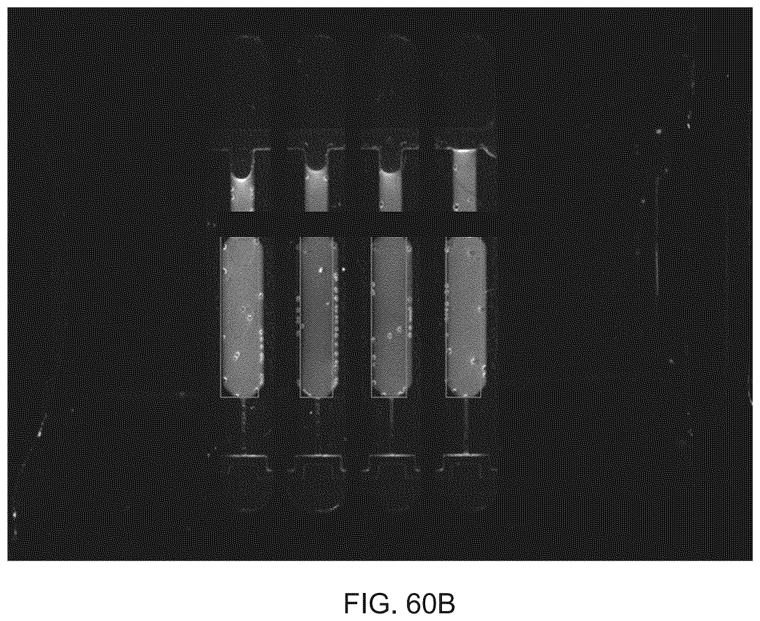

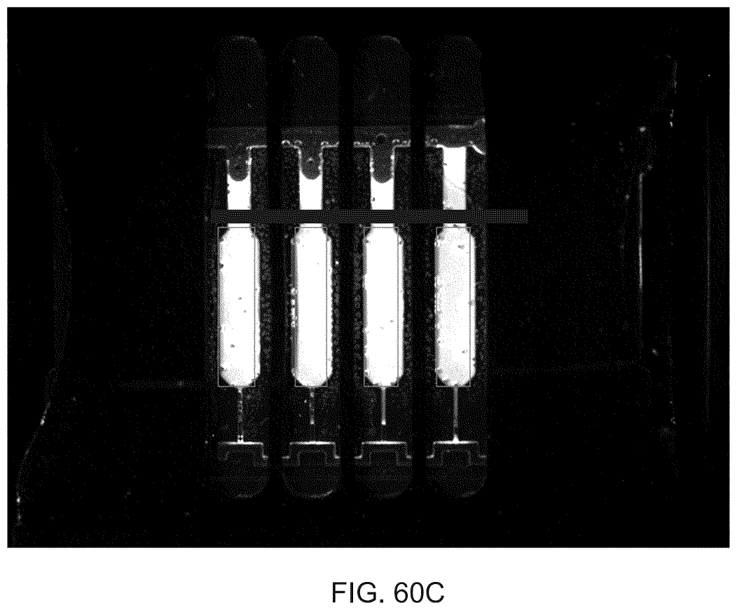

FIG. 60A, FIG. 60B, and FIG. 60C show the raw images of scanned PCR chambers in the Cy5 channel after 1, 25, and 36 PCR cycles respectively. For purposes of proof of concept, the signal intensities were manually measured for each well of the PCR chambers using imageJ, and graphed per PCR cycle to obtain the data shown in FIGS. 81-104.

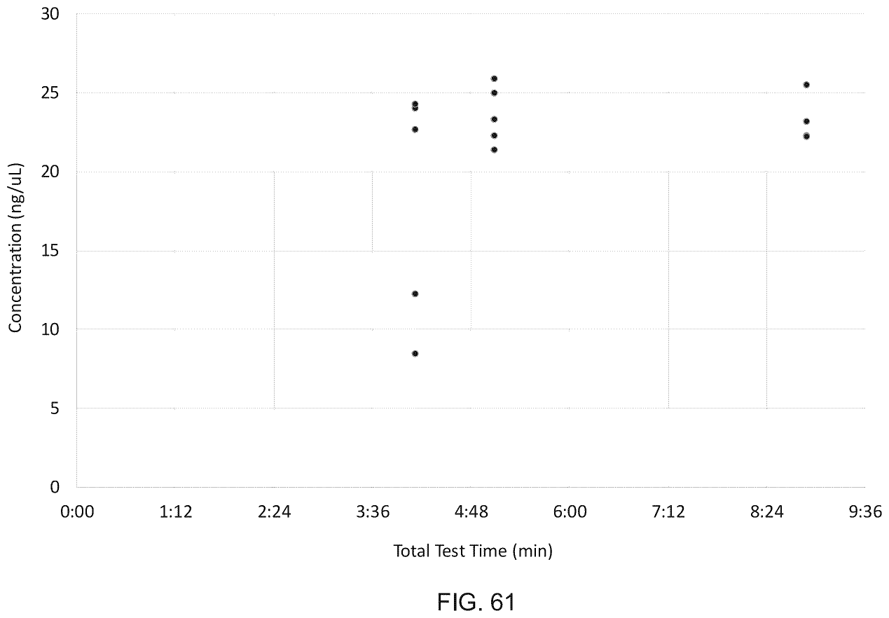

FIG. 61 shows the total DNA concentration produced using a series of total PCR reaction time using a model PCR chamber microfluidic cartridge. The cycle time was varied between 1.5 and 8 seconds at each heating zone to create a total PCR cycle time of between 4:07 and 8:53 (minutes). As shown in FIG. 61, the total DNA concentration (measured by an Agilent Bioanalyzer, data not shown) plateaus with a total PCR cycle time of around 5:05 minutes (when each dwell time is 5 seconds), indicating that the PCR reaction time can be around 5:05 minutes. Combined with the lysis step and extraction chamber steps of about 60 seconds each, the total process time can be in about 8 minutes.

### Example 4. Representative Microfluidic Cartridge Process Flow

An example of one representative method using the microfluidic cartridge system is described herein.

A sample is obtained from a swab. The swab sample is placed in a sample collection element, e.g., tube or sample collection chamber, and contacted with lysis solution present in the tube before placement of the swab sample. Alternatively, lysis solution is added to the sample collection tube after placement of the swab sample.

After combining the sample with the lysis solution, a portion of the biological sample is transferred from the collection element using, e.g., a dropper, pipette, or automated sample transfer system, to the microfluidic cartridge by presenting the sample to the introduction element on the microfluidic cartridge. For example, as shown in FIG. 3 a portion of a sample is introduced to cartridge at cup 2108 of introduction element 2100. The introduced sample may have a volume of 100, 150, 200, 250, 300, 350, 400, 450, or 500 microliters, or have a volume in a range from about 150 to about 1000 microliters, from about 150 to about 500 microliters, from about 200 to about 500 microliters, from about 200 to about 300 microliters, or any volume between any of the aforementioned volumes or the aforementioned volume ranges. In some embodiments, an introduced sample may have a volume of about 250 microliters. In some embodiments, a predetermined volume of the introduced sample may vary based on the type of analysis, target molecules, geometry of the microfluidic cartridge, and/or volume of the pi dropper used to dispense the sample into the sample introduction cup. For example, a single use dropper may be used to directly deposit the sample into introduction element. In some embodiments, the dropper may be an exact volume single use eyedropper.

After introduction of the sample, the cap 2318 of the introduction element is closed. The cap may be secured in place using one or more of an interlocking, and/or interference fit (e.g., friction fit).

Cartridge 2000 is placed in the device 3000 at portal 3010 and the microfluidic cartridge is positioned in a bracket. A motor may move the microfluidic cartridge into the device. In some embodiments, the motor may be on a cantilever. In some embodiments, pneumatics may be used to position and/or move the microfluidic cartridge within the device.

The microfluidic cartridge is pre-impregnated with PCR master mix reagents and solutions (which are all air-gapped from each other) throughout the microfluidic chambers. The solutions can include or exclude lysis buffer, wash buffer, elution buffer. The PCR master mix reagents can comprise polymerase, cofactors, buffer, primers, probes, and control nucleic acids.

Next, the microfluidic cartridge is inserted into a system for detecting one or a plurality of selected nucleic acid sequences as described herein. The microfluidic cartridge is moved into the system and interfaced with exogenous pressure pumps. In some embodiments, as the microfluidic cartridge moves in XY plane, it activates an angled lever which pushes at a fulcrum on a separate lever which causes a plurality of disc pumps to engage with the top of the microfluidic cartridge in the Z-direction. In alternative embodiments, the insertion of the microfluidic cartridge activates one or a plurality of disc pumps which engage with pump ports on the microfluidic cartridge.

A disc pump conveys air into a channel which is pre-impregnated with lysis buffer, thereby conveying additional lysis buffer into the sample delivery cup and then from the sample introduction cup into the lysis chamber. In some embodiments, the lysis buffer and sample is transferred directly from the sample introduction cup into the lysis chamber. The rotatable valve is set to allow the open line to connect to waste.

The rotatable valve is turned to selectively close off the fluid line from the waste reservoir. This can also prevent any fluid from uncontrolled liquid movement from the lysis chamber prematurely into the microfluidic channels.

When the microfluidic cartridge is introduced into the system, the magnetizable balls (stainless steel and chrome plated 0.09 inches) in the lysis chamber become in magnetic communication with a magnetic dual helicopter rotor station. The magnetic dual helicopter rotor station comprises two rotors which rotate in opposite directions in a controlled manner. The two rotors comprise an optical position sensor to monitor their position. The magnetic dual helicopter rotor station can comprise a gear reduction motor or a stepper motor to control the rotation speed of the helicopter rotors. A pulley can be configured with the motors and rotors to transmit the rotation speed from the motor to the rotors. The rotor speed can be 750 rpm, resulting in 1500 strokes per minute, wherein each complete magnetic helicopter rotor spin results in two strokes (a stroke defined as the traversal of the magnetizeable beads across the length of the lysis chamber). The lysis step is performed for 60 seconds.

Mechanical lysis is typically disfavored in the art because it can shear nucleic acids (Nester et al., PNAS, Jan. 1, 1963, 49 (1) 61-68, doi.org/10.1073/pnas.49.1.61; Fuciarelli, et al., Free Radical Biology and Medicine, Volume 18, Issue 2, 1995, 231-238, doi.org/10.1016/0891-5849 (94) 00119-5). The inventors, however, have made the surprising discovery that the mechanical lysis step described herein can degrade co-factors which inhibit PCR which are present in saliva and nasal samples, with minimal shearing of nucleic acids for PCR analysis. It is unlikely that all of the target nucleic acid would be degraded by the mechanical lysis conditions described herein.

Next, a disc pump conveys the lysed sample from the lysis chamber into the extraction chamber. The extraction chamber comprises a porous silica membrane to which extracted nucleic acids (e.g., DNA or RNA) bind under high salt conditions. The rotatable valve is configured to allow any excess lysis solution to go to the waste reservoir.

Next, a disc pump conveys a wash solution across the porous silica membrane in the extraction chamber and any then into the waste reservoir to wash away non DNA material from the lysed sample. The wash solution composition can be the same as, or different, from the lysis buffer. The wash solution comprises a high salt concentration to encourage nucleic acid binding to the porous silica membrane. The rotatable valve is then switched to divert any excess wash buffer solution effluent into the waste reservoir.

Nest, a disc pump conveys an elution solution to the extraction chamber. The elution solution comprises a low salt (e.g., typically less than 50 micromolar, and preferably about 10 micromolar) concentration to elute nucleic acids off the porous silica membrane and into the mixing chamber. The binding, washing, and elution steps in total can occur in 30 to 120 seconds. The volume of the wash solution ranges from about 200 to about 600 microliters. Cell debris from the lysis chamber goes can pass through the porous silica filter and into the waste reservoir. The volume of the elution solution ranges from about 40 to about 60 microliters. The release of nucleic acids from the porous silica membrane occurs very rapidly upon contact with the elution buffer.

The rotatable valve is configured to fluidically connect and convey the polymerase chain reaction (PCR) Master Mix (a solution comprising PCR polymerase enzyme(s), labeled probes, buffer, and triphosphate nucleotides required to perform PCR steps) from a separate fluid channel into the mixing chamber. The PCR Master Mix is in the form of lyophilized beads and is pre-impregnated in the microchannel between the extraction chamber and the mixing chamber.

The extracted DNA is then mixed with the PCR Master Mix in the mixing chamber. In some embodiments, the mixing chamber comprises a “corkscrew” shaped mixing fluid line. The mixing microchannel has different depths, which causes mixing. The nucleic acid that is eluted off the silica membrane (filter) will have a concentration gradient, so the mixing area makes the concentration uniform and homogenizes the concentration of the PCR master mix reagents with the eluted sample. In some embodiments, the mixing chamber comprises a tear-drop shape wherein the PCR master mix reagents can mix with the eluted sample. In some embodiments, a piezo disc pump can sequentially generates positive and negative pressure into the system to push and pull the fluid to further enhance mixing.

After traversing the mixing chamber, the eluted sample with reagents (“reagent sample mix”) enters the PCR chambers. The PCR chambers fill, beginning with the first chamber in the fluid path, and then the solution enters each successive chamber. Fluid stops entering each PCR chamber at the chamber end which tapers to a very narrow exit port wherein only gasses exit the exit port (to prevent backpressure buildup). Surface tension keeps fluid within the chamber. The relatively large entrance size, and relatively small exit size to each PCR chamber ensures complete filling of the PCR chambers without overfilling or crossing over reagent sample mix into a next PCR chamber. In some embodiments, features (which can include bumps) are present at the chamber entrance to enhance turbulent flow to further mix the reagents. The volume of each chamber can range from 3 to 9 microliters. The exit ports of each PCR chamber are connected by a zig zag of channel to release air which is pushed out of each PCR chamber as the PCR chambers fill with fluid. Each of the PCR chambers contain pre-impregnated lyophilized reagents which can include or exclude primers, probes, and control nucleic acids. The primers can be specific for a particular molecular target/biomarker genetic locus. When there are 4 PCR chambers present in the microfluidic cartridge, up to 4 different molecular targets can be detected. For example, a first PCR chamber can comprise reagents for the analysis of Covid, a second PCR chamber can comprise reagents for the analysis of Influenza, or a first PCR chamber can comprise reagents for analysis of a first strain of SARS-Cov2 (e.g., Delta variant), and a second PCR chamber can comprise reagents for the analysis of a different Covid strain (e.g., Omnicron variant). In some embodiments, one of the PCR chambers can comprise reagents to detect a control nucleic acid.

After all of the PCR chambers have been filled with reagent sample mix, excess reagent sample mix can convey to the waste reservoir.

In some embodiments, the rotatable valve can be configured so that the fluid pressure in the PCR chambers is increased by exogenous pressure from the disc pump. Increasing the pressure can reducing outgassing during the PCR heating cycles, thereby preventing bubble formation. The pressure can be increased from 0 to 9 PSI. In some embodiments, the rotatable valve can be configured to fluidically isolate the PCR chambers from the other features on the microfluidic cartridge to prevent liquid flow during the PCR heating cycles.

In some embodiments, the microfluidic cartridge can be moved to alternating heating zones. In alternative embodiments, the microfluidic cartridge is in a fixed Z-axis position but move along an X-axis while alternating heating zones are sequentially moved along the Z-axis to be in contact with the PCR chambers of the microfluidic cartridge. The alternating heating zones can heat the PCR chambers in the microfluidic cartridge at a separate temperature (a first range from 55° C. to 60° C. and a second range from 95° C. to 100° C.). The microfluidic cartridge can contact each heating zone for a contact time from 1 to 8 seconds. In some embodiment, the PCR chambers in the cartridge will take about 1 second to achieve the selected temperature, about 4 seconds to hold at a first selected temperature, then a second heating zone moved to the PCR chambers of the microfluidic cartridge and contacted for 4 seconds at a second selected temperature, for a total of about 8-9 second cycle time. In some embodiments, the first selected temperature is the anneal temperature and the second selected temperature is the denature temperature.

The alternative heating zones contact the PCR chambers of the microfluidic cartridge a selected number of times, which corresponds to the selected number of PCR cycles. Each time the PCR chambers on the microfluidic cartridge are contacted with the anneal heating zone, the fluorescence is measured at several different wavelengths corresponding to an emission wavelength of the labeled probes. The fluorescence intensity is measured and compared against the first cycle fluorescence intensity.

The temperature of each heating zone is continuously monitored and controlled by a computer. In some embodiments, the temperature is monitored by a thermistor, increased by a heating block in thermal contact with a first heating zone, and decreased by a heat sink in thermal contact with a second heating zone. The thermistor uses the measured temperature as feedback for the PID loop. The material for the denaturing heating zone can be copper. The material for the annealing heating zone can be aluminum.

In some embodiments, the system can comprise one or a plurality of cameras. One camera can monitor the lysis chamber to confirm sufficient material was loaded to avoid a false negative signal due to insufficient sample present. One camera can be configured to monitor the PCR chambers when the microfluidic cartridge is positioned on the annealing heating block. One camera can be configured to monitor the PCR chambers when the microfluidic cartridge is positioned on the denaturing heating block. The control nucleic acid PCR chamber can be monitored while the microfluidic cartridge is positioned on the denaturing heating block. In some embodiments, there is one camera with a dual-fluorescence filter, wherein lenses direct the fluorescence from each of the heating blocks selectively to the camera through selected fluorescence filters.

The system can comprise one or a plurality of LEDs. The LEDs can excite fluorescent probes in the reagent sample mix during the PCR cycles. The wavelength of the LEDs can be selected to overlap with the excitation profile of the fluorescent probes. Typical fluorescent dyes conjugated to probes can include or exclude: FAM6, and Cy5.

The methods and systems described herein can amplify as few as 100 copies of DNA for detection in under 5 minutes after 40 PCR cycles. The methods and systems described herein can amplify as few as 100 copies of RNA for detection in under 5 minutes after 40 PCR cycles.

In some embodiments, the microfluidic cartridge and/or the sample collection cartridge can further comprise a sample identifier that can be associated with the patient's sample. The sample identifier can be a barcode. In some embodiments, the sample identifier can be a 1-D or 2-D barcode. In some embodiments, the sample identifier can be a hologram barcode. In some embodiments, the microfluidic cartridge can further comprise an identifier as to the identity of the PCR primer types and/or targets. The identifier can be those described herein.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are within the following claims. In addition, where features or aspects of the invention are described in terms of Markush groups, those skilled in the art will recognize that the invention is also thereby described in terms of any individual member or subgroup of members of the Markush group.

We claim:

1. A method of detecting one or a plurality of selected nucleic acids in a sample, the method comprising:
a. providing a sample mixed with lysis solution to a sample introduction cup of a microfluidic cartridge wherein the sample introduction cup comprises a moveable cap providing a pressure tight seal and is fluidically connected to a pneumatic channel and port via a first opening and a sample introduction microchannel via a second opening wherein the sample introduction microchannel connects to a valve configured to selectively isolate the sample introduction cup and sample introduction microchannel, and wherein the pneumatic channel is fluidically connected to a sample conveyance pressure port on a top surface of the cartridge;
b. closing the cap of the sample introduction cup;
c. introducing pressure to the sample conveyance pressure port to introduce pressure above the level of the fluid in the sample introduction cup;
d. actuating the valve to fluidically connect the sample introduction cup to the sample introduction microchannel, which is fluidically connected to a mechanical lysis chamber, wherein a plurality of magnetizeable beads are disposed in said mechanical lysis chamber;
e. conveying the sample mixed with lysis solution to the mechanical lysis chamber;
f. actuating the valve to fluidically disconnect the mechanical lysis chamber from the sample introduction cup;
g. actuating at least two rotatable members comprising magnets to move the magnetizeable beads in the mechanical lysis chamber wherein the sample is converted to lysed cell constituents comprising nucleic acids;
h. actuating the valve to fluidically connect the lysis chamber with a extraction chamber which comprises a reversibly binding medium;
i. conveying the lysed cell constituents into the extraction chamber wherein the nucleic acids reversibly bind to the reversibly binding medium;
j. actuating the valve to fluidicially connect a wash solution reservoir which comprises wash solution to an introduction cup of the extraction chamber, and further fluidically connects an output port of the extraction chamber to a waste reservoir;
k. conveying wash solution to the extraction chamber to convey the lysed cell constituents not reversibly bound to the reversibly binding medium into the waste reservoir while retaining substantially all of the nucleic acids bound to the reversibly binding medium;
l. actuating the valve to fluidicially connect an elution solution reservoir, which comprises elution solution, to an input port of the extraction chamber, and to further fluidically connect an output port of the extraction chamber to one or a plurality of a PCR mastermix reagent zones, which comprise PCR mastermix reagents;
m. conveying elution solution to the extraction chamber to elute and convey nucleic acid eluted from the reversibly binding medium into the one or a plurality of PCR mastermix zones forming nucleic acid PCR admixture;
n. conveying the nucleic acid PCR admixture into a mixing channel forming a mixed nucleic acid PCR admixture;
o. actuating the valve to fluidically connect the mixing channel to two or a plurality of PCR chambers and a waste reservoir wherein each PCR chamber comprises PCR reagents comprising one or more polymerases, control PCR reagents and selected PCR reagents for a selected target, wherein the control and selected PCR reagents comprise fluorescently labeled primers and or fluorescently labeled probes;
p. conveying the mixed nucleic acid PCR admixture into the two or a plurality of PCR chambers, wherein each of the PCR chambers is filled with mixed nucleic acid PCR admixture comprising the PCR reagents, and wherein any excess mixed nucleic PCR admixture which is not required to fill the two or a plurality of PCR chambers is conveyed into the waste reservoir;
q. actuating the valve to fluidically isolate the two or a plurality of PCR chambers;
r. contacting a selected region of the microfluidic cartridge with a first heating zone;
s. modulating the selected region of the microfluidic cartridge to one or a plurality of temperatures;
t. contacting the selected region of the microfluidic cartridge with a second heating zone;
u. modulating the selected region of microfluidic cartridge to one or a plurality of temperatures;
v. presenting an excitation light source to the two or a plurality of PCR chambers wherein a labeled control primer or probe emits control fluorescence and a labeled selected primer or probe emits selected fluorescence;
w. measuring one or a plurality of selected photophysical properties from the emitted control fluorescence and selected fluorescence from each PCR chamber;
repeating steps (r) through (v) for a selected number of instances,
wherein the microfluidic cartridge comprises a sample introduction cup, one or a plurality of valves, one or a plurality of storage elements (each of which can optionally independently further comprise an elution solution, PCR mastermix reagents, and/or a control sample), a mechanical lysis chamber, an extraction chamber, a waste reservoir, a mixing channel, and two to ten PCR chambers.

2. The method of claim 1, wherein the valve is rotatable.

3.-5. (canceled)

6. The method of claim 1, wherein the sample introduction microchannel, lysis solution, elution solution, or combinations thereof comprise one or more control reagents which comprises a nucleic acid having a known sequence.

7. The method of claim 6, wherein the control sample further comprises carrier RNA (cRNA).

8. (canceled)

9. (canceled)

10. The method of claim 6, wherein the nucleic acid having a known sequence is MS2 DNA (SEQ ID NO: 1).

11. The method of claim 6, wherein the one or more control reagents are lyophilized.

12. The method of claim 1, wherein step (c) introducing pressure to the sample conveyance pressure port to introduce pressure into the sample introduction cup, further comprises:
(i) introducing pressure into a first reservoir of the sample introduction cup through a vertically aligned channel surrounded by a wall disposed within the interior of the sample introduction cap wherein at least a portion of the vertically aligned channel wall does not extend throughout the entirety of the first reservoir of the sample introduction cup and the top surface of the sample mixed with lysis solution is above the top of the vertically aligned channel, wherein pressure is increased in the volume defined by the top of the sample surface and the interior surface of the cap;
(ii) stopping the introduction of pressure into said first reservoir and allowing the pressure presented to the first reservoir to return to atmospheric pressure, whereby any fluid in the first reservoir positioned above the top of the vertically aligned channel is conveyed through the vertically aligned channel into the lysis reservoir;
(iii) introducing pressure to the sample conveyance pressure port to the sample holder cup.

13. The method of claim 1, wherein each of the at least two rotatable members comprising magnets are comprise a first and second end at the periphery of said members and are independently configured to comprises magnets on the first, second, or both ends.

14. The method of claim 1, wherein the reversibly binding medium is a silica medium.

15. The method of claim 14, wherein the silica medium is a porous silica membrane.

16. The method of claim 1, wherein conveying the sample mixed with lysis solution into the mechanical lysis chamber is performed by introduction of pressure to a pneumatic pump port.

17. The method of claim 1, wherein conveying the lysed cell constituents into the extraction chamber is performed by introduction of pressure to a post-sample air pump port while the valve is actuated to fluidically disconnect the sample introduction cup from the mechanical lysis chamber.

18. The method of claim 1, wherein conveying wash solution to the extraction chamber is performed by introduction of pressure to a wash solution reservoir pump port.

19. The method of claim 1, wherein conveying elution solution to the extraction chamber is performed by introduction of pressure via an external disc pump in contact with an elution solution reservoir pump port.

20. The method of claim 1, wherein conveying the nucleic acid PCR admixture into the mixing chamber is performed by introduction of pressure to an elution solution reservoir pump port.

21. The method of claim 1, wherein the one or a plurality of temperatures is between 55° C. and 65° C., or between 90° C. and 98° C.

22. The method of claim 21, wherein the one or a plurality of temperatures is between about 94° C. and about 96° C.

23. The method of claim 1, wherein first heating zone comprises a temperature of greater than the selected temperature.

24. The method of claim 1, further comprising: maintaining the first selected temperature for a selected period of time.

25. The method of claim 1, wherein the second selected temperature range is between 90° C. and 98° C., or between 55° C. and 65° C.

26. The method of claim 25, wherein the second selected temperature range is between about 59° C. and about 61° C.

27. The method of claim 1, wherein the second heating zone comprises a temperature of less than or within the selected temperature range.

28. The method of claim 1, further comprising: maintaining the second selected temperature for a selected time.

29. The method of claim 1, wherein at least one of the one or a plurality of selected photophysical properties is light intensity at one or a plurality of wavelengths.

30. The method of claim 1, wherein step (x) measuring one or a plurality of selected photophysical properties from the emitted control fluorescence and selected fluorescence from each PCR chamber is performed at the first heating zone, second heating zone, or both heating zones.

31. The method of claim 1, wherein the selected number of instances is from 2 to 100.

32.-43. (canceled)

44. A lysis module for lysing biological materials comprising:
a lysing chamber comprising:
one or more magnetizeable balls which are magnetic when subjected to a magnetic field; and
at least two rotatable members comprising magnets on one or both ends of each of the at least two rotatable members.

45. The lysis module of claim 44 wherein the one or more magnetizeable balls comprise stainless steel.

46. (canceled)

47. The lysis module of claim 44 wherein during use movement of the at least two rotatable members moves the one or more magnetizeable balls within the lysis chamber such that in a linear movement from a first wall to a second wall of the chamber at a speed in a range from about 100 to about 3200 strokes per minute.

48. (canceled)

49. The lysis module of claim 44 wherein during the at least two rotatable members rotate in the opposite direction such that a magnetic field provided to the lysis chamber alternates with each pass of one of the at least two rotatable members.

50. The lysis module of claim 44 wherein during use PCR interfering substances are separated or eliminated from the sample by the movement of the one or more magnetizeable balls.

51. The lysis module of claim 44 wherein during use the lysis element lyses constituents in a sample in less than about 60 seconds.

52. (canceled)

53. The lysis module of claim 44 wherein the magnetizeable balls comprise ball bearings having a diameter of about 0.09 inches.

54. A lysis module comprising:
a microfluidic cartridge comprising:
a lysing chamber;
a plurality of balls positioned within the lysing chamber wherein a ratio of a diameter of at least one of the plurality of ball bearings to a transverse width of the lysing chamber is in a range from about 0.03125 to about 0.125;
at least one rotating member having magnets at both ends wherein a first magnet positioned on a first end of the at least one rotating member has a polarity opposite a second magnet positioned on a second end of the at least one rotating member; and
wherein the at least one rotating member is positioned such that during use the at least one rotating member moves the plurality of ball bearings within the lysing chamber.

55. The lysis module of claim 54 wherein during use the rotation of the rotating members moves the ball bearings linearly from a first end of the lysing chamber to a second end of the lysing chamber.

56. The lysis module of claim 54 wherein during use the rotating members move such that the ball bearings move within the lysing chamber at about 1500 strokes per minute.

57.-82. (canceled)

83. A system for detecting one or a plurality of selected nucleic acid sequences comprising:
a microfluidic cartridge comprising:
a lysis chamber having one or more magnetic balls capable of being fluidically isolated;
one or a plurality of PCR chambers;
a rotatable valve comprising one or more predetermined pathways;
a distribution element having one or more openings extending through the microfluidic cartridge wherein during use the rotatable valve couples to the distribution element; and
at least one path through the microfluidic cartridge; and
an analytic device comprising:
a rotatable magnetic member;
two or more heating elements positionable proximate to a predetermined surface of the microfluidic cartridge;
one or more light sources; and
one or more image capturing devices.

84. The system of claim 83 wherein each of the one or a plurality of PCR chambers comprises:
a PCR chamber depth (CD) that is predetermined based on a target or a type of analysis;
a recess section that has a depth equal to 1.5 times the PCR chamber depth;
a channel having a depth equal to 1.5 times the PCR chamber depth, comprising:
a first channel section having a depth equal to half the depth of the PCR chamber; and
a second channel section proximate the first channel section having a depth equal to one quarter of the PCR chamber depth; and
a restriction section having a depth equal to one third of the depth of the PCR chamber.

85. The system of claim 83 wherein the rotatable magnetic member is positioned proximate the lysis chamber and is configured to move such that the one or more magnetic balls are moved within the lysis chamber at a rate of greater than about 1000 strokes per minute.

86. (canceled)

87. (canceled)

88. A method of detecting one or a plurality of selected nucleic acids, comprising:
providing a sample to a microfluidic cartridge at an introduction element having a cap capable of forming a pressure tight seal with the microfluidic cartridge;
pressurizing the introduction element to drive a portion of the sample to a lysis chamber;
isolating a portion of the sample in the lysis chamber;
moving one or more magnetizeable balls in a lysis chamber at a rate in a range from about 100 to about 3200 strokes per minute;
providing a portion of the lysed fluid to an extraction chamber;
extracting nucleic acid materials from the lysed fluid;
providing a fluid comprising the extracted nucleic acid materials to a PCR element;
providing light to a plurality of PCR chambers wherein a lyophilized labeled control primer or probe emits control fluorescence and a labeled selected primer or probe emits selected fluorescence; and
measuring one or a plurality of selected photophysical properties for materials in each PCR chamber for a predetermined number of instances or until a predetermined threshold has been met.

89. The method of claim 88 wherein the one or more magnetizeable balls are moved within the lysis chamber at a rate of greater than about 1000 strokes per minute.

90. (canceled)

91. The method of claim 88 further comprising providing a magnetic force proximate a lysis chamber sufficient to move the one or more balls from a first end to a second end of the lysis chamber.

92. The method of claim 88 wherein the selected number of instances is from 2 to 100.

93.-95. (canceled)

96. The method of claim 88, further comprising providing a control sample comprising carrier RNA (cRNA).

97.-99. (canceled)

100. The method of claim 88 wherein the microfluidic cartridge comprises a sample introduction cup, a valve, a control sample zone, an extraction chamber, a waste reservoir, a wash solution reservoir, an elution solution reservoir, one or a plurality of control reagent zones, and a mixing channel.
